(19) United States
(12) Patent Application Publication
(10) Pub. No.: US 2024/0030429 A1
(43) Pub. Date: Jan. 25, 2024

(54) POSITIVE ELECTRODE ACTIVE MATERIAL, LITHIUM-ION SECONDARY BATTERY, AND VEHICLE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Ryo ARASAWA, Isehara, Kanagawa (JP); Shunichi ITO, Atsugi, Kanagawa (JP); Shiori SAGA, Atsugi, Kanagawa (JP); Yohei MOMMA, Isehara, Kanagawa (JP); Jo SAITO, Atsugi, Kanagawa (JP); Kunihiko SUZUKI, Isehara, Kanagawa (JP); Teppei OGUNI, Atsugi, Kanagawa (JP); Yuji IWAKI, Isehara, Kanagawa (JP); Kanta ABE, Atsugi, Kanagawa (JP)

(21) Appl. No.: 18/251,776

(22) PCT Filed: Oct. 28, 2021
(86) PCT No.: PCT/IB2021/059948

§ 371 Date: May 4, 2023

(30) Foreign Application Priority Data
Nov. 9, 2020 (JP) 2020-186742
Dec. 16, 2020 (JP) 2020-208833
Sep. 3, 2021 (JP) 2021-144027

(51) Int. Cl. H01M 4/525; H01M 4/46; H01M 10/0525

(52) U.S. Cl. CPC H01M 4/525; H01M 4/463; H01M 4/466; H01M 10/0525; H01M 2004/028

(57) ABSTRACT

A positive electrode active material in which the number of defects that cause deterioration is small or progress of the defect is suppressed is provided. The positive electrode active material is used for a secondary battery. The positive electrode active material contains lithium cobalt oxide containing an additive element. After a cycle test is performed on a cell that uses the positive electrode active material for a positive electrode and a lithium electrode as a counter electrode, the positive electrode active material includes a defect and contains at least the same element as the additive element in a region in the vicinity of the defect. The additive element is contained also in a surface portion of the positive electrode active material.

### TECHNICAL FIELD

One embodiment of the present invention relates to an object, a method, or a manufacturing method. Another embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, the present invention relates to a positive electrode active material for a lithium-ion secondary battery, a fabrication method thereof, and a lithium-ion secondary battery including the positive electrode active material.

### BACKGROUND ART

In recent years, demand for lithium-ion secondary batteries with high output and high capacity has rapidly grown with the development of the semiconductor industry, and the lithium-ion secondary batteries are essential for modern society as energy sources that can be repeatedly used.

In particular, as lithium-ion secondary batteries for mobile electronic devices, secondary batteries with a large discharge capacity per weight and excellent charge and discharge characteristics have been required. In order to meet such demands, positive electrode active materials included in positive electrodes of secondary batteries have been actively improved (see Patent Document 1, for example).

### REFERENCE

### Patent Document

[Patent Document 1] Japanese Published Patent Application No. 2018-120812

### SUMMARY OF THE INVENTION

### Problems to be Solved by the Invention

Patent Document 1 discloses, focusing on a crack in a positive electrode active material, a technique for repairing the crack by performing sol-gel treatment a plurality of times. The crack is generated before the positive electrode active material is completed.

However, the deterioration state of the positive electrode active material after a cycle test is not taken into account in Patent Document 1. In view of this, an object of the present invention is to provide a positive electrode active material with a suppressed decrease in discharge capacity retention rate in a cycle test, as a result of earnest consideration on the deterioration state of the positive electrode active material after a cycle test.

Another object of one embodiment of the present invention is to provide a lithium-ion secondary battery including the positive electrode active material and an electronic device including the lithium-ion secondary battery, or to provide fabrication methods thereof.

Note that the description of these objects does not preclude the existence of other objects. One embodiment of the present invention does not have to achieve all of these objects. Other objects can be derived from the description of the specification, the drawings, and the claims.

### Means for Solving the Problems

One embodiment of the present invention is a positive electrode active material used for a secondary battery. The positive electrode active material includes lithium cobalt oxide containing an additive element. After a cycle test is performed on a cell using the positive electrode active material for a positive electrode and a lithium electrode as a counter electrode, the positive electrode active material includes a defect, and contains at least an element identical to the additive element in a region in the vicinity of the defect.

One embodiment of the present invention is a positive electrode active material used for a secondary battery. The positive electrode active material includes lithium cobalt oxide containing an additive element. After a cycle test is performed on a cell using the positive electrode active material for a positive electrode and a lithium electrode as a counter electrode, the positive electrode active material includes a defect, and contains at least an element identical to the additive element in a region in the vicinity of a side surface of the defect.

One embodiment of the present invention is a positive electrode active material used for a secondary battery. The positive electrode active material includes lithium cobalt oxide containing an additive element. After a cycle test is performed on a cell using the positive electrode active material for a positive electrode and a lithium electrode as a counter electrode, the positive electrode active material includes a defect, and contains at least an element identical to the additive element in a region in the vicinity of a tip of the defect.

In one embodiment of the present invention, the defect preferably has a constant width.

In one embodiment of the present invention, an upper limit voltage of the cycle test can be 4.65 V or 4.7 V.

In one embodiment of the present invention, the additive element contained in the lithium cobalt oxide is preferably positioned in a surface portion of the lithium cobalt oxide.

In one embodiment of the present invention, the additive element contained in the lithium cobalt oxide preferably contains at least magnesium or aluminum.

One embodiment of the present invention is a positive electrode active material used for a secondary battery. The positive electrode active material includes lithium cobalt oxide containing an additive element. After a cycle test is performed at an upper limit voltage of 4.7 V and at 25° C. on a cell using the positive electrode active material for a positive electrode and a lithium electrode as a counter electrode, a surface portion of the positive electrode active material includes a region where a rock-salt structure exists.

One embodiment of the present invention is a positive electrode active material used for a secondary battery. The positive electrode active material includes lithium cobalt oxide containing an additive element. After a cycle test is performed at an upper limit voltage of 4.7 V and at 25° C. on a cell using the positive electrode active material for a positive electrode and a lithium electrode as a counter electrode, a surface portion of the positive electrode active material includes a region where a rock-salt structure exists, and the additive element contained in the lithium cobalt oxide is positioned in a surface portion of the lithium cobalt oxide.

One embodiment of the present invention is a positive electrode active material used for a secondary battery. The positive electrode active material includes lithium cobalt oxide containing an additive element. After a cycle test is performed at an upper limit voltage of 4.7 V and at 45° C. on a cell using the positive electrode active material for a positive electrode and a lithium electrode as a counter electrode, a surface portion of the positive electrode active material includes a region where a rock-salt structure exists and a region where a spinel structure exists.

One embodiment of the present invention is a positive electrode active material used for a secondary battery. The positive electrode active material includes lithium cobalt oxide containing an additive element. After a cycle test is performed at an upper limit voltage of 4.7 V and at 45° C. on a cell using the positive electrode active material for a positive electrode and a lithium electrode as a counter electrode, a surface portion of the positive electrode active material includes a region where a rock-salt structure exists and a region where a spinel structure exists, and the additive element is not detected in the surface portion of the positive electrode active material in EDX line analysis.

In one embodiment of the present invention, the rock-salt structure preferably exists in a region from a surface of the lithium cobalt oxide to a depth of greater than or equal to 0.8 nm and less than or equal to 0.9 nm.

In one embodiment of the present invention, the spinel structure preferably exists in a region from a surface of the lithium cobalt oxide to a depth of greater than or equal to 1.5 nm and less than or equal to 4.5 nm.

In one embodiment of the present invention, the lithium cobalt oxide preferably includes a defect having a constant width in a cross section.

In one embodiment of the present invention, the additive element preferably contains at least magnesium and aluminum.

One embodiment of the present invention is a lithium-ion secondary battery including the above positive electrode active material in a positive electrode, and graphite in a negative electrode.

One embodiment of the present invention is a vehicle including the above lithium-ion secondary battery.

### Effect of the Invention

A decrease in discharge capacity retention rate, i.e., deterioration in a cycle test is suppressed in the positive electrode active material of the present invention. A lithium-ion secondary battery including the positive electrode active material has a long lifetime and an improved safety. In addition, an electronic device including the lithium-ion secondary battery can be used for a long period and has an improved safety.

Note that the description of these effects does not preclude the existence of other effects. One embodiment of the present invention does not have to have all of these effects. Note that other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A and FIG. 1B are diagrams illustrating positive electrode active materials of embodiments of the present invention.

FIG. 2A and FIG. 2B are diagrams illustrating positive electrode active materials of embodiments of the present invention.

FIG. 3A and FIG. 3B are diagrams illustrating positive electrode active materials of embodiments of the present invention.

FIG. 4A and FIG. 4B are diagrams illustrating crystal structures of positive electrode active materials of embodiments of the present invention.

FIG. 5A and FIG. 5B are diagrams illustrating positive electrode active materials of embodiments of the present invention.

FIG. 6A and FIG. 6B are diagrams illustrating crystal structures of positive electrode active materials of embodiments of the present invention.

FIG. 7A and FIG. 7B are diagrams illustrating positive electrode active materials of embodiments of the present invention.

FIG. 8 is a diagram showing a fabrication process of a positive electrode active material of one embodiment of the present invention.

FIG. 9 is a diagram showing a fabrication process of a positive electrode active material of one embodiment of the present invention.

FIG. 10 is a diagram showing a fabrication process of a positive electrode active material of one embodiment of the present invention.

FIG. 11 is a diagram showing a fabrication process of a positive electrode active material of one embodiment of the present invention.

FIG. 12 is a diagram illustrating crystal structures of a positive electrode active material of one embodiment of the present invention.

FIG. 13 is a graph showing XRD results of a positive electrode active material of one embodiment of the present invention.

FIG. 14 is a diagram illustrating crystal structures of a positive electrode active material.

FIG. 15 is a graph showing XRD results of a positive electrode active material.

FIG. 16A to FIG. 16C are graphs showing a correlation between a Ni concentration and a-axis and c-axis lattice constants of a crystal structure of a positive electrode active material of one embodiment of the present invention.

FIG. 17A to FIG. 17C are graphs showing a correlation between a Mn concentration and the a-axis and c-axis lattice constants of a crystal structure of a positive electrode active material of one embodiment of the present invention.

FIG. 18A and FIG. 18B are diagrams illustrating a positive electrode active material layer of one embodiment of the present invention.

FIG. 19A and FIG. 19B are diagrams illustrating secondary batteries of embodiments of the present invention.

FIG. 20A to FIG. 20C are diagrams illustrating a cell for evaluating an all-solid-state battery of one embodiment of the present invention.

FIG. 21A and FIG. 21B are diagrams illustrating a secondary battery of one embodiment of the present invention.

FIG. 22A to FIG. 22C are diagrams illustrating a coin-type secondary battery of one embodiment of the present invention.

FIG. 23A to FIG. 23D are diagrams illustrating cylindrical secondary batteries of embodiments of the present invention.

FIG. 24A and FIG. 24B are diagrams illustrating a secondary battery of one embodiment of the present invention.

FIG. 25A to FIG. 25D are diagrams illustrating secondary batteries of embodiments of the present invention.

FIG. 26A and FIG. 26B are diagrams illustrating secondary batteries of embodiments of the present invention.

FIG. 27 is a diagram illustrating a wound body of one embodiment of the present invention.

FIG. 28A and FIG. 28B are diagrams illustrating a secondary battery of one embodiment of the present invention.

FIG. 29A and FIG. 29B are diagrams illustrating a secondary battery of one embodiment of the present invention.

FIG. 30 is a diagram illustrating a secondary battery of one embodiment of the present invention.

FIG. 31 is a diagram illustrating a secondary battery of one embodiment of the present invention.

FIG. 32A to FIG. 32C are diagrams showing a fabrication process of a secondary battery of one embodiment of the present invention.

FIG. 33A to FIG. 33G are diagrams illustrating electronic devices of embodiments of the present invention, and FIG. 33H is a diagram illustrating an apparatus of one embodiment of the present invention.

FIG. 34A to FIG. 34C are diagrams illustrating an electronic device of one embodiment of the present invention.

FIG. 35 is a diagram illustrating electronic devices of embodiments of the present invention.

FIG. 36A to FIG. 36D are diagrams illustrating electronic devices of embodiments of the present invention.

FIG. 37A to FIG. 37C are diagrams illustrating electronic devices of embodiments of the present invention.

FIG. 38A to FIG. 38C are diagrams illustrating vehicles of embodiments of the present invention.

FIG. 39 shows graphs of cycle test results of cells each including a positive electrode active material of one embodiment of the present invention.

FIG. 40 shows graphs of cycle test results of cells each including a positive electrode active material of one embodiment of the present invention.

FIG. 41A to FIG. 41C are observation images of a positive electrode active material of one embodiment of the present invention.

FIG. 42A to FIG. 42C are observation images of a positive electrode active material of one embodiment of the present invention.

FIG. 43 shows graphs of cycle test results of cells each including a positive electrode active material of one embodiment of the present invention.

FIG. 44 shows graphs of cycle test results of cells each including a positive electrode active material of one embodiment of the present invention.

FIG. 45A to FIG. 45D are observation images of a positive electrode active material of one embodiment of the present invention.

FIG. 46A to FIG. 46D are diagrams illustrating crystal structures of a positive electrode active material of one embodiment of the present invention.

FIG. 47 is a graph showing energy barriers of crystal structures of a positive electrode active material of one embodiment of the present invention.

FIG. 48 is a diagram illustrating crystal structures of a positive electrode active material of one embodiment of the present invention.

FIG. 49 shows graphs of cycle test results of cells each including a positive electrode active material of one embodiment of the present invention.

FIG. 50A and FIG. 50B are observation images of a positive electrode active material of one embodiment of the present invention after a cycle test.

FIG. 51A and FIG. 51B are observation images of a positive electrode active material of one embodiment of the present invention after a cycle test.

FIG. 52A1 to FIG. 52C are observation images and the like of a positive electrode active material of one embodiment of the present invention after a cycle test.

FIG. 53A1 to FIG. 53C are observation images and the like of a positive electrode active material of one embodiment of the present invention after a cycle test.

FIG. 54A to FIG. 54C are observation images of a positive electrode active material of one embodiment of the present invention after a cycle test.

FIG. 55A to FIG. 55C are observation images of a positive electrode active material of one embodiment of the present invention after a cycle test.

FIG. 56A1 to FIG. 56B are observation images and the like of a positive electrode active material of one embodiment of the present invention after a cycle test.

FIG. 57A1 to FIG. 57B are observation images and the like of a positive electrode active material of one embodiment of the present invention after a cycle test.

FIG. 58A and FIG. 58B are an observation image and the like of a positive electrode active material of one embodiment of the present invention before a cycle test.

FIG. 59A to FIG. 59C are observation images and the like of a positive electrode active material of one embodiment of the present invention after a cycle test.

FIG. 60 is an observation image of a positive electrode active material of one embodiment of the present invention before a cycle test.

FIG. 61A and FIG. 61B are observation images of a positive electrode active material of one embodiment of the present invention after a cycle test.

FIG. 62 is a graph showing proportions of crystal structures of a positive electrode active material of one embodiment of the present invention.

FIG. 63A and FIG. 63B are images showing calculation results of pits in positive electrode active materials of embodiments of the present invention.

FIG. 64 is a diagram showing calculation results of pits in positive electrode active materials of embodiments of the present invention.

FIG. 65A to FIG. 65C are diagrams showing calculation results of pits in positive electrode active materials of embodiments of the present invention.

FIG. 66A and FIG. 66B are diagrams showing calculation results of pits in positive electrode active materials of embodiments of the present invention.

FIG. 67A and FIG. 67B are diagrams showing calculation results of pits in positive electrode active materials of embodiments of the present invention.

FIG. 68A to FIG. 68D are diagrams showing a growth mechanism of a pit in a positive electrode active material of one embodiment of the present invention.

FIG. 69A to FIG. 69C are observation images of a positive electrode active material of one embodiment of the present invention after a cycle test.

FIG. 70A to FIG. 70C are observation images of a positive electrode active material of one embodiment of the present invention after a cycle test.

FIG. 71A to FIG. 71E are diagrams showing crystal structures of a positive electrode active material of one embodiment of the present invention.

FIG. 72A to FIG. 72C are diagrams showing crystal structures of a positive electrode active material of one embodiment of the present invention.

### MODE FOR CARRYING OUT THE INVENTION

Examples of embodiments of the present invention are described below with reference to the drawings and the like. Note that the present invention should not be construed as being limited to the description of the examples of the embodiments below. Embodiments of the invention can be changed unless it deviates from the spirit of the present invention.

In this specification and the like, the Miller index is used for the expression of crystal planes and crystal orientations. An individual plane that shows a crystal plane is denoted by “( )”. In the crystallography, a bar is placed over a number in the expression of crystal planes, crystal orientations, and space groups; in this specification and the like, because of format limitations, crystal planes, crystal orientations, and space groups are sometimes expressed by placing − (minus sign) in front of the number instead of placing a bar over the number.

In this specification and the like, a charge depth is used as an indicator; the charge depth obtained when all the lithium that can be inserted and extracted is inserted is 0, and the charge depth obtained when all the lithium that can be inserted and extracted and is contained in a positive electrode active material is extracted is 1.

In this specification and the like, a theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material can be represented by x in a compositional formula, e.g., x in LiₓCoO₂ or x in Liₓ/MO₂. In the case of a positive electrode active material in a secondary battery, x can be represented by (theoretical capacity−charge capacity)/theoretical capacity. In the case where a secondary battery using LiCoO₂ as a positive electrode active material is charged to 219.2 mAh/g, it can be said that the positive electrode active material is represented by Li_{0.2}CoO₂, or x=0.2. Small x in LiₓCoO₂ means, for example, 0.1<x≤0.24.

In the case where lithium cobalt oxide substantially satisfies the stoichiometric composition, the lithium cobalt oxide is LiCoO₂ and the occupancy rate x of Li in lithium sites is 1. In a secondary battery after its discharging ends, it can be said that the lithium cobalt oxide is LiCoO₂ and x=1. Here, “discharging ends” means that a voltage becomes 2.5 V or lower (in the case of a lithium counter electrode) at a current of 100 mAh/g, for example. In a lithium-ion secondary battery, a voltage decreases steeply when the occupancy rate x of lithium in lithium sites becomes 1 and no more lithium is allowed to be inserted. It can be said that discharging ends at this time. In a general lithium-ion secondary battery using LiCoO₂, the discharge voltage decreases steeply before the discharge voltage reaches 2.5 V; thus, discharging is regarded as ending when the above condition is satisfied.

Examples of a cycle test include a half-cell test using a lithium metal for a counter electrode and a full-cell test using graphite or the like for a counter electrode. A positive electrode active material after a cycle test deteriorates. The deterioration caused by a cycle test is sometimes referred to as deterioration over time. The deterioration over time generates a defect in some cases. The defect is not generated uniformly in a positive electrode active material and generated locally in some cases. Furthermore, the defect sometimes progresses due to an influence of a cycle test or the like.

It is considered that the deterioration over time tends to be apparent after a cycle test under a severe condition such as a high temperature or a high upper limit voltage.

In order to improve the characteristics of a lithium-ion secondary battery, inhibiting deterioration of a positive electrode active material should be taken into account. The deterioration over time has not been fully elucidated yet. In view of this, as a result of earnest consideration on the deterioration over time, the present inventors and the like have considered that the deterioration over time reflects a decrease in discharge capacity retention rate.

### Embodiment 1

In this embodiment, a structure example 1 of a positive electrode active material of one embodiment of the present invention is described.

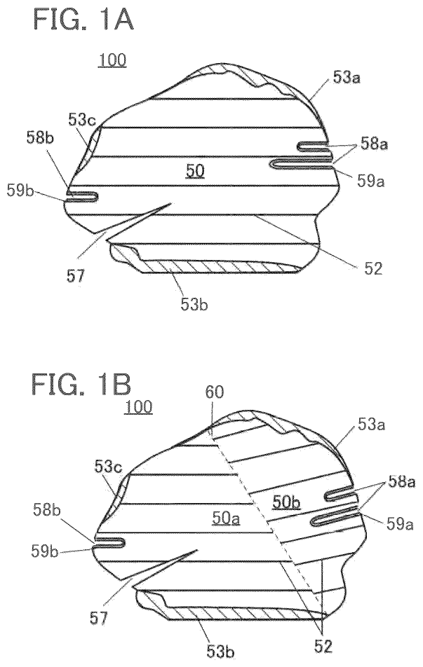

FIG. 1A and FIG. 1B each illustrate an example of a cross section of a particle including a positive electrode active material 100 (sometimes also referred to as a positive electrode active material particle) after a cycle test. Note that the positive electrode active material 100 is assumed to be a primary particle in the description and thus is referred to as a particle in some cases; however, the shape of the positive electrode active material is not limited to a particulate shape. Furthermore, the positive electrode active material 100 may be a secondary particle. The median diameter (D50) of the positive electrode active material 100 preferably satisfies the range of greater than or equal to 1 μm and less than or equal to 30 μm, further preferably greater than or equal to 5 μm and less than or equal to 20 μm.

The positive electrode active material 100 illustrated in FIG. 1A and FIG. 1B includes an inner portion 50 having a layered rock-salt crystal structure, and the inner portion 50 includes a crystal plane 52. Lithium composite oxide containing cobalt can be used as the positive electrode active material 100 having a layered rock-salt crystal structure, and the lithium composite oxide is, for example, lithium cobalt oxide (chemical formula: LiCoO₂, sometimes simply referred to as LCO). The composition of the lithium cobalt oxide is not strictly limited to Li:Co:O=1:1:2. In the case of LCO, the positive electrode active material 100 is often a primary particle. In addition, in the case of LCO, the crystal plane 52 corresponds to the crystal plane (001) or the like.

In lithium composite oxide other than LCO, one or more of Fe, Mn, Ni, and Co may be contained. Examples of the lithium composite oxide containing Ni, Mn, and Co include a NiCoMn-based material (NCM, also referred to as lithium nickel-cobalt-manganese oxide) represented by LiNiₓCo_{y}Mn_{z}O₂ (x>0, y>0, and 0.8<x+y+z<1.2). Specifically, 0.1x<y<8x and 0.1x<z<8x are preferably satisfied in the above. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof. In the case of NCM, primary particles are aggregated to form a secondary particle in some cases.

The positive electrode active material 100 contains an additive element as an element other than a main component, for example, an element other than cobalt, oxygen, and lithium, in the case of lithium cobalt oxide. The additive element contains at least magnesium or aluminum, and Embodiment 5 can be referred to for additive elements other than magnesium and aluminum. When an additive element is mixed and then heating is performed, the additive element is positioned at least in a surface portion of the positive electrode active material 100 in some cases. Regions in each of which the additive element is positioned sometimes exhibit a function of inhibiting deterioration of the inner portion 50, and are referred to as barrier layers 53a to 53c here. The barrier layers 53a to 53c may each contain a main component element, and may contain cobalt, for example. Containing the main component, the barrier layers 53a to 53c can transmit at least a carrier ion (e.g., lithium ion) and can be regarded as parts of the positive electrode active material 100.

Being positioned in the surface portion, the barrier layers 53a to 53c are in contact with a liquid electrolyte (sometimes also referred to as electrolyte solution). In this state, the additive element might be eluted to the electrolyte solution from any of the barrier layers 53a to 53c by a chemical reaction or an electrochemical reaction in a cycle test. Needless to say, the main component of the positive electrode active material, such as cobalt or oxygen contained in the barrier layers 53a to 53c, might also be eluted to the electrolyte solution. Because of various reasons including the possibility of elution, the states of the barrier layers 53a to 53c change after deterioration over time. For example, a barrier layer existing as a continuous film is divided in some cases. FIG. 1A and FIG. 1B each illustrate the barrier layers 53a to 53c that are divided as barrier layers after deterioration over time and positioned separately from each other. The barrier layers may be separated from each other before a cycle test. However, a continuous film is preferable in order to inhibit contact between the inner portion 50 and the electrolyte solution. Further preferably, the barrier layers have a uniform thickness. A decomposition reaction or the like occurs in a region where the inner portion 50 is in contact with the electrolyte solution, which might make it difficult to maintain a crystal structure and lead to a decrease in discharge capacity retention rate. In addition, the inner portion 50 preferably has a smooth surface in order that the barrier layer is formed as a continuous film and exists with a uniform thickness.

In the case where an additive element exists in the surface portion of the positive electrode active material 100, the concentration is higher than that in the inner portion 50 in some cases. This state can be expressed as a state where the additive element is unevenly distributed in the surface portion of the positive electrode active material 100. The unevenly distributed element may be referred to as an additive element.

In the case where the additive element is unevenly distributed in the surface portion, the additive element is not detected in the inner portion 50 in some cases. “The additive element is not detected” means that the concentration of the additive element is lower than or equal to the lower detection limit of a measurement device. Preferably, an additive element that does not contribute to an improvement in capacitance of the positive electrode active material 100 is not detected in the inner portion 50.

The positive electrode active material 100 includes a defect that is a factor of deterioration. FIG. 1A and FIG. 1B each illustrate a crack 57 as a defect and pits 58a and 58b as other defects.

The crack 57 is a crevice generated by application of physical stress. It is considered that the positive electrode active material 100 expands and contracts repeatedly during a cycle test. Volume change due to the repeated expansion and contraction probably applies physical stress on the positive electrode active material 100. The crack 57 generated by application of stress sometimes horizontally crosses the crystal plane 52, and has a tapered shape in a cross-sectional view in some cases.

The pits 58a and 58b are holes formed by extraction of some layers of a main component such as cobalt or oxygen in a cycle test, and include holes generated by pitting corrosion. For example, cobalt is considered to be eluted to the electrolyte solution in some cases, and elution of one layer of cobalt might result in formation of a hole that is referred to as a pit. The pit might progress in a cycle test to be a deep hole. In addition, the pits 58a and 58b are sometimes triggered by entering and leaving of lithium ions in a cycle test. In addition, the pits 58a and 58b might progress in accordance with volume change such as expansion and contraction of the positive electrode active material 100 in a cycle test; furthermore, the pits 58a and 58b might be triggered by the crack 57. The pits 58a and 58b rarely cross the crystal plane 52 horizontally in a cross-sectional view, and extend in a direction along the crystal plane 52. In most cases, the pit progresses with a constant width and has a tapered tip.

Although both the crack 57 and the pits 58a and 58b are defects, there seems to be various differences between them as described above.

The shape of an opening portion corresponding to entrance of the pits 58a and 58b is not limited to a circular shape and may be a rectangular shape. The width of the pits 58a and 58b or simply the width of a defect in a cross section is greater than or equal to 3 nm and less than or equal to 50 nm, preferably greater than or equal to 5 nm and less than or equal to 40 nm. The depth of the pits 58a and 58b or simply the depth of a defect is greater than or equal to 10 nm and less than or equal to 2 μm, preferably greater than or equal to 50 nm and less than or equal to 1.8 μm. The width and depth of the pits 58a and 58b are probably determined depending on the cycle test condition such as the number of cycles or the ambient temperature.

Since the electrolyte solution can enter the pits 58a and 58b with the above size, the positive electrode active material 100 in the vicinity of the pits 58a and 58b is also impregnated with the electrolyte solution. The positive electrode active material 100 impregnated with the electrolyte solution allows entering and leaving of lithium ions, but cannot maintain the layered rock-salt crystal structure because of the contact with the electrolyte solution, and thus is decreased in crystallinity in some cases. That is, the positive electrode active material 100 in the vicinity of the pit sometimes has lower crystallinity than the inner portion and includes an amorphous region, for example.

Such a positive electrode active material in the vicinity of a pit preferably includes a region containing the same element as the additive element. In FIG. 1A and FIG. 1B, regions in the vicinity of pits are denoted by 59a and 59b. A region in the vicinity of a pit where additive elements segregate is referred to as a region in the vicinity of a pit or simply referred to as a region in the vicinity of a defect. The thickness of the region in the vicinity of a pit in a cross-sectional view is 15 nm, preferably 10 nm, further preferably 5 nm.

The pit is often generated after a cycle test; at the time when the positive electrode active material 100 is completed, no pit is generated and of course no additive element exists in the vicinity of a pit. When a pit is generated due to a cycle test, the positive electrode active material 100 in the vicinity of the pit preferably includes a region containing the additive element. The present inventors and the like have found the correlation between the region and suppression of a decrease in discharge capacity retention rate. For example, the present inventors have assumed that the region suppresses the pit progress and accordingly inhibits a decrease in discharge capacity retention rate. In order to suppress the pit progress, the additive element preferably exists at least in the vicinity of the tip of the pit rather than in the vicinity of a side surface of the pit. The region becomes an amorphous region in some cases.

It can be considered that the additive element in the barrier layer enters the positive electrode active material through the pit. Alternatively, it can be considered that the additive element in the inner portion of the positive electrode active material 100 diffuses outwardly. In any cases, the additive element preferably exists in the positive electrode active material 100 in the vicinity of the pit.

When a model where the additive element comes from the barrier layer is considered, the additive element is probably eluted from the barrier layer to the electrolyte solution in a cycle test. In the subsequent cycle test, the additive element probably enters the positive electrode active material in the vicinity of the pit through the electrolyte solution, like lithium. In the case where the positive electrode active material is lithium cobalt oxide and the additive element is magnesium, the magnesium is sometimes positioned in lithium sites in the lithium cobalt oxide in the vicinity of the pit, and in the case where the additive element is aluminum, the aluminum is sometimes positioned in cobalt sites in the lithium cobalt oxide in the vicinity of the pit. The additive element positioned in each site preferably suppresses the pit progress.

The state where the additive element is positioned in each site in the positive electrode active material is regarded as a state where the additive element forms a solid solution in the positive electrode active material 100. That is, an additive element that forms a solid solution in the positive electrode active material is preferably used. Therefore, among the additive elements in the barrier layers, an element that does not form a solid solution is not positioned in the vicinity of the pit, in some cases. In this case, the kind of the additive element detected in the barrier layer is sometimes different from the kind of the additive element detected in the positive electrode active material in the vicinity of the pit.

Note that a cycle test can be regarded as corresponding to a usage mode of a lithium-ion secondary battery. Analysis of the positive electrode active material after a cycle test allows understanding of the state of the positive electrode active material of a lithium-ion secondary battery.

Note that distortion that causes the pits 58a and 58b is generated by difference in a lattice constant between a portion where a large amount of Li is extracted and a portion where Li is not extracted so much. The difference in a lattice constant can probably be reduced by a pit. A pit generated to reduce the difference in a lattice constant is formed deeply, and the depth of an adjacent pit is small. That is, adjacent pits are different from each other at least in the depth (see the pit 58a and the like in FIG. 1A and FIG. 1B). The depth of the pit is greater than or equal to nm and less than or equal to 100 nm, and a deep pit has a depth greater than or equal to 1.3 times and less than or equal to 5 times the depth of a shallow pit.

In consideration of such an effect of the pit, a positive electrode active material including a pit whose progress is suppressed seems to be preferable as compared with a positive electrode active material including no pit.

Since a pit is likely to be generated in a positive electrode active material with a layered rock-salt crystal structure, the pit progress is desired to be suppressed.

The positive electrode active material 100 illustrated in FIG. 1B is different from that in FIG. 1A in including a grain boundary 60, and is similar to that in FIG. 1A in the other structures. An inner portion 50a and an inner portion 50b are included with the grain boundary 60 as a boundary. The pits 58a and 58b are generated also in the positive electrode active material 100 including the grain boundary 60; thus, an additive element preferably exists in the vicinities 59a and 59b of the pits to suppress the progress of the pits.

When a cycle test is performed while the positive electrode active material is in contact with the electrolyte solution or the like, oxidation decomposition of an organic solvent of an electrolyte occurs and the decomposed product might form a coating film on the positive electrode active material. The coating film includes the organic solvent, and thus has a composition different from that of the barrier layer containing the above additive element.

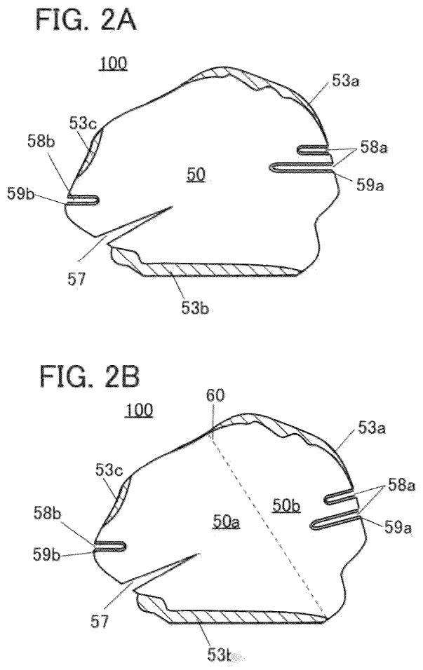

FIG. 2A and FIG. 2B illustrate cross section examples of the positive electrode active material 100 after a cycle test, in which the crystal planes illustrated FIG. 1A and FIG. 1B are omitted. The structures other than the crystal planes are similar to the structures described with reference to FIG. 1A and FIG. 1B.

This embodiment can be used in appropriate combination with any of the other embodiments.

### Embodiment 2

In this embodiment, a structure example 2 of the positive electrode active material of one embodiment of the present invention is described.

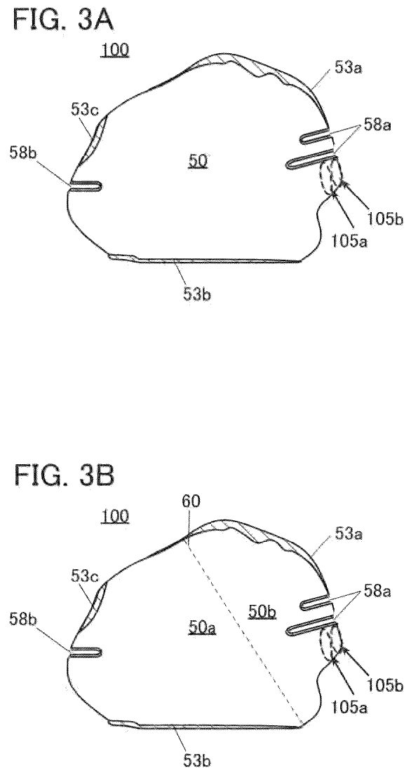

FIG. 3A and FIG. 3B illustrate cross section examples of a particle including the positive electrode active material 100 after a cycle test. Note that the positive electrode active material 100 is assumed to be a primary particle in the description and thus is referred to as a particle in some cases; however, the shape of the positive electrode active material is not limited to a particulate shape. Furthermore, the positive electrode active material 100 may be a secondary particle. The median diameter (D50) of the positive electrode active material 100 preferably satisfies the range of greater than or equal to 1 μm and less than or equal to 30 μm, preferably greater than or equal to 5 μm and less than or equal to 20 μm.

The positive electrode active material 100 illustrated in FIG. 3A and FIG. 3B includes the inner portion 50 having a layered rock-salt crystal structure, and the crystal planes 52 included in the positive electrode active material 100 are omitted in FIG. 3A and FIG. 3B. As described in Embodiment 1 or the like, LCO or NCM can be used as the positive electrode active material having a layered rock-salt crystal structure. Furthermore, the positive electrode active material may contain an additive element, as described in Embodiment 1 or the like.

The positive electrode active material 100 illustrated in FIG. 3A and FIG. 3B further includes the barrier layers 53a to 53c selectively, and the barrier layers 53a to 53c are preferably positioned in the surface portion of the positive electrode active material 100. The barrier layers 53a to 53c positioned in the surface portion can inhibit contact between the inner portion 50 and an electrolyte solution. The barrier layers 53a to 53c preferably contain an additive element. A region where the additive element is positioned exhibits a function of inhibiting deterioration of the positive electrode active material; thus, the barrier layers 53a to 53c positioned in the surface portion can inhibit deterioration of the inner portion 50. Note that regions that are in the surface portion of the positive electrode active material 100 and contain the additive element can be determined to be the barrier layers 53a to 53c.

Note that the state of the barrier layers 53a to 53c might change due to a cycle test. For example, the barrier layers 53a to 53c before a cycle test preferably have a larger area for covering the positive electrode active material 100 than those after the cycle test, and further preferably form a barrier layer that is like a continuous film. Needless to say, the barrier layers may be separated from each other before a cycle test. The barrier layers 53a to 53c preferably exist with a uniform thickness in a cross section of the positive electrode active material, and for the existence with a uniform thickness, the inner portion 50 preferably has a smooth surface.

In the case where the additive element exists in the surface portion of the positive electrode active material 100, the concentration of the additive element is higher than that in the inner portion 50 in some cases. This state can be expressed as a state where the additive element is unevenly distributed in the surface portion of the positive electrode active material 100. The unevenly distributed element may be referred to as an additive element.

In the case where the additive element is unevenly distributed in the surface portion, the additive element is not detected in the inner portion 50 in some cases. “The additive element is not detected” means that the concentration of the additive element is lower than or equal to the lower detection limit of a measurement device. An additive element that does not contribute to an improvement in battery characteristics such as capacitance of the positive electrode active material 100, for example, preferably has a concentration that does not allow the additive element to be detected in the inner portion 50.

The barrier layers 53a to 53c may contain a main component element, and may contain cobalt when the positive electrode active material is LCO. Containing the main component, the barrier layers 53a to 53c can transmit at least a carrier ion (e.g., lithium ion) and can be regarded as parts of the positive electrode active material 100.

FIG. 3A and FIG. 3B illustrate the positive electrode active material 100 including defects after a cycle test, and illustrate the pits 58a and 58b as examples of the defects.

The positive electrode active material 100 illustrated in FIG. 3B is different from that in FIG. 3A in including the grain boundary 60, and the inner portion 50a and the inner portion 50b are separately illustrated with the grain boundary 60 as a boundary. The positive electrode active material 100 illustrated in FIG. 3B is similar to that in FIG. 3A in the other structures.

The inner portion 50 of the positive electrode active material 100 preferably has a layered rock-salt crystal structure. A composite oxide containing cobalt can be used as the positive electrode active material having a layered rock-salt crystal structure; examples of the composite oxide include lithium cobalt oxide (LiCoO₂, sometimes simply referred to as LCO) and lithium nickel-cobalt-manganese oxide (sometimes simply referred to as NCM). In the case of LCO, the positive electrode active material 100 is often a primary particle. In the case of NCM, primary particles are often aggregated to form a secondary particle.

The generation mechanism of the pits 58a and 58b illustrated in FIG. 3A and FIG. 3B is described.

The pits 58a and 58b are holes formed by extraction of some layers of cobalt or oxygen that is a main component of the positive electrode active material 100 due to a cycle test, and include holes generated by pitting corrosion. The pits 58a and 58b begin to be generated from the surface portion of the positive electrode active material 100, which is because the surface portion is under the condition where cobalt or oxygen is released. The surface of the positive electrode active material 100 is in contact with the electrolyte solution and the positive electrode active material is impregnated with the electrolyte solution. That is, the surface portion of the positive electrode active material 100 is under the condition of being in contact with the electrolyte solution. When a material that easily reacts with oxygen is used for the electrolyte solution, oxygen contained in the positive electrode active material 100 reacts with the electrolyte solution; accordingly, a Co—O bond (cobalt-oxygen bond) at least in the surface portion is cut. The cobalt cut from the bond is considered to diffuse into the inner portion 50 as well as the electrolyte solution. This is because cobalt is considered to move mainly to lithium sites. Lithium ions do not exist in the lithium sites at the time of charging, which allows cobalt to easily move to the lithium sites. When the Co—O bond in the surface portion is cut, oxygen is desorbed, and cobalt diffuses as described above, the crystal structure of the surface portion probably changes.

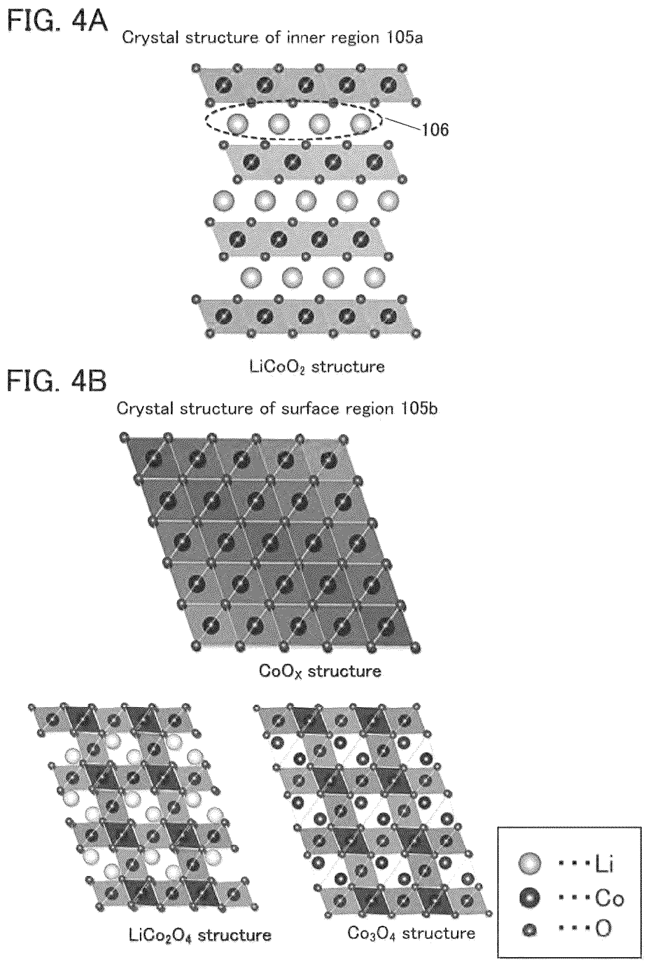

The change in the crystal structure is described. FIG. 4A illustrates a crystal structure included in a region in an inner portion (inner region) 105a illustrated in FIG. 3A and FIG. 3B. The inner region 105a has a LiCoO₂ structure (sometimes simply referred to as an LCO structure), and there seems to be little or no change from the LCO structure after a cycle test because the contact with the electrolyte solution is small. Note that the LCO structure is a layered rock-salt crystal structure, and a lithium layer 106 can be observed.

FIG. 4B illustrates crystal structures included in a region in a surface portion (a surface region) 105b illustrated in FIG. 3A and FIG. 3B. FIG. 4B illustrates a state after a cycle test, where at least CoO and LiCo₂O₄ or Co₃O₄ exist in the surface region 105b. Note that a cobalt oxide might include an oxygen vacancy or a cobalt vacancy, and is not limited to have a composition according to the compositional formula. For example, CoO can be represented as CoOx in consideration of the vacancy, in which x is in the neighborhood of 1, specifically greater than or equal to 0.9 and less than or equal to 1.1.

Note that CoO has a rock-salt structure in which no Li layer is observed. In addition, LiCo₂O₄ has a spinel structure in which lithium can be observed but a lithium layer is different from that in a layered rock-salt crystal structure, and Co₃O₄ has a spinel structure in which no Li layer can be observed. Li is less likely to enter and leave in the spinel structure than in the LCO structure. Furthermore, CoO is positioned closer to the surface of the positive electrode active material 100 than LiCo₂O₄ or Co₃O₄. CoO exists at a position where the contact with the electrolyte solution is the largest, but has a crystal structure that does not allow entering and leaving of Li.

The surface region 105b is in contact with the electrolyte solution or impregnated with the electrolyte solution, which probably causes a change in the crystal structure before and after a cycle test. The present inventors and the like have considered that it is important to understand at least the crystal structure, particularly the crystal structure of the surface portion after the cycle test to grasp the generation mechanism of a pit.

Note that the surface portion is a region that can be impregnated with the electrolyte solution, and include the surface of the positive electrode active material 100. Specifically, the surface portion includes a region from the surface of the positive electrode active material 100 to a depth of 20 nm.

The pits 58a and 58b illustrated in FIG. 3A and FIG. 3B progress in a cycle test in some cases. In other words, the pits 58a and 58b grow in some cases. The progressed pits 58a and 58b often have a constant width in a cross-sectional view. The reason why the width is often constant is that at least CoO exists in the surface portion after the cycle test. It can be considered that CoO exists also in the surface portion where the pits 58a and 58b are formed. Although cobalt moves so as to diffuse into the lithium sites as described above, no lithium site can be observed in CoO. Thus, the cobalt moves to the LCO structure side including the lithium sites. The LCO structure side is the inner portion 50. This is the growth mechanism of the pits 58a and 58b, and is also the reason why the pits 58a and 58b are formed with a constant width. The width of the pits 58a and 58b is greater than or equal to 5 nm and less than or equal to 50 nm, preferably greater than or equal to 10 nm and less than or equal to 40 nm. The depth of the pits 58a and 58b is greater than or equal to 100 nm and less than or equal to 2 μm, preferably greater than or equal to 150 nm and less than or equal to 1.8 μm.

Examples of the defect other than the pits 58a and 58b include a crack and a slip.

As described above, the surface portion of the positive electrode active material 100 easily deteriorates due to the contact with the electrolyte solution, and the reaction between the electrolyte solution and the positive electrode active material, for example, is also deemed to be a factor of generation trigger and progress of the pits 58a and 58b that are defects.

The above suggests that the positive electrode active material 100 where at least a pit is observed after a cycle test deteriorates. This is because lithium ions are less likely to enter and leave in the spinel structure than in the LCO structure.

In view of this, the present inventors have found a structure where the barrier layers 53a to 53c are provided in the surface portion of the positive electrode active material 100, as illustrated in FIG. 3A and FIG. 3B. The barrier layers 53a to 53c may contain a main component element, and may contain cobalt, for example. When containing the main component element, the barrier layers 53a to 53c can have a crystal structure similar to that of the inner portion 50 and can transmit a carrier ion (e.g., lithium ion). That is, the barrier layer containing the main component (e.g., cobalt) of the positive electrode active material is regarded as part of the positive electrode active material 100. Being positioned in the surface portion, the barrier layers 53a to 53c can prevent contact between the inner portion 50 and a liquid electrolyte (electrolyte solution).

The barrier layers 53a to 53c contain an additive element as an element other than a component element, for example, an element other than cobalt, oxygen, and lithium, in the case of lithium cobalt oxide. The additive element contains at least magnesium, fluorine, nickel, aluminum, or zirconium. Refer to Embodiment 3 for the other additive elements. When lithium cobalt oxide or the like where an additive element is mixed is heated, the additive element positioned at least in the surface portion of the positive electrode active material 100 can be observed.

Even when having the same crystal structure as the inner portion 50, the barrier layers 53a to 53c are different from the inner portion 50 in containing the additive element. When the additive element is contained, lithium is less likely to be extracted even in a charged state and thus the crystal structure is less likely to be broken. When lithium is not extracted, no lithium site is formed and thus cobalt diffusion into the lithium site does not occur. Therefore, the barrier layers 53a to 53c are considered to be able to maintain the same crystal structure as the inner portion 50 when being positioned in the surface portion. Thus, a pit is less likely to be generated in the barrier layers 53a to 53c, which indicates a high function of preventing contact between the electrolyte solution and the inner portion 50.

FIG. 3A and FIG. 3B each illustrate a state where the barrier layers 53a to 53c are separated from each other. In order to inhibit contact between the inner portion 50 and the electrolyte solution, the barrier layers preferably exist as a continuous film. Further preferably, the barrier layers have a uniform thickness. The inner portion 50 preferably has a smooth surface, in which case the barrier layers are easily formed as a continuous film. In addition, the inner portion 50 preferably has a smooth surface, in which case the barrier layers can have a uniform thickness.

In the case where an additive element exists in the surface portion of the positive electrode active material 100, the concentration is higher than that in the inner portion 50 in some cases. This state can be expressed as a state where the additive element is unevenly distributed in the surface portion of the positive electrode active material 100. The unevenly distributed element may be referred to as an additive element. The concentration of the additive element in the barrier layers 53a to 53c positioned in the surface portion is also higher than that in the inner portion 50 in many cases.

In the case where the additive element is unevenly distributed in the surface portion, the additive element is not detected in the inner portion 50 in some cases. “The additive element is not detected” means that the concentration of the additive element is lower than or equal to the lower detection limit of a measurement device. It is preferable that an additive element that does not contribute to an improvement in capacitance of the positive electrode active material 100 be not detected in the inner portion 50.

When a cycle test is performed while the positive electrode active material is in contact with the electrolyte solution or the like, oxidation decomposition of an organic solvent of an electrolyte occurs and the decomposed product might form a coating film on the positive electrode active material. The coating film includes the organic solvent, and thus has a composition different from that of the barrier layer containing the above additive element.

Note that a cycle test is regarded as corresponding to a usage mode of a lithium-ion secondary battery. Analysis of the positive electrode active material after a cycle test allows understanding of the state of the positive electrode active material of a lithium-ion secondary battery.

Note that distortion that causes the pits 58a and 58b is generated by difference in a lattice constant between a portion where a large amount of Li is extracted and a portion where Li is not extracted so much. The difference in a lattice constant can probably be reduced by a pit. A pit generated to reduce the difference in the lattice constant is formed deeply, and the depth of an adjacent pit is small. That is, adjacent pits are different from each other at least in the depth (see the pit 58a and the like in FIG. 3A and FIG. 3B). The depth of the pit is greater than or equal to nm and less than or equal to 100 nm, and a deep pit has a depth greater than or equal to 1.3 times and less than or equal to 5 times the depth of a shallow pit.

This embodiment can be used in appropriate combination with any of the other embodiments.

### Embodiment 3

In this embodiment, a structure example 3 of a positive electrode active material of one embodiment of the present invention is described.

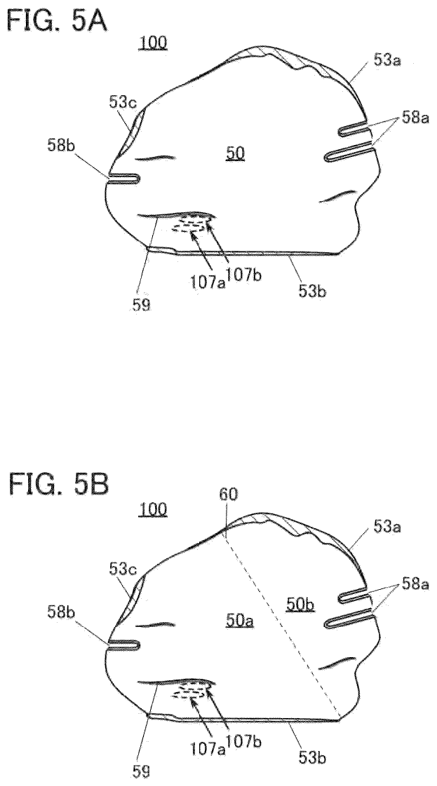

FIG. 5A and FIG. 5B illustrate cross section examples of a particle including the positive electrode active material 100 after a cycle test. Note that the positive electrode active material 100 is assumed to be a primary particle in the description and thus is referred to as a particle in some cases; however, the shape of the positive electrode active material is not limited to a particulate shape. Furthermore, the positive electrode active material 100 may be a secondary particle. The median diameter (D50) of the positive electrode active material 100 preferably satisfies the range of greater than or equal to 1 μm and less than or equal to 30 μm, preferably greater than or equal to 5 μm and less than or equal to 20 μm.

The positive electrode active material 100 illustrated in FIG. 5A and FIG. 5B includes the inner portion 50 having a layered rock-salt crystal structure, and the crystal planes 52 included in the positive electrode active material 100 are omitted in FIG. 5A and FIG. 5B. As described in Embodiment 1 or the like, LCO or NCM can be used as the positive electrode active material having a layered rock-salt crystal structure. Furthermore, the positive electrode active material may contain an additive element, as described in Embodiment 1 or the like.

The positive electrode active material 100 illustrated in FIG. 5A and FIG. 5B further includes the barrier layers 53a to 53c selectively. The barrier layers 53a to 53c are as described in Embodiments 1 and 2.

The positive electrode active material 100 includes a defect after a cycle test; in FIG. 5A and FIG. 5B, a closed split (hereinafter, simply referred to as split) 61 is illustrated as the defect existing in the inner portion 50.

The split 61 exists in the inner portion 50, and thus is considered to be generated by factors including a factor different from that of a pit. For example, the splits 61 are formed a lot in the positive electrode active material 100 exposed to high temperature (higher than or equal to ° C.) in a cycle test. In the positive electrode active material 100 exposed to room temperature (25° C.) in a cycle test, no split is detected or only undetectable split is formed.

The positive electrode active material 100 illustrated in FIG. 5B is different from that in FIG. 5A in including the grain boundary 60, and the inner portion 50a and the inner portion 50b are separately illustrated with the grain boundary 60 as a boundary. The positive electrode active material 100 illustrated in FIG. 5B is similar to that in FIG. 5A in the other structures.

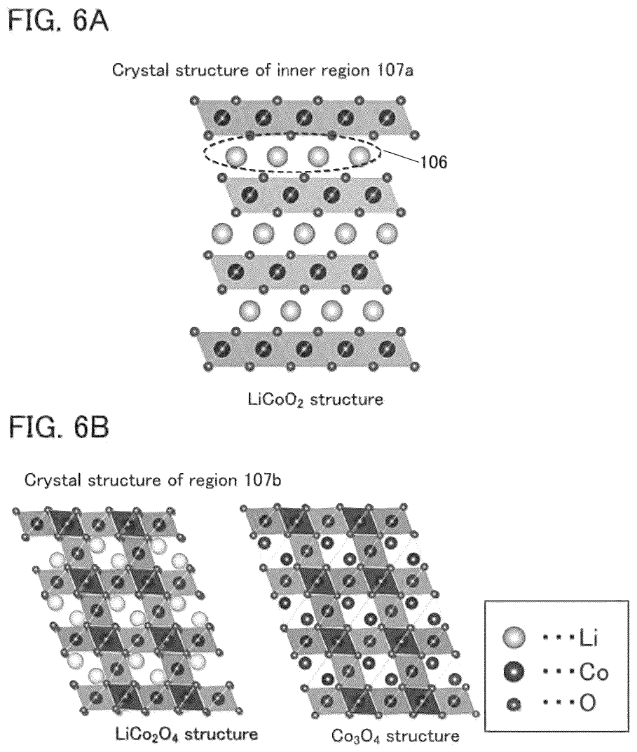

The change in the crystal structure is described. FIG. 6A illustrates a crystal structure included in a region in an inner portion (an inner region) 107a illustrated in FIG. 5A and FIG. 5B. The inner region 107a has a LiCoO₂ structure, and there seems to be little or no change from the LCO structure because the contact with the electrolyte solution is small. Note that the LCO structure is a layered rock-salt crystal structure, and the lithium layer 106 can be observed.

FIG. 6B illustrates a crystal structure included in a region 107b in the vicinity of the split 61 (a region in the vicinity of a split) illustrated in FIG. 5A and FIG. 5B. FIG. 6B illustrates a state after a cycle test, where LiCo₂O₄ or Co₃O₄ exists at least in the region 107b in the vicinity of a pit. CoO does not exist in the region 107b in the vicinity of a pit. It is found that LiCo₂O₄ has a spinel structure in which lithium can be observed but a lithium layer is different from that in a layered rock-salt crystal structure, and Co₃O₄ has a spinel structure in which no Li layer can be observed. Li is less likely to enter and leave in the spinel structure than in the LCO structure.

The positive electrode active material 100 in which a split is observed after a cycle test is found to have a spinel structure, which indicates that lithium ions are less likely to enter and leave in the spinel structure. It is probable that the split is also a factor of deterioration after a cycle test. Thus, an additive element, for example, is preferably added so as to be distributed uniformly in the inner portion 50 to inhibit generation of a split.

In addition to the pit formation and crystal structure change in the surface portion which are described in Embodiment 1, the split or the like described in this embodiment is also considered to be a factor of deterioration.

This embodiment can be used in appropriate combination with any of the other embodiments.

### Embodiment 4

In this embodiment, a structure example 4 of a positive electrode active material of one embodiment of the present invention is described.

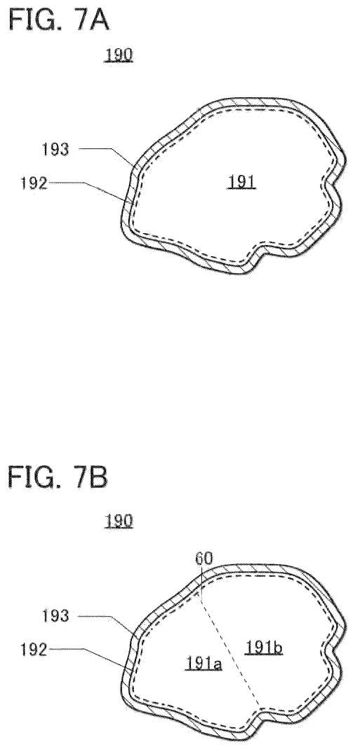

FIG. 7A and FIG. 7B illustrate cross section examples of a particle including the positive electrode active material 190 after a cycle test. Note that a positive electrode active material 190 is assumed to be a primary particle in the description and thus is referred to as a particle in some cases; however, the shape of the positive electrode active material is not limited to a particulate shape. Furthermore, the positive electrode active material 190 may be a secondary particle. The median diameter (D50) of the positive electrode active material 190 preferably satisfies the range of greater than or equal to 1 μm and less than or equal to 30 μm, preferably greater than or equal to 5 μm and less than or equal to 20 μm.

The positive electrode active material 190 illustrated in FIG. 7A and FIG. 7B includes an inner portion 191 having a layered rock-salt crystal structure, and crystal planes included in the positive electrode active material 190 are omitted in FIG. 7A and FIG. 7B. As described in Embodiment 1 or the like, LCO or NCM can be used as the positive electrode active material having a layered rock-salt crystal structure. Furthermore, the positive electrode active material may contain an additive element, as described in Embodiment 1 or the like.

The positive electrode active material 190 illustrated in FIG. 7A and FIG. 7B further includes a barrier layer 192. Although an example where the barrier layer 192 is provided as a continuous layer before a cycle test is described here, the barrier layer may be provided selectively before the cycle test. Note that the effect or the like of the barrier layer 192 is as described for the barrier layers 53a to 53c in Embodiments 1 and 2.

The positive electrode active material 190 illustrated in FIG. 7A and FIG. 7B further includes a shell layer 193 outside the barrier layer 192. The shell layer 193 is a continuous layer in the illustrated example, but is provided selectively in some cases. As described in the above embodiment, the barrier layer 192 is preferably provided to inhibit generation or progress of a pit. However, being exposed to an electrolyte solution, the barrier layer is likely to have a change in its state and is difficult to exist as a continuous layer in some cases. In view of this, the shell layer 193 is provided to protect the barrier layer 192. As a result, generation or progress of a pit in the positive electrode active material 190 is inhibited, and accordingly the discharge capacity retention rate is less likely to decrease after a cycle test. In the case where a cycle test is performed at high temperature (e.g., higher than or equal to 45° C.), providing the shell layer 193 is effective to inhibit disappearance of the barrier layer 192.

The barrier layer 192 and the shell layer 193 are positioned in the surface portion, not in the inner portion 191. The inner portion 191 is sometimes referred to as a core with respect to a cell. The barrier layer 192 contains an additive element different from the main component of the inner portion 191. Therefore, the barrier layer 192 is referred to as an impurity layer in some cases.

The thickness of the shell layer 193 is preferably larger than the thickness of the barrier layer 192. This enables effective protection of the barrier layer 192. For example, the thickness of the shell layer 193 in a cross section is preferably greater than or equal to 1.2 times and less than or equal to 3 times the thickness of the barrier layer 192.

The shell layer 193 can be obtained through a composite-making process using a first material and a second material. The first material corresponds to the positive electrode active material including the barrier layer. The second material corresponds to the shell layer. As the second material, an active material that can occlude and release lithium may be used. For example, as the second material, one or more of an oxide and LiM₂PO₄ (M2 is one or more selected from Fe, Ni, Co, and Mn) that has an olivine crystal structure can be used. Examples of the oxide include aluminum oxide, zirconium oxide, hafnium oxide, and niobium oxide. Examples of the LiMPO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

As the composite-making process, any one or more of the following composite-making processes can be used: a composite-making process utilizing mechanical energy such as a mechanochemical process, a mechanofusion process, and a ball mill process; a composite-making process utilizing a liquid phase reaction such as a coprecipitation process, a hydrothermal process, and a sol-gel process; and a composite-making process utilizing a gas phase reaction such as a barrel sputtering process, an ALD (Atomic Layer Deposition) process, an evaporation process, and a CVD (Chemical Vapor Deposition) process. After the composite-making process, heat treatment is preferably performed. Note that the composite-making process is sometimes referred to as a surface coating process or a coating process.

The positive electrode active material 190 illustrated in FIG. 7B is different from that in FIG. 7A in including the grain boundary 60, and an inner portion 191a and an inner portion 191b are separately illustrated with the grain boundary 60 as a boundary. The positive electrode active material 100 illustrated in FIG. 7B is similar to that in FIG. 7A in the other structures.

This embodiment can be used in appropriate combination with any of the other embodiments.

### Embodiment 5

In this embodiment, a method for fabricating a positive electrode active material of one embodiment of the present invention is described.

### <<Fabrication Method 1 of Positive Electrode Active Material>>

### <Step S11>

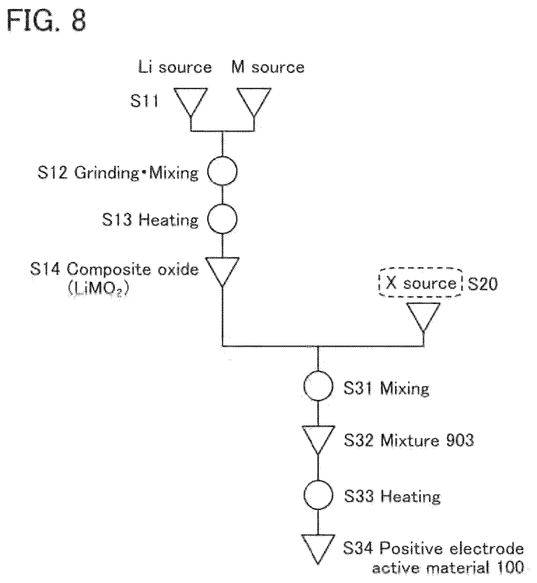

In Step S11 shown in FIG. 8, a lithium source (Li source) and a transition metal source (M source) are prepared as materials for lithium and a transition metal which are starting materials.

A compound containing lithium is preferably used as the lithium source, and for example, lithium carbonate, lithium hydroxide, lithium nitrate, lithium fluoride, or the like can be used. The lithium source preferably has a high purity and is preferably a material having a purity of higher than or equal to 99.99%, for example.

The transition metal can be selected from the elements belonging to Group 4 to Group 13 of the periodic table and for example, at least one of manganese, cobalt, and nickel is used. As the transition metal, for example, cobalt alone; nickel alone; two metals of cobalt and manganese; two metals of cobalt and nickel; or three metals of cobalt, manganese, and nickel may be used. When the transition metal is cobalt alone, the positive electrode active material to be obtained contains lithium cobalt oxide (LCO); when the transition metal is three metals of cobalt, manganese, and nickel, the positive electrode active material to be obtained contains lithium nickel cobalt manganese oxide (NCM).

As the transition metal source, a compound containing the above transition metal is preferably used and for example, an oxide, a hydroxide, or the like of any of the metals given as examples of the transition metal can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal source preferably has high purity, and for example, it is preferable to use a material having purity higher than or equal to 3N (99.9%), further preferably higher than or equal to 4N (99.99%), still further preferably higher than or equal to 4N5 (99.995%), yet still further preferably higher than or equal to 5N (99.999%). Impurities of the positive electrode active material can be controlled by using such a high-purity material. As a result, the capacity of a secondary battery is increased and/or the reliability of the secondary battery is improved.

Furthermore, the transition metal source preferably has high crystallinity and for example, preferably includes single crystal particles. To evaluate the crystallinity of the transition metal source, for example, the crystallinity can be judged with a TEM (transmission electron microscope) image, a STEM (scanning transmission electron microscope) image, an HAADF-STEM (high-angle annular dark field scanning transmission electron microscope) image, an ABF-STEM (annular bright-field scan transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal source.

In the case of using two or more transition metal sources, the two or more transition metal sources are preferably prepared to have proportions (mixing ratio) such that a layered rock-salt crystal structure would be obtained.

### <Step S12>

Next, in Step S12 shown in FIG. 8, the lithium source and the transition metal source are ground and mixed to form a mixed material. The grinding and mixing can be performed by a dry process or a wet process. A wet process is preferable because it can grind a material into a smaller size. When the mixing is performed by a wet process, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

As a means for the mixing or the like, a ball mill, a bead mill, or the like can be used. In the case where a ball mill is used, alumina balls or zirconia balls are preferably used as a grinding medium. Zirconia balls are preferable because they release fewer impurities. In the case where a ball mill, a bead mill, or the like is used, the peripheral speed is preferably greater than or equal to 100 mm/s and less than or equal to 2000 mm/s in order to inhibit contamination from the media or the material. In this embodiment, mixing is performed at a peripheral speed of 838 mm/s (the rotation speed: 400 rpm, the ball mill diameter: 40 mm).

### <Step S13>

Next, in Step S13 shown in FIG. 8, the mixed material is heated. The heating temperature is preferably higher than or equal to 800° C. and lower than or equal to 1100° C., further preferably higher than or equal to 900° C. and lower than or equal to 1000° C., and still further preferably approximately 950° C. An excessively low temperature might lead to insufficient decomposition and melting of the lithium source and the transition metal source. An excessively high temperature might lead to a defect due to evaporation or sublimation of lithium from the lithium source and/or excessive reduction of the metal used as the transition metal source, for example. The defect is, for example, an oxygen defect which could be induced by a change of trivalent cobalt into divalent cobalt due to excessive reduction, in the case where cobalt is used as the transition metal. Since the defect relates to deterioration of the positive electrode active material, the number of defects is preferably as small as possible.

The heating time is preferably longer than or equal to 1 hour and shorter than or equal to 100 hours, further preferably longer than or equal to 2 hours and shorter than or equal to 20 hours.

A temperature raising rate is preferably higher than or equal to 80° C./h and lower than or equal to 250° C./h, although depending on the end-point temperature of the heating. For example, in the case of heating at 1000° C. for 10 hours, the temperature raising is preferably at 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, flowing of oxygen is not necessarily performed. For example, a method may be employed in which the pressure in the reaction chamber is reduced and then the reaction chamber is filled with oxygen so that the oxygen does not enter or exit in/from the reaction chamber; this method is referred to as purging. For example, the pressure in the reaction chamber may be reduced to −970 hPa, and then the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. The heating with a rotary kiln can be performed while stirring is performed in either case of a sequential rotary kiln or a batch-type rotary kiln. In a rotary kiln or a roller hearth kiln, oxygen is preferably flowed.

A crucible or a sagger used in heating is preferably made of alumina, in which case impurities are less likely to enter during mixing with the crucible or the sagger. In this embodiment, a crucible made of alumina with a purity of 99.9% is used. Heating is preferably performed with a rid put on the crucible. This can prevent evaporation or sublimation of a material.

After the heating is finished, the heated material is ground as needed and may be made to pass through a sieve. Before collection of the heated material, the material may be moved from the crucible to a mortar. An alumina mortar is preferably used as the mortar, in which case impurities are less likely to enter during mixing with the mortar. Specifically, it is preferable to use a mortar made of alumina with a purity of higher than or equal to 90%, preferably higher than or equal to 99%. Note that heating conditions equivalent to those in Step S13 can be employed in a later-described heating step other than Step S13.

### <Step S14>

Through the above steps, a composite oxide containing the transition metal (LiMO₂) can be obtained in Step S14 shown in FIG. 8. Here, the composite oxide needs to have a crystal structure of the lithium composite oxide represented by LiMO₂, but the composition is not strictly limited to Li:M:O=1:1:2. When cobalt is used as the transition metal, the composite oxide is referred to as a composite oxide containing cobalt. Furthermore, in the case where cobalt is used as the transition metal, lithium cobalt oxide represented by LiCoO₂ can be obtained in Step S14. The composition of the lithium cobalt oxide is not strictly limited to Li:Co:O=1:1:2.

Although the example is described in which the composite oxide is fabricated by a solid phase method as in Step S11 to Step S14, the composite oxide may be fabricated by a coprecipitation method. Alternatively, the composite oxide may be fabricated by a hydrothermal method.

### <Step S20>

An additive element X may be added to the composite oxide as long as a layered rock-salt crystal structure is obtained. A step of adding the additive element is described.

In Step S20 shown in FIG. 8, an additive element source (X source) to be added to the composite oxide is prepared. A lithium source may be prepared together with the additive element source.

As the additive element, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or both of bromine and beryllium can be used. Note that the above-described additive elements are more suitably used because bromine and beryllium are elements having toxicity to living things.

For the addition of the additive element X, a solid phase method, a liquid phase method such as a sol-gel method, a sputtering method, an evaporation method, a CVD (chemical vapor deposition) method, a PLD (pulsed laser deposition) method, or the like can be used.

When magnesium is selected as the additive element, the additive element source can be referred to as a magnesium source. As the magnesium source, for example, magnesium fluoride, magnesium oxide, magnesium hydroxide, or magnesium carbonate can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ or CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. Among them, lithium fluoride, which has a relatively low melting point of 848° C., is preferable because it is easily melted in a heating process described later.

Magnesium fluoride can be used as both the fluorine source and the magnesium source. Lithium fluoride can also be used as both the fluorine source and the lithium source. Another example of the lithium source that can be used in Step S20 is lithium carbonate.

The fluorine source may be a gas, and for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of lowering the melting point becomes the highest. On the other hand, when the amount of lithium fluoride increases, cycle performance might deteriorate because of too large an amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 and the neighborhood thereof). Note that the neighborhood means a value greater than 0.9 times and less than 1.1 times 0.33.

Next, as the additive element source (X source), a magnesium source and a fluorine source are ground and mixed. This step can be performed under any of the conditions for the grinding and mixing selected from those described for Step S12.

Next, a heating step may be performed as needed. The heating step can be performed under any of the heating conditions selected from those described for Step S13. The heating time is preferably longer than or equal to 2 hours and the heating temperature is preferably higher than or equal to 800° C. and lower than or equal to 1100° C. The materials ground and mixed in the above step are collected, so that the additive element source (X source) can be obtained. Note that the obtained additive element source is formed of a plurality of starting materials and can be referred to as a mixture. Note that the obtained additive element source is referred to as a mixture even when being formed of one kind of starting material.

As for the particle diameter of the mixture, the median diameter (D50) is preferably greater than or equal to 600 nm and less than or equal to 20 μm, further preferably greater than or equal to 1 μm and less than or equal to 10 μm. Also when one kind of material is used as the additive element source, the median diameter (D50) is preferably greater than or equal to 600 nm and less than or equal to 20 μm, and further preferably greater than or equal to 1 μm and less than or equal to 10 μm.

When mixed with a composite oxide in a later step, the mixture thus pulverized is easily attached to surfaces of composite oxide particles uniformly. The mixture is preferably attached to the surfaces of the composite oxides uniformly, in which case at least magnesium is easily distributed in or diffused to the surface portions of the composite oxides uniformly after heating. A region where magnesium is distributed can be referred to as a surface portion. When the surface portion includes a region not containing magnesium, the positive electrode active material might be less likely to have an O3′ type crystal structure, which is described later, in a charged state.

Although the example where two kinds of additive element sources, which are the magnesium source and the fluorine source, are prepared is described above, three or more kinds of additive element sources may be added to the composite oxide.

For example, four kinds of additive element sources, which are a magnesium source (Mg source), a fluorine source (F source), a nickel source (Ni source), and an aluminum source (Al source), can be prepared. Note that the magnesium source and the fluorine source can be selected from the compounds and the like described above. As the nickel source, nickel oxide, nickel hydroxide, or the like can be used. As the aluminum source, aluminum oxide, aluminum hydroxide, or the like can be used.

### <Step S31>

Next, in Step S31 shown in FIG. 8, the composite oxide and the additive element source (X source) are mixed. The ratio of the number A_{M} of transition metal M atoms in the composite oxide containing lithium, the transition metal, and oxygen to the number A_{Mg} of magnesium atoms contained in the additive element source (X source) is preferably A_{M}:A_{Mg}=100:y (0.1≤y≤6), further preferably A_{M}:A_{Mg}=100:y (0.3≤y≤3).

The conditions of the mixing in Step S31 are preferably milder than those of the mixing in Step S12 in order not to damage the composite oxide particles. For example, conditions with a lower rotation frequency or shorter time than the mixing in Step S12 are preferable. In addition, it can be said that the dry process has a milder condition than the wet process. As a means for the mixing, a ball mill, a bead mill, or the like can be used. In the case where a ball mill is used, zirconia balls are preferably used as media, for example.

In this embodiment, the mixing is performed with a ball mill using zirconia balls having a diameter of 1 mm by a dry process at 150 rpm for 1 hour. The mixing step is performed in a dry room with a dew point higher than or equal to −100° C. and lower than or equal to −10° C.

### <Step S32>

Next, in Step S32 in FIG. 8, the materials mixed in the above manner are collected to obtain a mixture 903. At the time of the collection, the materials are crushed as needed and may be made to pass through a sieve.

Note that this embodiment describes a method for adding lithium fluoride as the fluorine source and magnesium fluoride as the magnesium source to the composite oxide in a later step. However, the present invention is not limited to the above method. The magnesium source, the fluorine source, and the like can be added to the lithium source and the transition metal source at the stage of Step S11, i.e., at the stage of the starting materials of the composite oxide. Then, the heating in Step S13 is performed, so that LiMO₂ to which magnesium and fluorine are added can be obtained. In this case, there is no need to separate steps of Step S11 to Step S14 and steps of Step S31 to Step S32. This method can be regarded as being simple and highly productive.

Alternatively, lithium cobalt oxide to which magnesium and fluorine are added in advance may be used. When lithium cobalt oxide to which magnesium and fluorine are added is used, the steps of Step S11 to Step S32 and Step S20 can be omitted. This method can be regarded as being simple and highly productive.

Alternatively, in accordance with Step S20, a magnesium source and a fluorine source may be further added to the lithium cobalt oxide to which magnesium and fluorine are added in advance. Alternatively, a magnesium source, a fluorine source, a nickel source, and an aluminum source may be further added to the lithium cobalt oxide to which magnesium and fluorine are added in advance.

### <Step S33>

Next, in Step S33 shown in FIG. 8, the mixture 903 is heated. The heating can be performed under any of the heating conditions selected from those described for Step S13. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element source proceeds. The temperature at which the reaction proceeds is the temperature at which interdiffusion of the elements contained in LiMO₂ and the additive element source occurs, and may be lower than the melting temperatures of these materials. When description is made using an oxide as an example, it is known that solid phase diffusion occurs at a temperature 0.757 times the melting temperature Tₘ (what is called the Tamman temperature T_{d}). Accordingly, it is only required that the heating temperature in Step S33 be higher than or equal to 500° C., for example.

Of course, the reaction proceeds more easily at a temperature higher than or equal to the temperature at which at least part of the mixture 903 is melted. For example, in the case where LiF and MgF₂ are contained as the additive element source, the eutectic point of LiF and MgF₂ is around 742° C., and the lower limit of the heating temperature in Step S33 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the heating temperature is preferably lower than or equal to 1000° C., further preferably lower than or equal to 950° C., still further preferably lower than or equal to 910° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., and yet still further preferably higher than or equal to 500° C. and lower than or equal to 910° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., and yet still further preferably higher than or equal to 742° C. and lower than or equal to 910° C. Furthermore, the heating temperature is higher than or equal to 800° C. and lower than or equal to 1100° C., preferably higher than or equal to 830° C. and lower than or equal to 1130° C., further preferably higher than or equal to 830° C. and lower than or equal to 1000° C., still further preferably higher than or equal to 830° C. and lower than or equal to 950° C., and yet still further preferably higher than or equal to 830° C. and lower than or equal to 910° C. Note that the heating temperature in Step S33 is preferably lower than that in Step 13.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a flux in some cases. Owing to this function, the heating temperature can be lower than the decomposition temperature of the composite oxide (LiMO₂), e.g., a temperature higher than or equal to 742° C. and lower than or equal to 950° C., which allows distribution of the additive element such as magnesium in the surface portion and fabrication of the positive electrode active material having favorable performance.

However, since LiF in a gas phase has a specific gravity less than that of oxygen, heating volatilizes or sublimates LiF in some cases. When LiF is volatilized or sublimated, the amount of LiF in the mixture 903 is reduced. As a result, the function of LiF as a flux deteriorates. Thus, heating is preferably performed while volatilization or sublimation of LiF is inhibited. Note that even when LiF is not used as the fluorine source or the like, Li at the surface of LiMO₂ and F of the fluorine source might react to produce LiF, which might be volatilized or sublimated. Therefore, inhibition of volatilization or sublimation is needed even when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization or sublimation of LiF in the mixture 903.

The heating in this step is preferably performed such that particles of the mixture 903 are not adhered to one another. Adhesion of the particles of the mixture 903 during the heating might decrease the area of contact with oxygen in the atmosphere and block a path of diffusion of the additive element (e.g., fluorine), thereby hindering distribution of the additive element (e.g., magnesium and fluorine) in the surface portion.

It is considered that uniform distribution of the additive element (e.g., fluorine) in the surface portion leads to a smooth positive electrode active material with little unevenness. In view of this, the particles are preferably not adhered to each other.

In the case of using a rotary kiln for the heating, the flow rate of an oxygen-containing atmosphere in the kiln is preferably controlled during the heating. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions, such as the heating temperature, and the particle size and composition of LiMO₂ in Step S14. In the case where the particle size is small, the heating is preferably performed at a lower temperature or for a shorter time than the case where the particle size is large, in some cases.

In the case where the median diameter (D50) of the composite oxide (LiMO₂) in Step S14 in FIG. 8 is approximately 12 μm, the heating temperature is preferably higher than or equal to 600° C. and lower than or equal to 950° C., for example. The heating time is preferably longer than or equal to 3 hours, further preferably longer than or equal to 10 hours, and still further preferably longer than or equal to 60 hours, for example. Note that the temperature decreasing time after the heating is, for example, preferably longer than or equal to 10 hours and shorter than or equal to 50 hours.

Meanwhile, in the case where the median diameter (D50) of the composite oxide (LiMO₂) in Step S14 is approximately 5 μm, the heating temperature is preferably higher than or equal to 600° C. and lower than or equal to 950° C., for example. The heating time is preferably longer than or equal to 1 hour and shorter than or equal to 10 hours, and further preferably approximately 2 hours, for example. Note that the temperature decreasing time after the heating is, for example, preferably longer than or equal to 10 hours and shorter than or equal to 50 hours.

### <Step S34>

Next, in Step S34 shown in FIG. 8, the heated material is collected and then crushed as needed, whereby the positive electrode active material 100 is obtained. At this time, the collected particles are preferably made to pass through a sieve.

Through the above steps, the positive electrode active material 100 of one embodiment of the present invention can be fabricated.

### <Fabrication Method 2 of Positive Electrode Active Material>

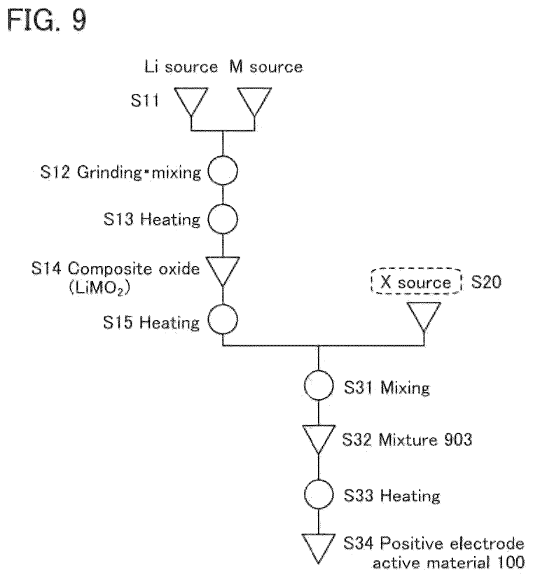

As shown in FIG. 9, a heating step may be added as Step S15 after Step S14. A fabrication method including this step is described.

### <Step S15>

Steps S11 to S14 shown in FIG. 9 are similar to Steps S11 to S14 shown in FIG. 8. In Step S15 shown in FIG. 9, the above composite oxide is heated. The heating in Step S15 is the first heating performed on the composite oxide, and thus is sometimes referred to as initial heating. Through the initial heating, the surface of the composite oxide becomes smooth. Having a smooth surface refers to a state where the composite oxide has little unevenness and is rounded as a whole and its corner portion is rounded. Having a smooth surface also refers to a state where few foreign matters are attached to a surface. Foreign matters are deemed to cause unevenness and are preferably not attached to a surface. The composite oxide can also have high hardness when having a smooth surface.

The initial heating refers to heating after the composite oxide is completed. When the initial heating is performed aiming at smoothing a surface, an additive element can be added uniformly and a continuous barrier layer can be formed.

For the initial heating, a lithium compound source does not need to be prepared.

For the initial heating, an additive element source does not need to be prepared.

For the initial heating, a flux (also referred to as flux agent) does not need to be prepared.

The initial heating is heating performed before addition of an additive element, and is referred to as preheating or pretreatment in some cases.

The initial heating can reduce impurities in the composite oxide completed in Step 14.

The heating conditions in this step can be freely set as long as the heating makes the surface of the above composite oxide smooth. For example, any of the heating conditions described for Step S13 can be selected. Additionally, the heating temperature in this step is preferably lower than the temperature in Step S13 so that the crystal structure of the composite oxide is maintained. The heating time in this step may be shorter than the time in Step S13 so that the crystal structure of the composite oxide is maintained. For example, the heating is preferably performed at a temperature higher than or equal to 700° C. and lower than or equal to 1000° C. for approximately 2 hours.

In the composite oxide, a temperature difference between the surface and the inner portion of the composite oxide might be caused by the heating in Step S13. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. Thus, it is deemed that Step S15 makes the surface of the composite oxide smooth. In other words, it is deemed that Step S15 reduces the differential shrinkage caused in the composite oxide to make the surface of the composite oxide smooth. This is also rephrased as modification of the surface.

Such differential shrinkage might cause a micro shift in the composite oxide such as a shift in a crystal. To reduce the shift, this initial heating is preferably performed. Performing the initial heating can distribute a shift uniformly in the composite oxide. When the shift is distributed uniformly, the surface of the composite oxide might become smooth. “Shift is distributed uniformly” is also rephrased as “crystal grains are aligned”. In other words, it is deemed that Step S15 reduces the shift due to a crystal or the like which is caused in the composite oxide to make the surface of the composite oxide smooth.

The use of a composite oxide with a smooth surface as a positive electrode active material can prevent cracking of the positive electrode active material, thereby reducing deterioration after a cycle test.

It can be said that when surface unevenness in a cross section of a composite oxide is measured and quantified, a smooth surface of the composite oxide has a surface roughness of at least less than or equal to 10 nm. The one cross section is, for example, a cross section obtained in observation using a scanning transmission electron microscope.

Note that when Step S15 is performed on the pre-synthesized composite oxide containing lithium, a transition metal, and oxygen, a composite oxide with a smooth surface can be obtained.

The initial heating might reduce the amount of lithium in the composite oxide. The reduction in the amount of lithium might promote entry of an additive element into the composite oxide when the additive element source is added after Step S20.

Through the above steps, the positive electrode active material 100 of one embodiment of the present invention can be fabricated. The positive electrode active material of one embodiment of the present invention has a smooth surface.

### <<Fabrication Method 3 of Positive Electrode Active Material>>

Next, as one embodiment of the present invention, a method different from the fabrication methods 1 and 2 of the positive electrode active material is described.

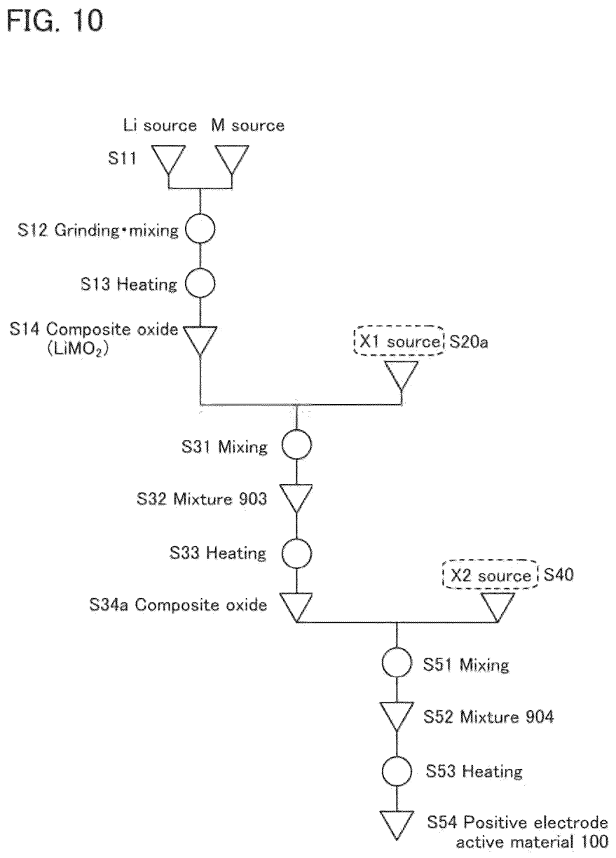

Steps S11 to S14 in FIG. 10 are performed as in FIG. 8 to prepare a composite oxide (LiMO₂). Note that with reference to FIG. 9, Step S15 may be added after Step S14 to prepare a composite oxide (LiMO₂) with a smooth surface.

As described above, the additive element X may be added to the composite oxide as long as a layered rock-salt crystal structure can be obtained. A fabrication method 3 here describes the addition of the additive element divided into two or more steps.

### <Step S20a>

First, in Step S20a shown in FIG. 10, a first additive element source (X1 source) is prepared. As the X1 source, any one selected from the additive elements X described for Step S20 shown in FIG. 8 can be used.

For the addition of the first additive element X1, a solid phase method, a liquid phase method such as a sol-gel method, a sputtering method, an evaporation method, a CVD (chemical vapor deposition) method, a PLD (pulsed laser deposition) method, or the like can be used.

Here, as the first additive element source (X1 source), a magnesium source (Mg source) and a fluorine source (F source) are prepared. Next, with reference to FIG. 8, grinding, mixing, heating, and the like of the magnesium source and the fluorine source are performed as appropriate, so that the first additive element source (X1 source) can be obtained.

Steps S31 to S33 shown in FIG. 10 can be performed in a manner similar to that in Steps S31 to S33 shown in FIG. 8.

### <Step S34a>

Next, the material heated in Step S33 is collected to fabricate a composite oxide containing the first additive element X1. This composite oxide is called a second composite oxide to be distinguished from the composite oxide in Step S14.

### <Step S40>

In Step S40 shown in FIG. 10, a second additive element source (X2 source) is prepared. As the X2 source, any one selected from the additive elements X described for Step S20 shown in FIG. 8 can be used.

For the addition of the second additive element X2, a solid phase method, a liquid phase method such as a sol-gel method, a sputtering method, an evaporation method, a CVD (chemical vapor deposition) method, a PLD (pulsed laser deposition) method, or the like can be used.

Here, in the case where a sol-gel method is used for the addition of the second additive element X2, a solvent used for the sol-gel method is prepared in addition to the second additive element source (X2 source). In the sol-gel method, a metal alkoxide can be used as a metal source and alcohol can be used as the solvent, for example. In the case of adding aluminum, for example, aluminum isopropoxide can be used as the metal source and isopropanol(2-propanol) can be used as the solvent. For example, in the case of adding zirconium, zirconium(IV) tetraisopropoxide can be used as the metal source and isopropanol can be used as the solvent.

FIG. 10 shows an example where nickel and aluminum are used as the second additive element X2.

In Step S40 shown in FIG. 10, with reference to Step S20 shown in FIG. 8, grinding, mixing, heating, and the like are performed as appropriate, so that the second additive element source (X2 source) can be obtained.

In the case where a plurality of element sources are contained as the second additive element source, the plurality of element sources may be prepared by independently performing the steps up to and including the step of grinding. As a result, a plurality of second additive element sources (X2 sources) are independently prepared in Step S40.

For example, the second additive element source using a solid phase method and the second additive element source using a sol-gel method may be independently prepared. An example is described where a nickel source and an aluminum source are prepared by a wet process and a sol-gel method, respectively.

First, nickel hydroxide is prepared and ground to prepare a nickel source. Heating may be performed after grinding to remove a solvent.

Next, aluminum isopropoxide, zirconium(IV) tetrapropoxide, and isopropanol are prepared separately from the nickel source, and then stirring is performed. After that, filtration is performed for collection and drying under reduced pressure is performed at 70° C. for one hour to prepare an aluminum source.

### <Step S51 to Step S53>

Next, Step S51 to Step S53 shown in FIG. 10 can be performed under conditions similar to those of Step S31 to Step S34 shown in FIG. 8. Through the above steps, the positive electrode active material 100 of one embodiment of the present invention can be fabricated in Step S54.

As shown in FIG. 10, in the fabrication method 3, introduction of the additive element to the composite oxide is divided into introduction of the first additive element X1 and that of the second additive element X2. When the introduction is divided, the additive elements can have different concentration profiles in the depth direction. For example, the first additive element can be introduced such that its concentration is higher in the surface portion than in the inner portion, and the second additive element can be introduced such that its concentration is higher in the inner portion than in the surface portion.

### <<Fabrication Method 4 of Positive Electrode Active Material>>

Next, as one embodiment of the present invention, a method different from the fabrication methods 1 to 3 of the positive electrode active material is described.

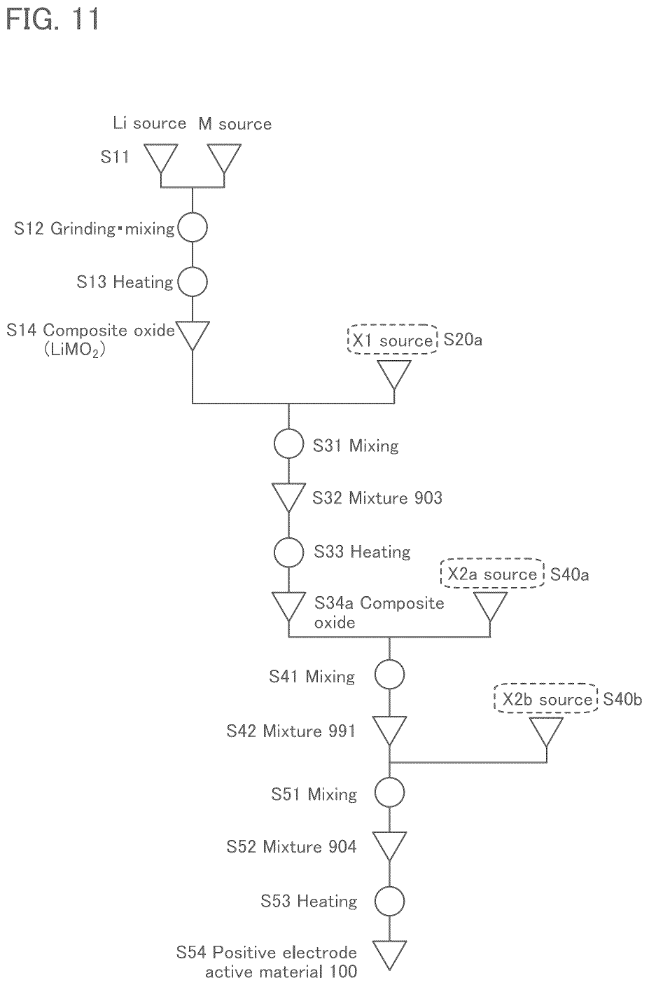

As described above, the additive element X may be added to the composite oxide as long as a layered rock-salt crystal structure can be obtained. In FIG. 11, Steps S11 to S34a are performed as in FIG. 10. A fabrication method 4 here describes the addition of the second additive element (X2) divided into two or more steps.

### <Step S40a>

In Step S40a shown in FIG. 11, one of the second additive element sources (hereinafter, referred to as X2a source) is prepared. As the X2a source, any one selected from the additive elements X described for Step S20 shown in FIG. 8 can be used. For example, one or more selected from nickel, titanium, boron, zirconium, and aluminum can be suitably used as X2a.

For the addition of X2a, a solid phase method, a liquid phase method such as a sol-gel method, a sputtering method, an evaporation method, a CVD (chemical vapor deposition) method, a PLD (pulsed laser deposition) method, or the like can be used.

FIG. 11 shows an example where nickel is used as X2a.

In Step S40a shown in FIG. 11, with reference to Step S20 shown in FIG. 8, grinding, mixing, heating, and the like are performed as appropriate, so that the X2a source can be obtained. For example, a nickel source is obtained as the X2a source by a wet process.

In the case where a plurality of additive element sources are prepared, grinding may be performed independently.

### <Step S40b>

In Step S40b shown in FIG. 11, the other of the second additive element sources (hereinafter, referred to as X2b source) can be obtained. For example, the X2b source is obtained by a sol-gel method. In the case where a sol-gel method is used for preparation in this manner, unlike in Step S40a, steps for preparations are preferably performed independently. A fabrication process of the X2b source by a sol-gel method is described.

In the case where a sol-gel method is used, a solvent used for the sol-gel method is prepared in addition to X2b. In the sol-gel method, a metal alkoxide can be used as a metal source and alcohol can be used as the solvent, for example. Aluminum isopropoxide can be used as aluminum alkoxide in the case of preparing an aluminum source, zirconium isopropoxide can be used as zirconium alkoxide in the case of preparing a zirconium source, and isopropanol can be used as the solvent.

Next, the aluminum alkoxide, the zirconium alkoxide, and the isopropanol are mixed (stirred). The sol-gel reaction may be progressed here, or the sol-gel reaction may be progressed in the next step. In the case where the sol-gel reaction is progressed, heating may be performed at the time of mixing. In this manner, a mixture (also referred to as a mixed solution) containing the aluminum source and the zirconium source is prepared as the X2b source.

### <Step S51 to Step S53>

Next, Step S51 to Step S53 shown in FIG. 11 can be performed under conditions similar to those of Step S31 to Step S33 shown in FIG. 8. The sol-gel reaction can be progressed in Step S53. Through the above steps, the positive electrode active material 100 of one embodiment of the present invention can be fabricated in Step S54.

This embodiment can be used in combination with any of the other embodiments.

### Embodiment 6

In this embodiment, structures of a positive electrode active material of one embodiment of the present invention are described.

A material having the layered rock-salt crystal structure, such as lithium cobalt oxide (LiCoO₂), is known to have a high discharge capacity and excel as a positive electrode active material of a secondary battery. As an example of the material having the layered rock-salt crystal structure, a composite oxide represented by LiMO₂ (M is a transition metal) is given.

It is known that the Jahn-Teller effect in a transition metal compound varies in degree according to the number of electrons in the d orbital of the transition metal. For example, in the case where the transition metal M is nickel, a composite oxide containing an excess amount of nickel might be greatly affected by distortion due to the Jahn-Teller effect. Accordingly, when charging and discharging at a high voltage are performed on LiNiO₂, which is a composite oxide containing Ni, the crystal structure might be broken because of the distortion. Meanwhile, the influence of the Jahn-Teller effect is suggested to be small in a composite oxide containing cobalt as the transition metal M (LiCoO₂); hence, LiCoO₂ has higher tolerance to high-voltage charging in some cases.

Described here is a crystal structure or the like of the case where a composite oxide containing cobalt as the transition metal M (LiCoO₂) is used as the positive electrode active material.

### <Conventional Positive Electrode Active Material>

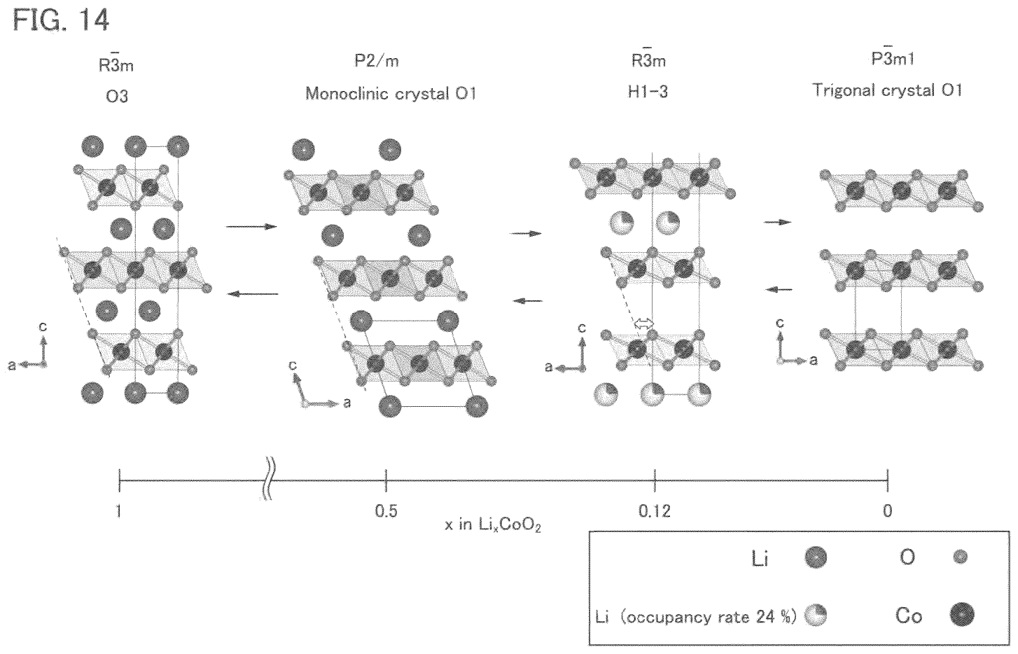

FIG. 14 shows a conventional positive electrode active material that is lithium cobalt oxide (LiCoO₂) not containing any additive element, and shows a state where the crystal structure changes depending on the charge depth.

As shown in FIG. 14, in the conventional lithium cobalt oxide with a charge depth of 0 (in a discharged state), that is, with x in LiₓCoO₂ of 1, there is a region having a crystal structure belonging to the space group R-3m, lithium occupies octahedral sites, and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state.

Conventional lithium cobalt oxide with x in LiₓCoO₂ of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type crystal structure or a monoclinic O1 type crystal structure in some cases.

Furthermore, when the charge depth is 1, that is, when x in LiₓCoO₂ is 0, the conventional lithium cobalt oxide has a trigonal crystal structure belonging to the space group P-3m1, and a unit cell includes one CoO₂ layer. Thus, this crystal structure is referred to as an O1 type crystal structure or a trigonal O1 type crystal structure in some cases. Moreover, in some cases, this crystal structure is referred to as a hexagonal O1 type crystal structure when a trigonal crystal is converted into a composite hexagonal lattice.

Conventional lithium cobalt oxide with, for example, x in LiₓCoO₂ of approximately 0.12 has a crystal structure belonging to the space group R-3m. This crystal structure can also be regarded as a structure in which the CoO₂ structure belonging to, for example, P-3m1 O1, and the LiCoO₂ structure belonging to, for example, R-3m O3, are alternately stacked. Thus, this crystal structure is referred to as an H1-3 type crystal structure in some cases. Note that since insertion and extraction of lithium do not necessarily uniformly occur in reality, the H1-3 type crystal structure starts to be observed when x is approximately 0.25 in practice. The number of cobalt atoms per unit cell in the actual H1-3 type crystal structure is twice that in other structures. However, in this specification including FIG. 14, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. In this manner, the H1-3 type crystal structure is represented by a unit cell including one cobalt atom and two oxygen atoms. Meanwhile, the O3′ type crystal structure of one embodiment of the present invention is preferably represented by a unit cell containing one cobalt atom and one oxygen atom, as described later. This means that the symmetry of cobalt and oxygen differs between the O3′ type crystal structure and the H1-3 type structure, and the amount of change from the O3 type crystal structure is smaller in the O3′ type crystal structure than in the H1-3 type structure.

A preferred unit cell for representing a crystal structure of the lithium cobalt oxide is selected such that the value of goodness of fit (GOF) is smaller in Rietveld analysis of XRD, for example.

When charging at a high charge voltage of 4.6 V or more with reference to the redox potential of a lithium metal or charging that makes x in LiₓCoO₂ be 0.25 or less and discharging are repeated, the crystal structure of conventional lithium cobalt oxide changes (i.e., an unbalanced phase change occurs) repeatedly between the H1-3 type crystal structure and the O3 type crystal structure in a discharged state.

As indicated by a dotted line and an arrow in FIG. 14, the CoO₂ layer in the H1-3 type crystal structure greatly shifts from that in the O3 type crystal structure. That is, there is a large shift of the CoO₂ layer between these two crystal structures. Such a dynamic structural change can adversely affect the stability of the crystal structure of the lithium cobalt oxide.

A difference in volume is also large. The H1-3 type crystal structure and the O3 type crystal structure in a discharged state that contain the same number of cobalt atoms have a difference in volume of more than or equal to 3.0%.

In addition, a structure in which CoO₂ layers are continuous, such as the trigonal O1 type crystal structure, included in the H1-3 type crystal structure is highly likely to be unstable.

Thus, when charging and discharging at a high voltage, that is, charging and discharging that make x be 0.25 or less are repeated, the crystal structure of conventional lithium cobalt oxide is gradually broken. The broken crystal structure triggers degradation of the battery characteristics after a cycle test. This is because the broken crystal structure has a smaller number of sites where lithium can exist stably and makes it difficult to insert and extract lithium.

### <Positive Electrode Active Material of One Embodiment of the Present Invention>

### <<Crystal Structure>>

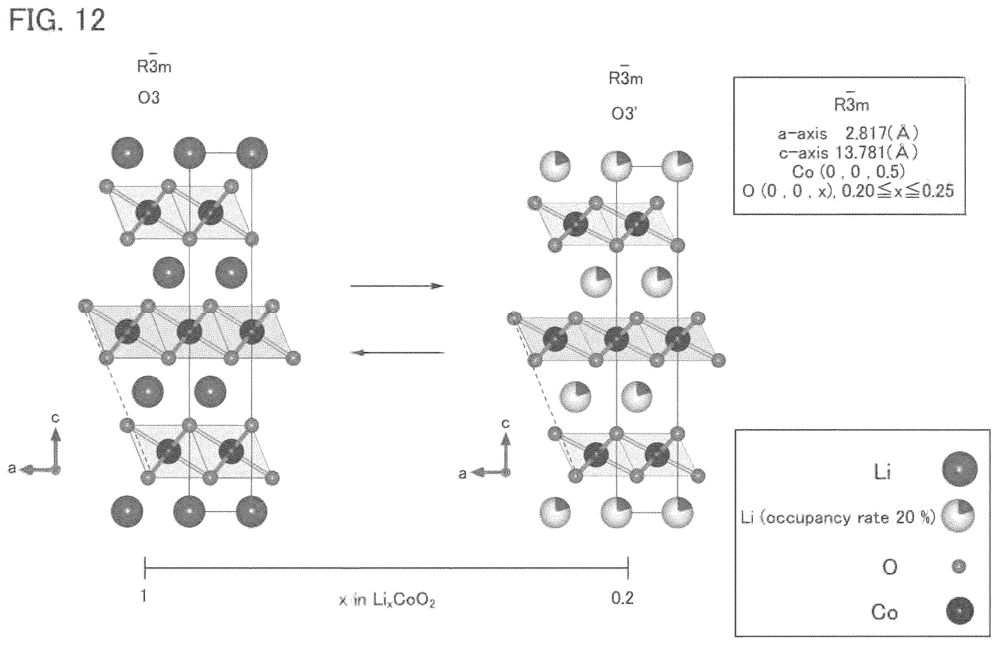

FIG. 12 illustrates the crystal structures of the positive electrode active material 100 of one embodiment of the present invention before and after charging and discharging. Lithium cobalt oxide is given as an example of the positive electrode active material 100. As an additive element, magnesium or aluminum is preferably contained, and further preferably fluorine is contained.

The crystal structure of the case with a charge depth of 0 (in a discharged state), that is, with x in LiₓCoO₂ of 1, in FIG. 12 is the O3 type crystal structure as in FIG. 14. In addition, the positive electrode active material 100 of one embodiment of the present invention has a trigonal crystal structure belonging to the space group R-3m, when charged to a sufficient charge depth, for example, when x is approximately 0.2. Furthermore, the symmetry of CoO₂ layers of this crystal structure is the same as that in the O3 type crystal structure. Thus, this crystal structure is referred to as an O3′ type crystal structure in this specification and the like. The O3′ type crystal structure is a structure different from the H1-3 type crystal structure.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 0.2797≤a≤0.2837 (nm), further preferably 0.2807≤a≤0.2827 (nm), typically a=0.2817 (nm). The lattice constant of the c-axis is preferably 1.3681≤c≤1.3881 (nm), and further preferably 1.3751≤c≤1.3811 (nm), typically, c=1.3781 (nm).

Note that in the O3′ type crystal structure, an ion of cobalt, magnesium, or the like occupies a site coordinated to six oxygen atoms. Note that a light element such as lithium sometimes occupies a site coordinated to four oxygen atoms.

Note that a light element such as lithium sometimes occupies a site coordinated to four oxygen atoms.

As indicated by the dotted lines in FIG. 12, the CoO₂ layers hardly shift between the O3 type crystal structure in a discharged state and the O3′ type crystal structure. The O3 type crystal structure in a discharged state and the O3′ type crystal structure that contain the same number of cobalt atoms have a difference in volume of 2.5% or less, specifically 2.2% or less, typically 1.8%. That is, in the positive electrode active material 100 of one embodiment of the present invention, a change in the crystal structure caused when a large amount of lithium is extracted is smaller than that in a conventional positive electrode active material. In addition, a change in the volume in the case where the positive electrode active materials having the same number of cobalt atoms are compared is inhibited. Thus, the crystal structure of the positive electrode active material 100 is less likely to break even when charging and discharging that make x be 0.25 or less are repeated. This inhibits a decrease in charge and discharge capacity of the positive electrode active material 100 of one embodiment of the present invention in charge and discharge cycles. Furthermore, the positive electrode active material 100 can stably use a larger amount of lithium than a conventional positive electrode active material and thus has large discharge capacity per weight and per volume. Thus, with the use of the positive electrode active material 100, a secondary battery with large discharge capacity per weight and per volume can be obtained.

Note that the positive electrode active material 100 of one embodiment of the present invention is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LiₓCoO₂ but also the number of charge and discharge cycles, a charge current and a discharge current, temperature, an electrolyte, and the like, so that the range of x is not limited to the above.

Thus, when x in LiₓCoO₂ is greater than 0.1 and less than or equal to 0.24, the entire internal structure of the positive electrode active material 100 of one embodiment of the present invention is not necessarily the O3′ type crystal structure. The positive electrode active material 100 may have another crystal structure or may be partly amorphous.

In order to make x in LiₓCoO₂ small, charging at a high charge voltage is necessary in general. Therefore, the state where x in LiₓCoO₂ is small can be rephrased as a state where a charge voltage is high. For example, when CC/CV (constant current/constant voltage) charging is performed at 25° C. and 4.6 V or higher with reference to the potential of a lithium metal, the H1-3 type crystal structure appears in a conventional positive electrode active material. Therefore, a charge voltage of 4.6 V or higher with reference to the potential of a lithium metal can be regarded as a high charge voltage. In this specification and the like, unless otherwise specified, charge voltage is shown with reference to the potential of a lithium metal.

Thus, the positive electrode active material 100 of one embodiment of the present invention is preferable because the O3 type crystal structure can be maintained even when charging at a high charge voltage of 4.6 V or higher is performed at 25° C., for example. Moreover, the positive electrode active material 100 of one embodiment of the present invention is preferable because the O3′ type crystal structure can be obtained when charging at a higher charge voltage, e.g., a voltage higher than or equal to 4.65 V and lower than or equal to 4.7 V is performed at 25° C.

In the positive electrode active material 100, when the charge voltage is increased, the H1-3 type crystal is eventually observed in some cases. As described above, the crystal structure is influenced by the number of charge and discharge cycles, a charge current and a discharge current, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Therefore, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in the O3′ type crystal structure in FIG. 12, one embodiment of the present invention is not limited thereto. Lithium may exist unevenly in only some of the lithium sites. Distribution of lithium can be analyzed by neutron diffraction, for example.

The O3′ type crystal structure can be regarded as a crystal structure that contains lithium between layers randomly and is similar to a CdCl₂ crystal structure. The crystal structure similar to the CdCl₂ crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ crystal structure in general.

A slight amount of the additive element, such as magnesium randomly existing between the CoO₂ layers, i.e., in lithium sites, can suppress a shift in the CoO₂ layers at the time of charging at a high voltage. Thus, magnesium between the CoO₂ layers makes it easier to obtain the O3′ type crystal structure. Therefore, magnesium is preferably distributed throughout a particle of the positive electrode active material 100 of one embodiment of the present invention. To distribute magnesium throughout the particle, heat treatment is preferably performed in the fabrication process of the positive electrode active material 100 of one embodiment of the present invention.

However, heat treatment at an excessively high temperature may cause cation mixing, which increases the possibility of entry of the additive element such as magnesium into the cobalt sites. Magnesium in the cobalt sites does not have the effect of maintaining the O3′ crystal structure at the time of charging at a high voltage. Furthermore, heat treatment at an excessively high temperature might have an adverse effect; for example, cobalt might be reduced to have a valence of two or lithium might be evaporated.

In view of the above, a fluorine compound is preferably added to lithium cobalt oxide before the heat treatment for distributing magnesium throughout the particle. The addition of the fluorine compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material 100 of one embodiment of the present invention is preferably greater than or equal to 0.001 times and less than or equal to 0.1 times, further preferably greater than 0.01 times and less than 0.04 times, still further preferably approximately 0.02 times the number of atoms of the transition metal M. Alternatively, the number of magnesium atoms preferably greater than or equal to 0.001 times and less than 0.04 times the number of cobalt atoms. Alternatively, it is preferably greater than or equal to 0.01 times and less than or equal to 0.1 times. The magnesium concentration described here may be a value obtained by element analysis on the whole particles of the positive electrode active material using ICP-MS or the like, or may be a value based on the ratio of the raw materials mixed in the fabrication process of the positive electrode active material, for example.

As a metal (hereinafter, a metal Z), one or more metals selected from nickel, aluminum, manganese, titanium, vanadium, and chromium may be added to lithium cobalt oxide, for example, and in particular, one or both of nickel and aluminum are preferably added. In some cases, manganese, titanium, vanadium, and chromium are likely to have a valence of four stably and thus contribute highly to a stable structure. The addition of the metal Z may enable the positive electrode active material 100 of one embodiment of the present invention to have a more stable crystal structure in a high-voltage charged state. Here, in the positive electrode active material 100 of one embodiment of the present invention, the metal Z is preferably added at a concentration that does not greatly change the crystallinity of the lithium cobalt oxide. For example, the metal Z is preferably added at an amount that does not cause an adverse effect of the Jahn-Teller effect.

Aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material 100 of one embodiment of the present invention increases, the charge and discharge capacity of the positive electrode active material decreases in some cases. As an example, one reason is that the amount of lithium that contributes to charging and discharging decreases when magnesium enters the lithium sites. Another possible reason is that excess magnesium generates a magnesium compound that does not contribute to charging and discharging. When the positive electrode active material 100 of one embodiment of the present invention contains nickel as the metal Z in addition to magnesium, the charge and discharge capacity per weight and per volume can be increased in some cases. When the positive electrode active material 100 of one embodiment of the present invention contains aluminum as the metal Z in addition to magnesium, the charge and discharge capacity per weight and per volume can be increased in some cases. When the positive electrode active material 100 of one embodiment of the present invention contains nickel and aluminum in addition to magnesium, the charge and discharge capacity per weight and per volume can be increased in some cases.

The concentrations of the elements contained in the positive electrode active material 100 of one embodiment of the present invention, such as magnesium and the metal Z, are described below using the number of atoms.

The number of nickel atoms contained in the positive electrode active material 100 of one embodiment of the present invention is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The nickel concentration described here may be a value obtained by element analysis on the whole particles of the positive electrode active material using GD-MS, ICP-MS, or the like, or may be a value based on the ratio of the raw materials mixed in the fabrication process of the positive electrode active material, for example.

Nickel contained at any of the above concentrations easily forms a solid solution uniformly throughout the positive electrode active material 100 and thus particularly contributes to stabilization of the crystal structure of the inner portion 50. When divalent nickel exists in the inner portion 50, a slight amount of the additive element having a valence of two and randomly existing in lithium sites, such as magnesium, might be able to exist more stably in the vicinity of the divalent nickel. Thus, even when charging and discharging at a high voltage are performed, dissolution of magnesium might be inhibited. Accordingly, charge and discharge cycle performance might be improved. Such a combination of the effect of nickel in the inner portion 50 and the effect of magnesium, aluminum, titanium, fluorine, or the like in the surface portion extremely effectively stabilizes the crystal structure at the time of charging at a high voltage.

The number of aluminum atoms contained in the positive electrode active material 100 of one embodiment of the present invention is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The aluminum concentration described here may be a value obtained by element analysis on the whole particles of the positive electrode active material using GD-MS, ICP-MS, or the like, or may be a value based on the ratio of the raw materials mixed in the fabrication process of the positive electrode active material, for example.

It is preferable that the positive electrode active material 100 of one embodiment of the present invention contain an element W and phosphorus be used as the element W. The positive electrode active material 100 of one embodiment of the present invention further preferably includes a compound containing phosphorus and oxygen.

When the positive electrode active material of one embodiment of the present invention includes a compound containing the element W, a short circuit can be inhibited while a high-voltage charged state is maintained, in some cases.

In the case where the positive electrode active material of one embodiment of the present invention contains phosphorus as the element W, the phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in the hydrogen fluoride concentration in the electrolyte solution can inhibit corrosion and coating film separation of a current collector in some cases. Furthermore, the decrease in the hydrogen fluoride concentration in the electrolyte solution can inhibit a reduction in adhesion properties due to gelling or insolubilization of PVDF in some cases.

When containing magnesium in addition to the element W, the positive electrode active material 100 of one embodiment of the present invention is extremely stable in a high-voltage charged state. When the element W is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The phosphorus concentration and the magnesium concentration described here may each be a value obtained by element analysis on the whole particles of the positive electrode active material using ICP-MS or the like, or may be a value based on the ratio of the raw materials mixed in the fabrication process of the positive electrode active material, for example.

Anions of a layered rock-salt crystal structure and anions of a rock-salt crystal structure each form a cubic close-packed structure (face-centered cubic lattice structure). Anions of the O3′ type crystal structure are also presumed to form a cubic close-packed structure. When these crystal structures are in contact with each other, there is a crystal plane at which orientations of the cubic close-packed structures composed of anions are aligned. Note that a space group of the layered rock-salt crystal structure and the O3′ type crystal structure is R-3m, which is different from a space group Fm-3m of the rock-salt crystal structure (a space group of a general rock-salt crystal) and a space group Fd-3m of the rock-salt crystal structure (a space group of a rock-salt crystal structure having the simplest symmetry); thus, the Miller index of the crystal plane satisfying the above conditions in the layered rock-salt crystal structure and the O3′ type crystal structure is different from that in the rock-salt crystal structure. In this specification, a state where the orientations of the cubic close-packed structures composed of anions in the layered rock-salt crystal structure, the O3′ type crystal structure, and the rock-salt crystal structure are aligned is sometimes referred to as a state where crystal orientations are substantially aligned.

Substantial alignment of the crystal orientations in two regions can be judged from a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. X-ray diffraction (XRD), electron diffraction, neutron diffraction, and the like can also be used for judging. In the TEM image and the like, alignment of cations and anions can be observed as repetition of bright lines and dark lines. When the orientations of cubic close-packed structures in the layered rock-salt crystal structure and the rock-salt crystal structure are aligned, a state where the angle made by the repetition of bright lines and dark lines in the crystals is less than or equal to 5°, further preferably less than or equal to 2.5° can be observed. Note that in the TEM image and the like, a light element such as oxygen or fluorine cannot be clearly observed in some cases; however, in such a case, alignment of orientations can be judged by arrangement of metal elements.

### <<Particle Diameter>>

Too large a particle diameter of the positive electrode active material 100 of one embodiment of the present invention causes problems such as difficulty in lithium diffusion and too much surface roughness of an active material layer in application to a current collector. In contrast, too small a particle diameter causes problems such as increased difficulty in application of the active material layer to the current collector and overreaction with an electrolyte solution. Therefore, the median diameter (D50) is preferably greater than or equal to 1 μm and less than or equal to 100 μm, further preferably greater than or equal to 1 μm and less than or equal to 35 μm or greater than or equal to 1 μm and less than or equal to 30 μm, still further preferably greater than or equal to 5 μm and less than or equal to 20 μm or greater than or equal to 5 μm and less than or equal to 25 μm.

### <Analysis Method>

Whether or not a given positive electrode active material is the positive electrode active material 100 of one embodiment of the present invention, which has the O3′ type crystal structure when charged at a high voltage, can be judged by analyzing a positive electrode charged at a high voltage by XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material 100 of one embodiment of the present invention has a feature of a small change in the crystal structure between a high-voltage charged state and a discharged state. A material in which 50 wt % or more of the crystal structure largely changes between a high-voltage charged state and a discharged state is not preferable because the material cannot withstand charging and discharging at a high voltage. It should be noted that the intended crystal structure is not obtained in some cases only by addition of the additive element. For example, in a high-voltage charged state, lithium cobalt oxide containing magnesium and fluorine has the O3′ type crystal structure at 60 wt % or more in some cases, and has the H1-3 type crystal structure at 50 wt % or more in other cases. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD or other methods.

However, the crystal structure of a positive electrode active material in a high-voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Cycle Test (Charging Method)>>

As a cycle test for the positive electrode active material 100 of one embodiment of the present invention, a half-cell test using a lithium counter electrode is given. As a cell used in the half-cell test, a coin cell (CR2032 type, with a diameter of 20 mm and a height of 3.2 mm) can be fabricated.

A positive electrode formed by application of a slurry in which the obtained positive electrode active material, a conductive additive, and a binder are mixed to a positive electrode current collector made of aluminum foil is used for the coin cell.

A lithium metal can be used for a counter electrode of the coin cell. Note that when the counter electrode is formed using a material other than the lithium metal, a potential of a secondary battery differs from a potential of the positive electrode. Unless otherwise specified, a voltage and a potential in this specification and the like refer to a potential of a positive electrode.

As a lithium salt contained in an electrolyte solution of the coin cell, 1 mol/L lithium hexafluorophosphate (LiPF₆) can be used, and as a solvent contained in the electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator of the coin cell, 25-μm-thick polypropylene can be used.

Stainless steel (SUS) can be used for a positive electrode can and a negative electrode can of the coin cell.

The coin cell fabricated under the above conditions is subjected to constant current charging (CC) at a freely selected voltage (e.g., 4.6 V, 4.65 V, or 4.7 V) and 0.5 C and then constant voltage charging (CV) until the current value reaches 0.01 C. Note that 1 C can be 137 mA/g or 200 mA/g. The temperature is set to 25° C. After the charging is performed in this manner, the coin cell is disassembled in a glove box with an argon atmosphere to take out the positive electrode, whereby the positive electrode active material charged at a high voltage can be obtained. The positive electrode active material is preferably enclosed in an argon atmosphere when various analyses are performed later.

### <<XRD (X-Ray Diffraction)>>

For example, XRD can be performed on the positive electrode active material enclosed in an airtight container with an argon atmosphere. The apparatus and conditions for the XRD measurement are not particularly limited. The measurement can be performed with the apparatus and conditions as described below, for example.
XRD apparatus: D8 ADVANCE produced by Bruker AXS
X-ray source: CuKα radiation
Output: 40 KV, 40 mA
Slit system: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample in XRD is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so as to fit the measurement plane required by the apparatus.

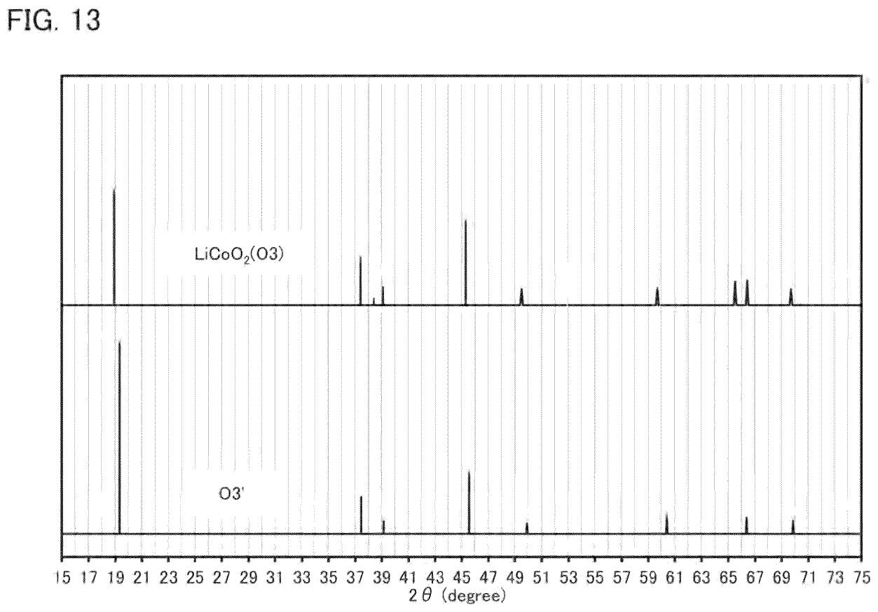

FIG. 13 shows XRD patterns of the positive electrode active material 100 of one embodiment of the present invention. FIG. 13 shows a powder XRD pattern of LiCoO₂ (O3 type crystal structure, shown as LiCoO₂ (O3) in the figure) corresponding to a charge depth of 0, i.e., x in LiₓCoO₂ of 1; and a powder XRD pattern obtained from the O3′ type crystal structure (shown as O3′ in the figure) corresponding to a charge depth of 0.8, i.e., x in LiₓCoO₂ of 0.2. Note that the XRD pattern of the O3′ type crystal structure was obtained in the following manner: the XRD pattern of the positive electrode active material 100 of one embodiment of the present invention was obtained, the crystal structure was estimated from the XRD pattern, and then fitting was performed using TOPAS ver. 3 (crystal structure analysis software manufactured by Bruker Corporation).

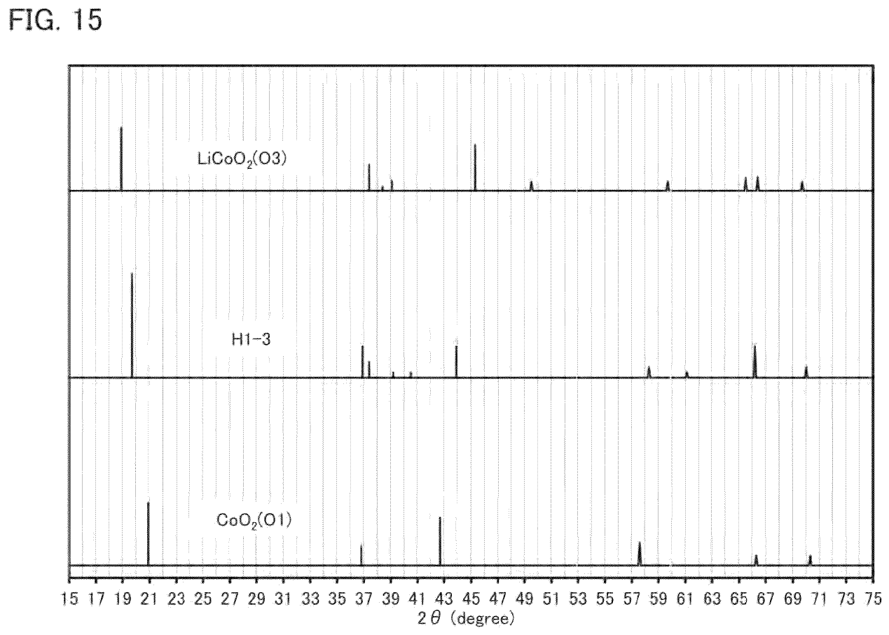

FIG. 15 shows XRD patterns of conventional crystal structures. FIG. 15 shows a powder XRD pattern of LiCoO₂ (O3 type crystal structure, shown as LiCoO₂ (O3) in the figure) corresponding to a charge depth of 0, i.e., x in LiₓCoO₂ of 1; a powder XRD pattern of the H1-3 type crystal structure (shown as H1-3 in the figure) corresponding to x in LiₓCoO₂ of 0.2; and a powder XRD pattern of CoO₂ (O1 type crystal structure, shown as CoO₂ (O1) in the figure) corresponding to a charge depth of 1, i.e., x in LiₓCoO₂ of 0.

As shown in FIG. 13, the O3′ type crystal structure exhibits diffraction peaks at least at 2θ of 19.30±0.20° (greater than or equal to 19.10° and less than or equal to 19.50°) and 2θ of (greater than or equal to 45.45° and less than or equal to 45.65°). More specifically, sharp diffraction peaks appear at least at 2θ of 19.30±0.10° (greater than or equal to 19.20° and less than or equal to 19.40°) and 2θ of 45.55±0.05° (greater than or equal to 45.50° and less than or equal to 45.60).

Meanwhile, as shown in FIG. 15, the H1-3 type crystal structure and CoO₂ (O1) do not exhibit diffraction peaks at the same positions as the peaks of the O3′ type crystal structure shown in FIG. 13. From the above, it can be said that the positive electrode active material 100 of one embodiment of the present invention exhibits peaks at 2θ=19.30±0.20° and 2θ=45.55±0.10° when a lithium metal is used for the counter electrode and charging is performed at a high voltage, e.g., an upper limit voltage of 4.6 to 4.7 V.

The XRD results in FIG. 13 show that, in the positive electrode active material 100 of one embodiment of the present invention, the positions of the XRD diffraction peaks (the values of 2θ) exhibited by the crystal structure with a charge depth of 0, i.e., with x in LiₓCoO₂ of 1, and the crystal structure at the time of high-voltage charging, i.e., with x in LiₓCoO₂ of 0.2, are close to each other. More specifically, it can be said that a difference in the positions of two or more, preferably three or more of the main diffraction peaks (difference in 2θ) between the crystal structures is 0.7 or less, preferably 0.5 or less. Note that the main diffraction peak refers to a peak with high intensity.

Although the positive electrode active material 100 of one embodiment of the present invention has the O3′ type crystal structure when charged at a high voltage, not all the positive electrode active materials necessarily have the O3′ type crystal structure. The positive electrode active material 100 may have another crystal structure or may be partly amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %.

Furthermore, after a cycle test of 50 or more cycles, preferably 100 cycles of charging and discharging under the above high voltage condition, the O3′ type crystal structure accounts for preferably greater than or equal to 35 wt %, further preferably greater than or equal to 40 wt %, still further preferably greater than or equal to 43 wt %, in the Rietveld analysis.

The crystallite size of the O3′ type crystal structure is only decreased to approximately one-tenth that of LiCoO₂ (O3) in a discharged state. Thus, the diffraction peak of the O3′ type crystal structure can sometimes be clearly observed after high-voltage charging even when XRD measurement is performed on a positive electrode before charging and discharging. By contrast, simple LiCoO₂ has a small change in crystallite size and exhibits a broad and small diffraction peak although it can partly have a structure similar to the O3′ type crystal structure after high-voltage charging. Note that the crystallite size can be obtained from the half width of the XRD peak, and thus the crystallite size is considered to correlate with the half width. The crystallite size reduced to 1/10 means the half width reduced to 1/10.

The influence of the Jahn-Teller effect is preferably small in the positive electrode active material 100 of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described metal Z in addition to cobalt as long as the influence of the Jahn-Teller effect is small, and may contain nickel, manganese, or the like, for example.

The range of the lattice constants where the influence of the Jahn-Teller effect is presumed to be small in the positive electrode active material is examined by XRD analysis.

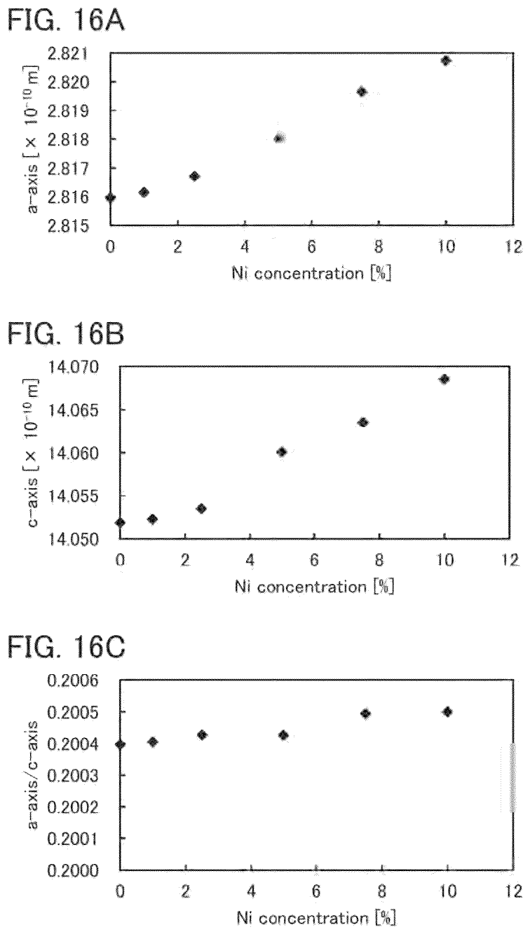

FIG. 16 shows the calculation results of the lattice constants of the a-axis and the c-axis by XRD analysis in the case where the positive electrode active material 100 of one embodiment of the present invention has a layered rock-salt crystal structure and contains cobalt and nickel. FIG. 16A shows the results of the a-axis of the layered rock-salt crystal structure, and FIG. 16B shows the results of the c-axis of the layered rock-salt crystal structure. Note that the XRD patterns of a powder after the synthesis of the positive electrode active material are used for the calculation. The nickel concentration on the horizontal axis represents a nickel concentration with the sum of cobalt atoms and nickel atoms regarded as 100%. The nickel concentration represents a nickel concentration with the sum of cobalt atoms and nickel atoms regarded as 100% in Step S40 or Step S40a.

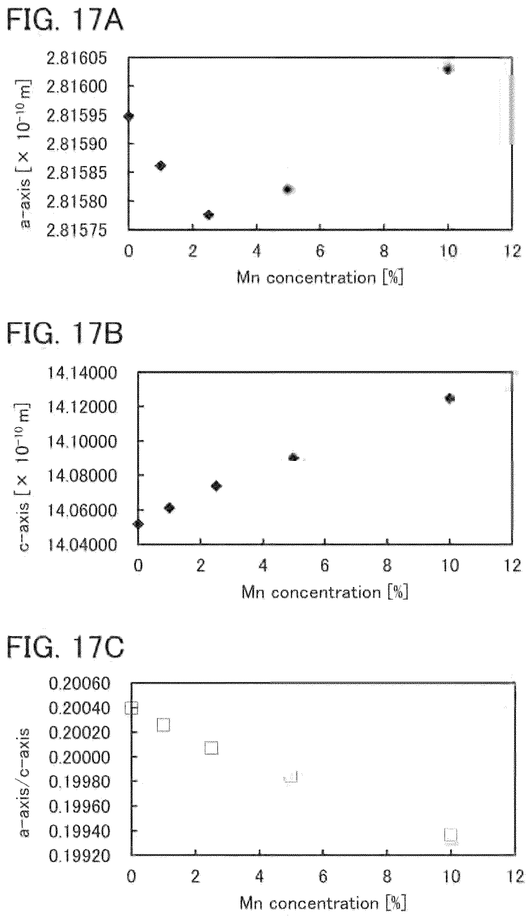

FIG. 17 shows the results of estimation of the lattice constants of the a-axis and the c-axis by XRD analysis in the case where the positive electrode active material of one embodiment of the present invention has a layered rock-salt crystal structure and contains cobalt and manganese. FIG. 17A shows the results of the a-axis of the layered rock-salt crystal structure, and FIG. 17B shows the results of the c-axis of the layered rock-salt crystal structure. Note that the lattice constants shown in FIG. 17 are obtained using a powder after the synthesis of the positive electrode active material. The manganese concentration on the horizontal axis represents a manganese concentration with the sum of cobalt atoms and manganese atoms regarded as 100%. The positive electrode active material was fabricated using a manganese source instead of the nickel source in Step S40 or Step S40a. The manganese concentration represents a manganese concentration with the sum of cobalt atoms and manganese atoms regarded as 100% in Step S40 or Step S40a.

FIG. 16C shows values obtained by dividing the lattice constants of the a-axis by the lattice constants of the c-axis (a-axis/c-axis) in the positive electrode active material, whose results of the lattice constants are shown in FIG. 16A and FIG. 16B. FIG. 17C shows values obtained by dividing the lattice constants of the a-axis by the lattice constants of the c-axis (a-axis/c-axis) in the positive electrode active material, whose results of the lattice constants are shown in FIG. 17A and FIG. 17B.

As shown in FIG. 16C, the value of a-axis/c-axis tends to significantly change between nickel concentrations of 5% and 7.5%, and the distortion of the a-axis becomes large. This distortion may be the Jahn-Teller distortion. It is suggested that an excellent positive electrode active material with small Jahn-Teller distortion can be obtained at a nickel concentration of lower than 7.5%.

FIG. 17C indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Preferable ranges of the lattice constants of the positive electrode active material 100 of one embodiment of the present invention are examined above. In the layered rock-salt crystal structure, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. Examined above is the state of a powder, which corresponds to a positive electrode active material in a state where charging and discharging are not performed or in a discharged state.

In the layered rock-salt crystal structure of the positive electrode active material in the state where charging and discharging are not performed or in the discharged state, the value obtained by dividing the a-axis lattice constant by the c-axis lattice constant (a-axis/c-axis) is preferably greater than 0.2000 and less than 0.2005.

When the layered rock-salt crystal structure of the positive electrode active material in the state where charging and discharging are not performed or in the discharged state is subjected to XRD analysis, a first peak is observed at 20 of greater than or equal to 18.50° and less than or equal to 19.30°, and a second peak is observed at 20 of greater than or equal to 38.00° and less than or equal to 38.80°, in some cases.

Note that the peaks appearing in the powder XRD patterns reflect the crystal structure of the inner portion 50 of the positive electrode active material 100, which accounts for the majority of the volume of the positive electrode active material 100. The crystal structure of the surface portion, a crystal grain boundary, or the like can be analyzed by electron diffraction of a cross section of the positive electrode active material 100, for example.

### <<XPS (X-Ray Photoelectron Spectroscopy)>>

A region from the surface of the positive electrode active material to a depth of greater than or equal to 2 nm and less than or equal to 8 nm (normally, less than or equal to 5 nm) can be analyzed by XPS; thus, the concentration of each element in the surface portion of the positive electrode active material can be quantitatively analyzed. The bonding states of the elements can be analyzed by narrow scanning. Note that the quantitative accuracy of XPS is approximately ±1 atomic % in many cases, and the lower detection limit is approximately 1 atomic % but depends on the element.

When the positive electrode active material 100 of one embodiment of the present invention is subjected to XPS analysis, the number of atoms of the additive element is preferably greater than or equal to 1.6 times and less than or equal to 6.0 times, further preferably greater than or equal to 1.8 times and less than 4.0 times the number of atoms of the transition metal M. When the additive element is magnesium and the transition metal M is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of halogen such as fluorine is preferably greater than or equal to 0.2 times and less than or equal to 6.0 times, further preferably greater than or equal to 1.2 times and less than or equal to 4.0 times the number of atoms of the transition metal M.

In the XPS analysis, monochromatic aluminum can be used as an X-ray source, for example. An extraction angle is, for example, 45°. For example, the measurement can be performed using the following apparatus and conditions.
Measurement apparatus: Quantera II produced by PHI, Inc.
X-ray source: monochromatic Al (1486.6 eV)
Detection area: 100 μmϕ
Detection depth: approximately 4 to 5 nm (extraction angle 45°)
Measurement spectrum: wide scanning, narrow scanning of each detected element

In addition, when the positive electrode active material 100 of one embodiment of the present invention is subjected to XPS analysis, a peak indicating the bonding energy of fluorine with another element is preferably at greater than or equal to 682 eV and less than 685 eV, further preferably approximately 684.3 eV. The above value is different from both the bonding energy of lithium fluoride, which is 685 eV, and the bonding energy of magnesium fluoride, which is 686 eV. That is, in the case where the positive electrode active material 100 of one embodiment of the present invention contains fluorine, the fluorine is preferably in a bonding state other than lithium fluoride and magnesium fluoride.

Furthermore, when the positive electrode active material 100 of one embodiment of the present invention is subjected to XPS analysis, a peak indicating the bonding energy of magnesium with another element is preferably at greater than or equal to 1302 eV and less than 1304 eV, further preferably approximately 1303 eV. This value is different from the bonding energy of magnesium fluoride, which is 1305 eV, and close to the bonding energy of magnesium oxide. That is, in the case where the positive electrode active material 100 of one embodiment of the present invention contains magnesium, the magnesium is preferably in a bonding state other than magnesium fluoride.

The concentrations of the additive elements that preferably exist in the surface portion in a large amount, such as magnesium and aluminum, measured by XPS or the like are preferably higher than the concentrations measured by ICP-MS (inductively coupled plasma mass spectrometry), GD-MS (glow discharge mass spectrometry), or the like.

When a cross section is exposed by processing and analyzed by TEM-EDX, the concentrations of magnesium and aluminum in the surface portion are preferably higher than those in the inner portion 50. An FIB (Focused Ion Beam) can be used for the processing, for example.

In the XPS analysis, the number of magnesium atoms is preferably greater than or equal to 0.4 times and less than or equal to 1.5 times the number of cobalt atoms. In the ICP-MS analysis, the atomic ratio of magnesium (Mg/Co) is preferably greater than or equal to 0.001 and less than or equal to 0.06.

By contrast, it is preferable that nickel not be unevenly distributed in the surface portion but be distributed throughout the positive electrode active material 100.

### <<ESR (Electron Spin Resonance)>>

As described above, the positive electrode active material of one embodiment of the present invention preferably contains cobalt and nickel as the transition metal and magnesium as the additive element. It is preferable that Ni²⁺ be substituted for part of Co³⁺ and Mg²⁺ be substituted for part of Li⁺ accordingly. Accompanying the substitution of Mg²⁺ for Li⁺, the Ni²⁺ might be reduced to be Ni³⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably higher than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density in the positive electrode active material can be analyzed by ESR, for example.

### <<EPMA (Electron Probe Microanalysis)>>

Elements can be quantified by EPMA. In surface analysis, distribution of each element can be analyzed.

In EPMA, a region from a surface to a depth of approximately 1 μm is analyzed. Thus, the concentration of each element is sometimes different from measurement results obtained by other analysis methods. For example, when surface analysis is performed on the positive electrode active material 100, the concentration of the additive element present in the surface portion might be lower than the concentration obtained in XPS. The concentration of the additive element present in the surface portion might be higher than the concentration obtained in ICP-MS or a value based on the ratio of the raw materials mixed in the fabrication process of the positive electrode active material.

EPMA surface analysis of a cross section of the positive electrode active material 100 of one embodiment of the present invention preferably reveals a concentration gradient in which the concentration of the additive element increases from the inner portion toward the surface portion. The aluminum concentration peak may be located in the surface portion or located deeper than the surface portion. The aluminum concentration peak is preferably located on the inner side of the magnesium concentration peak.

Note that the positive electrode active material of one embodiment of the present invention does not contain a carbonic acid, a hydroxy group, or the like which is chemisorbed after fabrication of the positive electrode active material. Furthermore, the positive electrode active material of one embodiment of the present invention does not contain an electrolyte solution, a binder, a conductive material, and a compound originating from any of these that are attached to the surface of the positive electrode active material. Thus, in quantification of the elements contained in the positive electrode active material, correction may be performed to exclude carbon, hydrogen, excess oxygen, excess fluorine, and the like that might be detected in surface analysis such as XPS and EPMA.

This embodiment can be used in combination with any of the other embodiments.

### Embodiment 7

In this embodiment, examples of a secondary battery of one embodiment of the present invention are described.

### Structure Example 1 of Secondary Battery

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material and a binder. As the positive electrode active material, the positive electrode active material described in the above embodiments is used.

The positive electrode active material described in the above embodiments and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, and MnO₂ can be given.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the performance of the secondary battery.

As another positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, and is further preferably nickel. In the case where the whole particles of a lithium-manganese composite oxide are measured, it is preferable to satisfy the following at the time of discharging: 0<a/(b+c)<2; c>0; and 0.26≤(b+c)/d<0.5. Note that the proportions of metals, silicon, phosphorus, and the like in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICPMS combined with fusion gas analysis and valence evaluation of XAFS (X-ray absorption fine structure) analysis. Note that a lithium-manganese composite oxide is an oxide containing at least lithium and manganese, and may contain at least one kind of element selected from a group consisting of chromium, cobalt, aluminum, nickel, iron, magnesium, molybdenum, zinc, indium, gallium, copper, titanium, niobium, silicon, phosphorus, and the like.

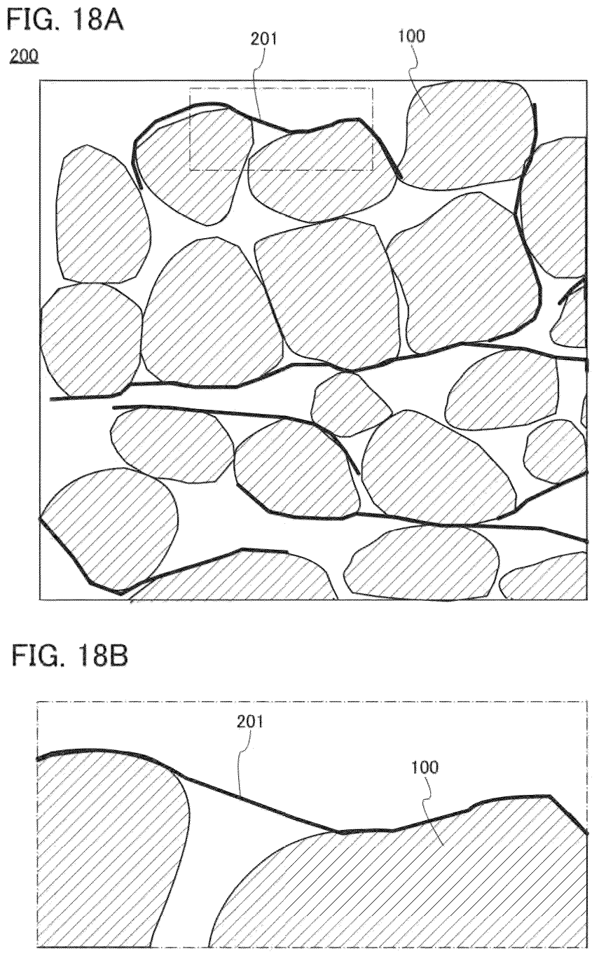

FIG. 18A illustrates, as an example, a cross-sectional structure example of an active material layer 200 in which graphene or a graphene compound is used as a conductive material.

The active material layer 200 includes particles of the positive electrode active material 100, graphene or a graphene compound 201 serving as the conductive material, and a binder (not illustrated).

The graphene compound 201 in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. A graphene compound preferably has a bent shape. A graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. In the case where the reduced graphene includes defects, a 7- or more-membered ring is observed. The reduced graphene oxide may be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound has excellent electrical characteristics of high conductivity and excellent physical properties of high flexibility and high mechanical strength in some cases. A graphene compound has a sheet-like shape. A graphene compound has a curved surface in some cases, thereby enabling low-resistant surface contact. Furthermore, graphene and a graphene compound have extremely high conductivity even with a small thickness in some cases and thus allow a conductive path to be formed in an active material layer efficiently even with a small amount. Hence, the use of a graphene compound as a conductive material can increase the area where an active material and the conductive material are in contact with each other. A graphene compound preferably covers 80% or more of the area of an active material. Note that a graphene compound preferably clings to at least part of an active material. Alternatively, a graphene compound preferably overlays at least part of an active material. Alternatively, the shape of a graphene compound preferably conforms to at least part of the shape of an active material. The shape of an active material indicates, for example, unevenness of a single active material or unevenness formed by a plurality of active materials. A graphene compound preferably surrounds at least part of an active material. A graphene compound may have a hole. The hole is observed as a poly-membered ring.

In the case where an active material with a small particle size (e.g., 1 μm or less) is used, the specific surface area of the active material is large and thus more conductive paths for the active materials are needed. In such a case, it is preferable to use a graphene compound that can efficiently form a conductive path even with a small amount.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and discharge characteristics in some cases. In addition, a mobile electronic device or the like is required to have fast charge characteristics in some cases. Fast charging and discharging may also be referred to as charging and discharging at a high rate, for example, at 1 C, 2 C, or 5 C or more.

FIG. 18B is an enlarged view of a region surrounded by a dashed dotted line in FIG. 18A. The sheet-like graphene or the graphene compound 201 positioned along the unevenness of the positive electrode active material 100 is included. When placed in such a manner, the graphene or the graphene compound 201 is substantially uniformly dispersed in the active material layer 200. The graphene or the graphene compound 201 is schematically shown by the thick line in FIG. 18B but is actually a thin film having a thickness corresponding to the thickness of a single layer or a multi-layer of carbon molecules. A plurality of sheets of graphene or the plurality of graphene compounds 201 are formed to partly cover or adhere to the surfaces of the plurality of particles of the positive electrode active material 100, so that surface contact is made.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used, which can increase the proportion of the active material in the electrode volume or the electrode weight. That is, the charge and discharge capacity of the secondary battery can be increased.

Here, it is preferable to perform reduction after a layer to be the active material layer 200 is formed in such a manner that graphene oxide is used as the graphene or the graphene compound 201 and mixed with the positive electrode active material 100. That is, the formed active material layer preferably contains reduced graphene oxide. When graphene oxide with extremely high dispersibility in a polar solvent is used for the formation of the graphene or the graphene compound 201, the graphene or the graphene compound 201 can be substantially uniformly dispersed in the active material layer 200. The solvent is removed by volatilization from a dispersion medium in which graphene oxide is uniformly dispersed, and the graphene oxide is reduced; hence, the sheets of graphene or the graphene compounds 201 remaining in the active material layer 200 partly overlap with each other and are dispersed such that surface contact is made, thereby forming a three-dimensional conduction path. Note that the graphene oxide may be reduced by heat treatment or with the use of a reducing agent, for example.

Unlike a particulate conductive material such as acetylene black, which makes point contact with an active material, the graphene or the graphene compound 201 is capable of making low-resistance surface contact; accordingly, the electrical conduction between the particles of the positive electrode active material 100 and the graphene or the graphene compound 201 can be improved with a small amount of the graphene and the graphene compound 201 as compared with a normal conductive material. This can increase the proportion of the positive electrode active material 100 in the active material layer 200. Hence, the discharge capacity of the secondary battery can be increased.

It is possible to form, with a spray dry apparatus, a graphene compound serving as a conductive material as a coating film to cover the entire surface of the active material in advance and to form a conductive path between the active materials using the graphene compound.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide or the like can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such water-soluble polymers be used in combination with any of the above-described rubber materials.

Alternatively, as the binder, it is preferable to use a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose.

Two or more of the above-described materials may be used in combination for the binder.

For example, a material having a significant viscosity modifying effect and another material may be used in combination. For example, a rubber material or the like has high adhesion or high elasticity but might have difficulty in viscosity modification when mixed in a solvent. In such a case, a rubber material or the like is preferably mixed with a material having a significant viscosity modifying effect, for example. As a material having a significant viscosity modifying effect, for example, a water-soluble polymer is preferably used. As a water-soluble polymer having a significant viscosity modifying effect, it is possible to use the above-mentioned polysaccharide, for example, a cellulose derivative such as carboxymethyl cellulose (CMC), methyl cellulose, ethyl cellulose, hydroxypropyl cellulose, diacetyl cellulose, or regenerated cellulose, or starch.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and the like in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material or another material combined as a binder, such as styrene-butadiene rubber, in an aqueous solution. Furthermore, a water-soluble polymer is expected to be easily and stably adsorbed onto an active material surface because it includes a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to inhibit the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferable that the passivation film can conduct lithium ions while suppressing electrical conduction.

### [Positive Electrode Current Collector]

The positive electrode current collector can be formed using a material that has high conductivity, such as a metal like stainless steel, gold, platinum, aluminum, and titanium, or an alloy thereof. It is preferable that a material used for the positive electrode current collector not dissolve at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector having a thickness greater than or equal to 5 μm and less than or equal to 30 μm is preferably used.

Slurry containing the positive electrode active material, a conductive material, a binder, and the like are applied as a positive electrode active material layer on the positive electrode current collector, drying or the like is performed, and then pressing is performed, so that the positive electrode is completed. The pressing is preferably performed in multiple stages. First pressing and second pressing are sequentially performed, and the pressure of the second pressing is preferably set greater than or equal to 5 times and less than or equal to 8 times as high as that of the first pressing.

### <Slip>

When the positive electrode active material layer is formed on the positive electrode current collector, pressing is performed, and then a cross-sectional STEM image of part of the positive electrode is observed, a step formed on the particle surface in a direction perpendicular to the lattice fringes (the c-axis direction) by the pressing and an evidence of deformation along the lattice fringe direction (the ab plane direction) are observed. The deformation is referred to as a slip in some cases. The slip might trigger a defect such as a crack or a pit. Therefore, the slip is preferably not generated.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material or a carbon material can be used.

As the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers to silicon monoxide, for example. Note that SiO can alternatively be expressed as SiOₓ. Here, x is preferably 1 or an approximate value of 1. For example, x in SiOx is preferably greater than or equal to 0.2 and less than or equal to 1.5, further preferably greater than or equal to 0.3 and less than or equal to 1.2. Alternatively, x in SiOx is preferably greater than or equal to 0.2 and less than or equal to 1.2. Alternatively, x in SiOx is preferably greater than or equal to 0.3 and less than or equal to 1.5.

As the carbon material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into the graphite (while a lithium-graphite intercalation compound is formed). For this reason, a lithium-ion secondary battery can have a high operating voltage. In addition, graphite is preferable because of its advantages such as a relatively high charge and discharge capacity per unit volume, relatively small volume expansion, low cost, and a higher safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

As the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

### [Negative Electrode Current Collector]

For the negative electrode current collector, a material similar to that for the positive electrode current collector can be used. Note that a material that is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferable; for example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

The use of one or more ionic liquids (room temperature molten salts) that are unlikely to burn and volatize as the solvent of the electrolyte solution can prevent a secondary battery from exploding or catching fire even when the secondary battery internally shorts out or the internal temperature increases owing to overcharging or the like. An ionic liquid contains a cation and an anion, specifically, an organic cation and an anion. Examples of the organic cation used for the electrolyte solution include an aliphatic onium cation and an aromatic cation. Examples of the aliphatic onium cation include a quaternary ammonium cation, a tertiary sulfonium cation, and a quaternary phosphonium cation. Examples of the aromatic cation include an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the solvent, a lithium salt is used. As the lithium salt, for example, one or more selected from LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used. In the case where two or more of the above lithium salts are used, the lithium salts can be combined at an appropriate ratio.

As the electrolyte solution used for a secondary battery, it is preferable to use an electrolyte solution that is highly purified and contains a small number of dust particles or elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. VC or LiBOB is particularly preferable because it facilitates formation of a favorable coating film.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based inorganic material or an oxide-based inorganic material can be used. Instead of the electrolyte solution, a solid electrolyte solution containing a high-molecular material such as a PEO (polyethylene oxide)-based high molecular material can be used. In the case where the solid electrolyte is used, a separator and a spacer are not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. As the ceramic-based material, aluminum oxide particles or silicon oxide particles can be used, for example. As the fluorine-based material, PVDF or polytetrafluoroethylene can be used, for example. As the polyamide-based material, nylon or aramid (meta-based aramid or para-based aramid) can be used, for example.

When the separator is coated with the ceramic-based material, the oxidation resistance is improved; hence, deterioration of the separator in charging and discharging at a high voltage can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the charge and discharge capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

### Structure Example 2 of Secondary Battery

A structure of a secondary battery including a solid electrolyte layer is described below as another structure example of a secondary battery.

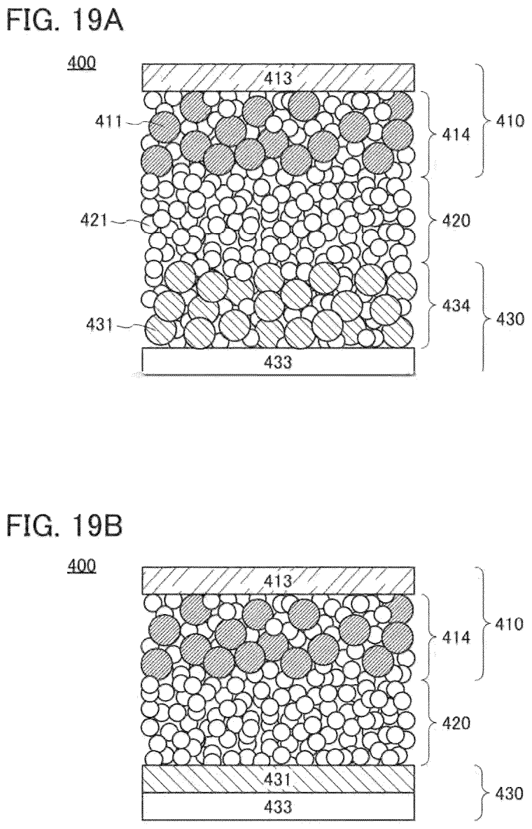

As illustrated in FIG. 19A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material fabricated by the fabrication method described in the above embodiments is used. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when a lithium metal is used for the negative electrode 430, the negative electrode 430 that does not include the solid electrolyte 421 can be formed, as illustrated in FIG. 19B. The use of a lithium metal for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a material with a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can employ a variety of materials and shapes, and preferably has a function of applying pressure to the positive electrode, the solid electrolyte layer, and the negative electrode.

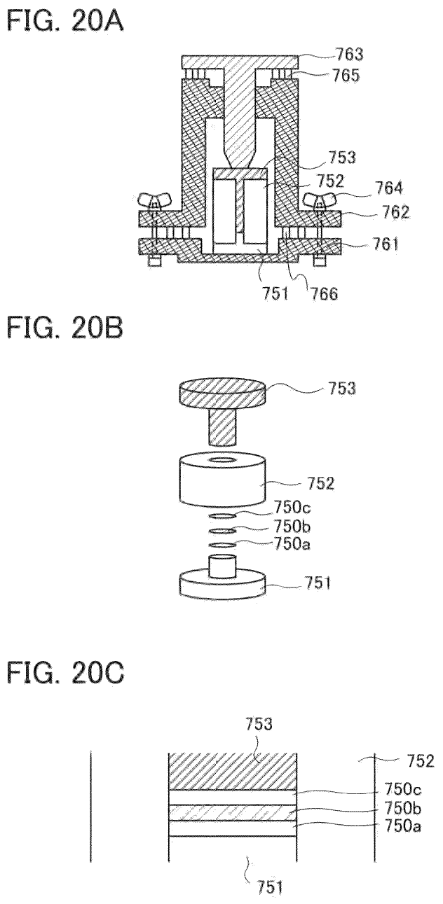

FIG. 20 illustrates an example of a cell for evaluating materials of an all-solid-state battery.

FIG. 20A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 20B is an enlarged perspective view of the evaluation material and its vicinity.

A stack of a positive electrode 750a, a solid electrolyte layer 750b, and a negative electrode 750c is illustrated here as an example of the evaluation material, and its cross section is illustrated in FIG. 20C. Note that the same portions in FIG. 20A, FIG. 20B, and FIG. 20C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

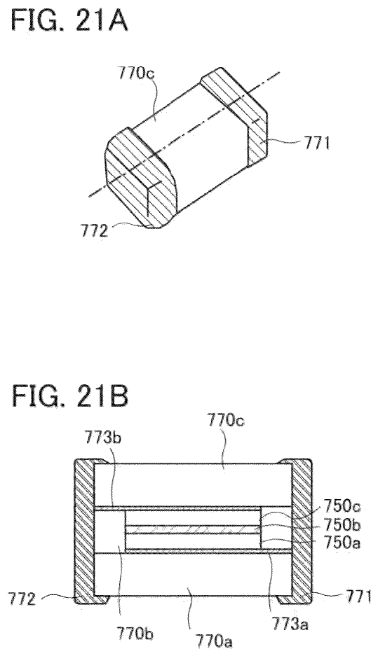

FIG. 21A is a perspective view of a secondary battery of one embodiment of the present invention that has an exterior body and a shape different from those in FIG. 20. The secondary battery in FIG. 21A includes external electrodes 771 and 772 and is sealed with an exterior body including a plurality of package components.

FIG. 21B illustrates an example of a cross section along the dashed-dotted line in FIG. 21A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material or ceramic, can be used.

The external electrode 771 is electrically connected to the positive electrode 750a through the electrode layer 773a and functions as a positive electrode terminal. An external electrode 772 is electrically connected to the negative electrode 750c through the electrode layer 773b and functions as a negative electrode terminal.

This embodiment can be used in appropriate combination with any of the other embodiments.

### Embodiment 8

In this embodiment, examples of a shape of a secondary battery including the positive electrode described in the above embodiment are described. For the materials used for the secondary battery described in this embodiment, the description of the above embodiment can be referred to.

### <Coin-Type Secondary Battery>

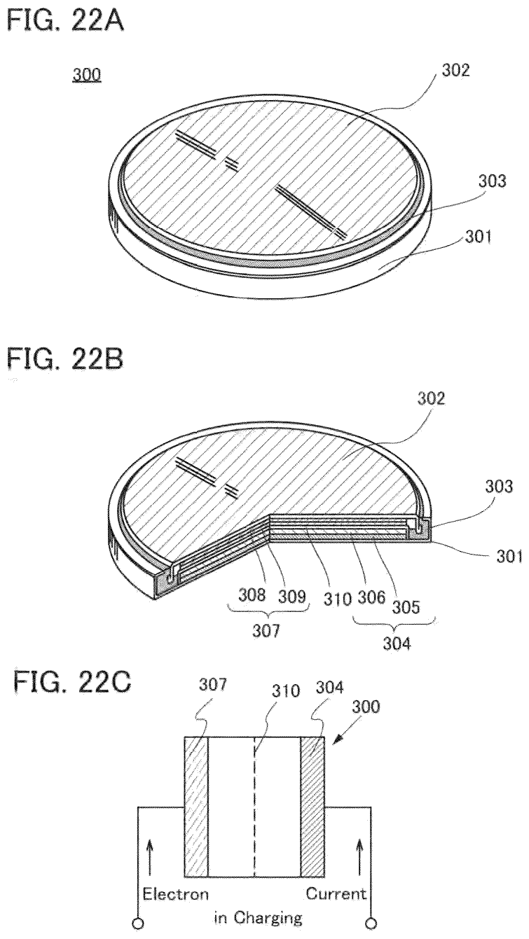

First, an example of a coin-type secondary battery is described. FIG. 22A is an external view of a coin-type (single-layer flat type) secondary battery, and FIG. 22B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte. Then, as illustrated in FIG. 22B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 is manufactured.

When the positive electrode active material described in the above embodiment is used in the positive electrode 304, the coin-type secondary battery 300 with high charge and discharge capacity and excellent cycle performance can be obtained.

Here, a current flow in charging a secondary battery is described with reference to FIG. 22C. When a secondary battery using lithium is regarded as a closed circuit, movement of lithium ions and the current flow are in the same direction. Note that in the secondary battery using lithium, the anode and the cathode interchange in charging and discharging, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charging is performed, discharging is performed, a reverse pulse current is supplied, and a charge current is supplied. The use of the terms “anode” and “cathode” related to an oxidation reaction and a reduction reaction might cause confusion because the anode and the cathode interchange in charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive (plus) electrode or a negative (minus) electrode.

Two terminals illustrated in FIG. 22C are connected to a charger, and the secondary battery 300 is charged. As the charging of the secondary battery 300 proceeds, a potential difference between electrodes increases.

### <Cylindrical Secondary Battery>

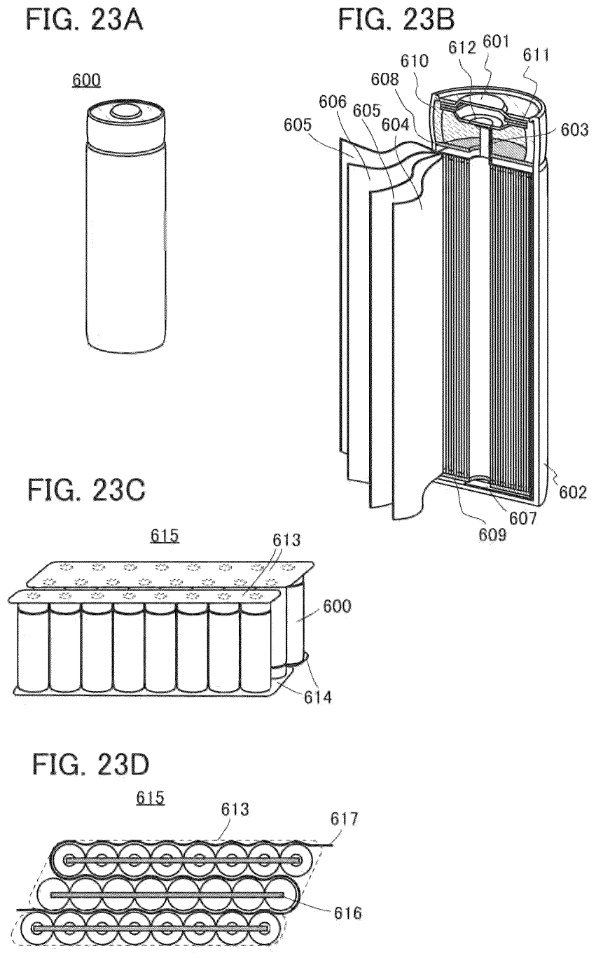

Next, an example of a cylindrical secondary battery is described with reference to FIG. 23. FIG. 23A is an external view of a cylindrical secondary battery 600. FIG. 23B is a schematic cross-sectional view of the cylindrical secondary battery 600. The cylindrical secondary battery 600 includes, as illustrated in FIG. 23B, a positive electrode cap (battery lid) 601 on the top surface and a battery can (outer can) 602 on the side and the bottom surfaces. The positive electrode cap 601 and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 interposed therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

Furthermore, as illustrated in FIG. 23C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 23D is a top view of the module 615. The conductive plate 613 is shown by a dotted line for clarity of the diagram. As illustrated in FIG. 23D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high charge and discharge capacity and excellent cycle performance can be obtained.

### Structure Examples of Secondary Battery

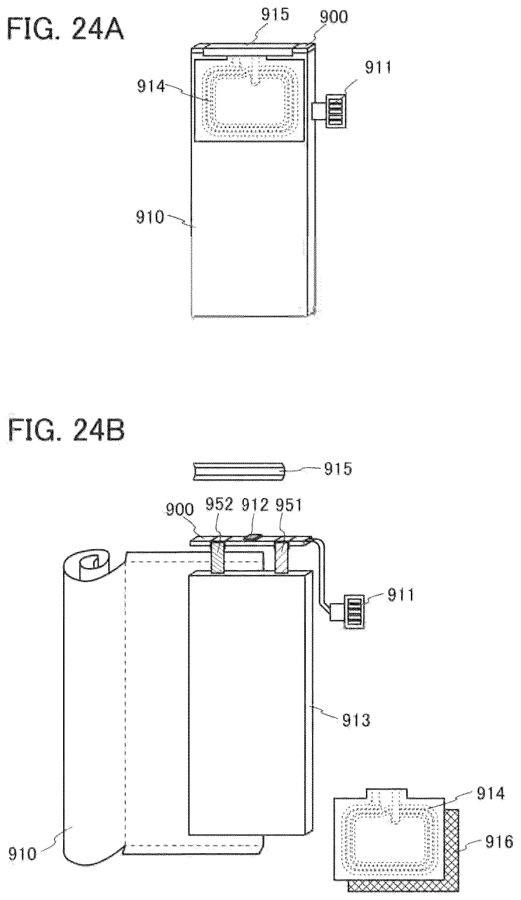

Other structure examples of secondary batteries are described with reference to FIG. 24 to FIG. 27.

FIG. 24A and FIG. 24B are external views of a battery pack. The battery pack includes a secondary battery 913 and a circuit board 900. The secondary battery 913 is connected to an antenna 914 through the circuit board 900. A label 910 is attached to the secondary battery 913. In addition, as illustrated in FIG. 24B, the secondary battery 913 is connected to a terminal 951 and a terminal 952. The circuit board 900 is fixed with a seal 915.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to coil shapes, and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

Note that the structure of the battery pack is not limited to that in FIG. 24.

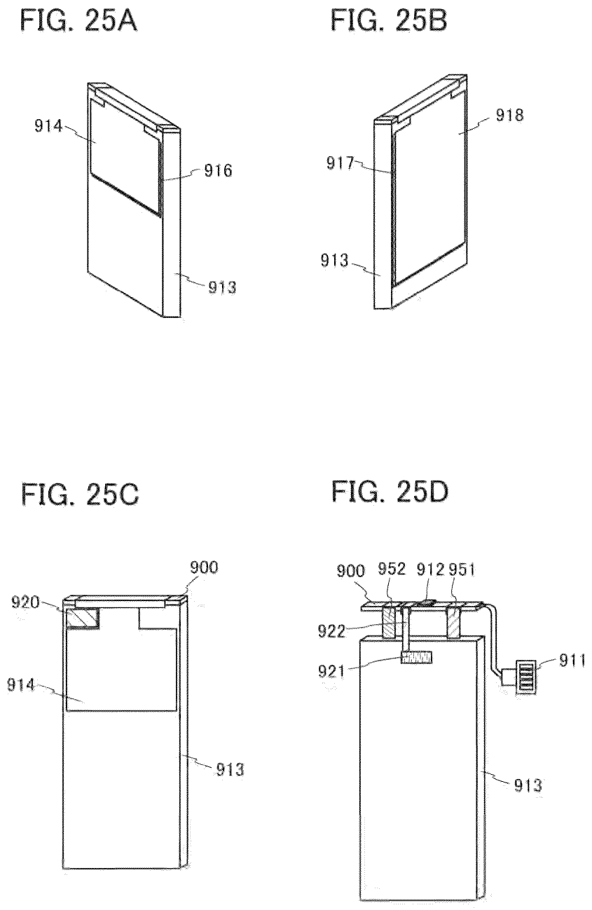

For example, as illustrated in FIG. 25A and FIG. 25B, two opposite surfaces of the secondary battery 913 of the battery pack may be provided with respective antennas. FIG. 25A is an external view seen from one side of the opposite surfaces, and FIG. 25B is an external view seen from the other side of the opposite surfaces.

As illustrated in FIG. 25A, the antenna 914 is provided on one of the opposite surfaces of the secondary battery 913 with the layer 916 interposed therebetween, and as illustrated in FIG. 25B, an antenna 918 is provided on the other of the opposite surfaces of the secondary battery 913 with a layer 917 interposed therebetween. The layer 917 has a function of blocking an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 25C, the secondary battery 913 illustrated in FIG. 25A and FIG. 25B may be provided with a display device 920. Note that for portions similar to those of the secondary battery illustrated in FIG. 25A and FIG. 25B, the description of the secondary battery illustrated in FIG. 25A and FIG. 25B can be appropriately referred to.

The display device 920 is electrically connected to the terminal 911 or the like, and the display device 920 may display, for example, an image showing whether charging is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 25D, the secondary battery 913 illustrated in FIG. 25A and FIG. 25B may be provided with a sensor 921. The sensor 921 is electrically connected to the terminal 911 via a terminal 922. Note that for portions similar to those of the secondary battery illustrated in FIG. 25A and FIG. 25B, the description of the secondary battery illustrated in FIG. and FIG. 25B can be appropriately referred to.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be detected and stored in a memory inside the circuit 912.

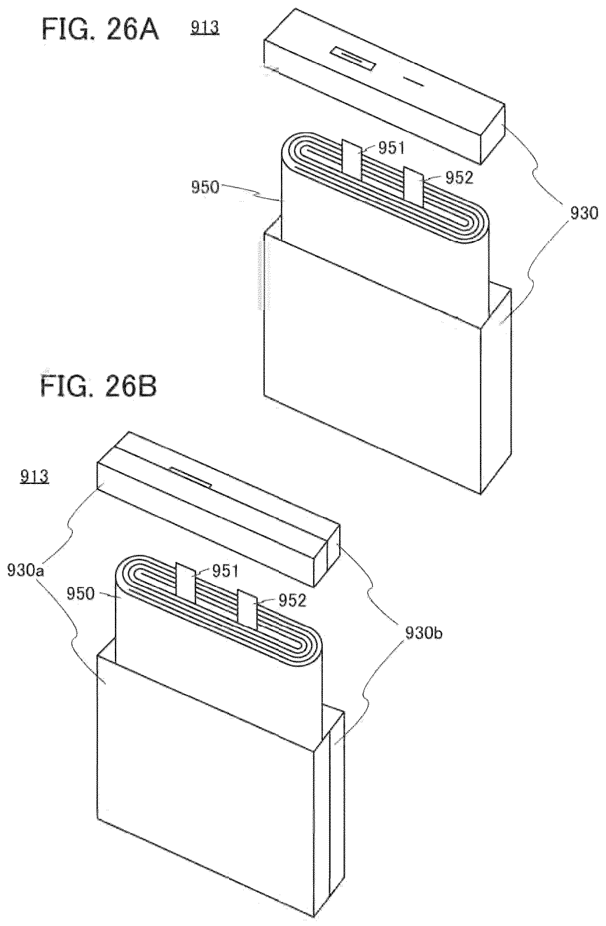

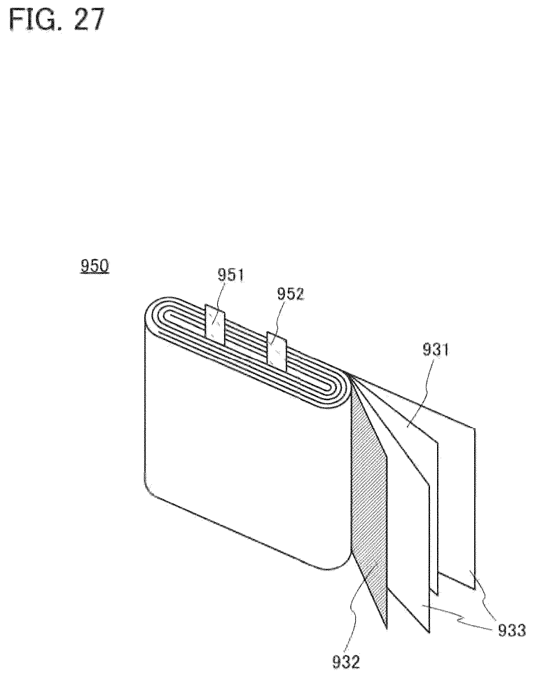

Furthermore, structure examples of the secondary battery 913 are described with reference to FIG. 26 and FIG. 27.

The secondary battery 913 illustrated in FIG. 26A includes a wound body 950 provided with the terminal 951 and the terminal 952 inside a housing 930. The wound body 950 is immersed in an electrolyte solution inside the housing 930. The terminal 952 is in contact with the housing 930. The use of an insulator or the like prevents contact between the terminal 951 and the housing 930. Note that in FIG. 26A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 26B, the housing 930 illustrated in FIG. 26A may be formed using a plurality of materials. For example, in the secondary battery 913 illustrated in FIG. 26B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 27 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 interposed therebetween. Note that a plurality of stacks each including the negative electrode 931, the positive electrode 932, and the separator 933 may be further stacked.

The negative electrode 931 is connected to the terminal 911 via one of the terminal 951 and the terminal 952. The positive electrode 932 is connected to the terminal 911 via the other of the terminal 951 and the terminal 952.

### <Laminated Secondary Battery>

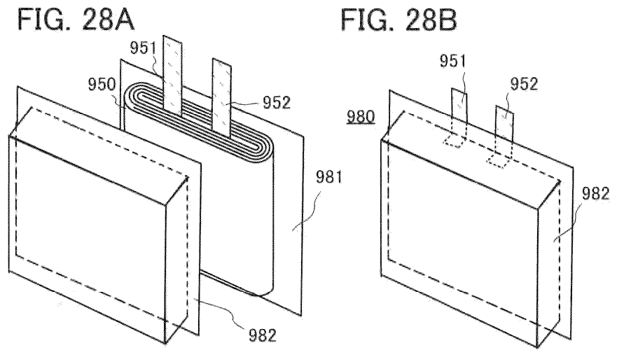

As illustrated in FIG. 28A, the wound body 950 may be placed in a space formed by bonding the film 981 serving as an exterior body and the film 982 having a depressed portion by thermocompression bonding or the like. Such a secondary battery is referred to as a laminated secondary battery. The wound body 950 is immersed in an electrolyte solution in the space formed by the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be fabricated.

Although the secondary battery 980 is formed using two films in FIG. 28A and FIG. 28B, a space may be formed by bending one film and the wound body 950 may be placed in the space.

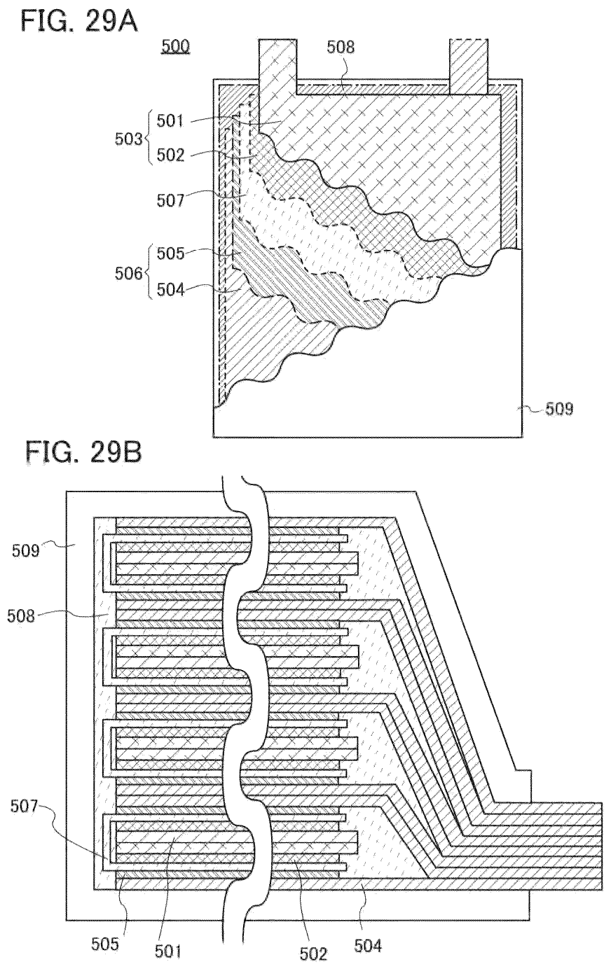

Next, another example of a laminated secondary battery is described with reference to FIG. 29. As illustrated in FIG. 29, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 29A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 3 can be used as the electrolyte solution 508.

In the laminated secondary battery 500 illustrated in FIG. 29A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 29B illustrates an example of a cross-sectional structure of the laminated secondary battery 500. FIG. 29A illustrates an example in which only two current collectors are included for simplicity, but actually, a plurality of electrode layers are included as illustrated in FIG. 29B.

In FIG. 29B, the number of electrode layers is 16, for example. Note that the secondary battery 500 has flexibility even though the number of electrode layers is set to 16. FIG. 29B illustrates a structure including 8 layers of negative electrode current collectors 504 and 8 layers of positive electrode current collectors 501, i.e., 16 layers in total. Note that FIG. 29B illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high charge and discharge capacity. In contrast, with a small number of electrode layers, the secondary battery can have small thickness and high flexibility.

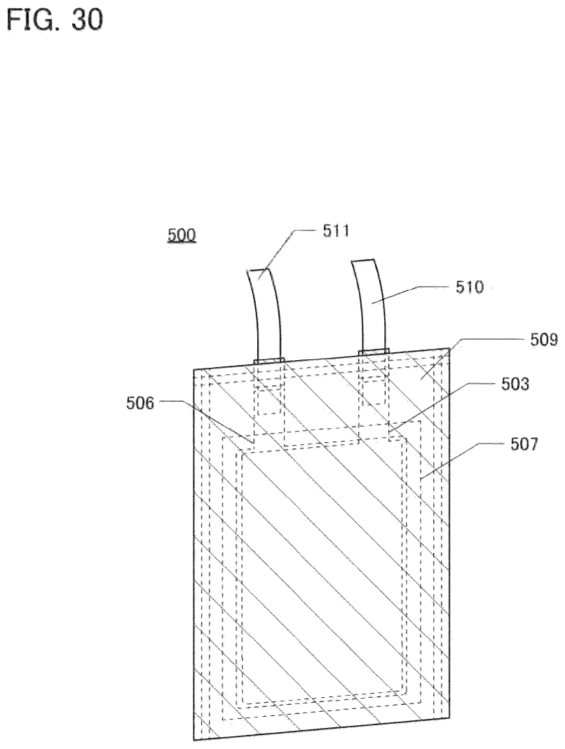

FIG. 30 and the like each illustrate an example of the external view of the laminated secondary battery 500. The positive electrode 503, the negative electrode 506, the separator 507, the exterior body 509, a positive electrode lead electrode 510, and a negative electrode lead electrode 511 are included.

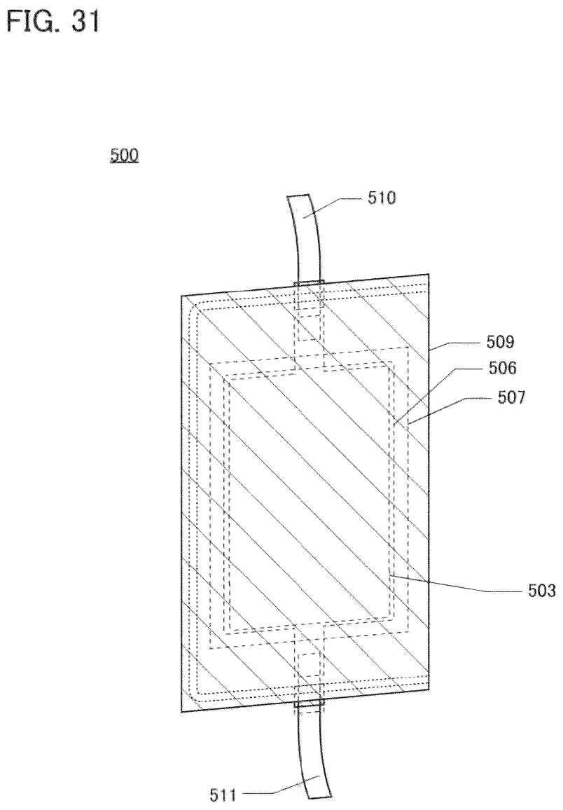

FIG. 31 is different from FIG. 30 in that the positive electrode lead electrode 510 and the negative electrode lead electrode 511 are provided in the opposite sides. The areas and the shapes of the tab regions included in the positive electrode and the negative electrode are not limited to those of examples illustrated in FIG. 30 and FIG. 31.

### <Method for Fabricating Laminated Secondary Battery>

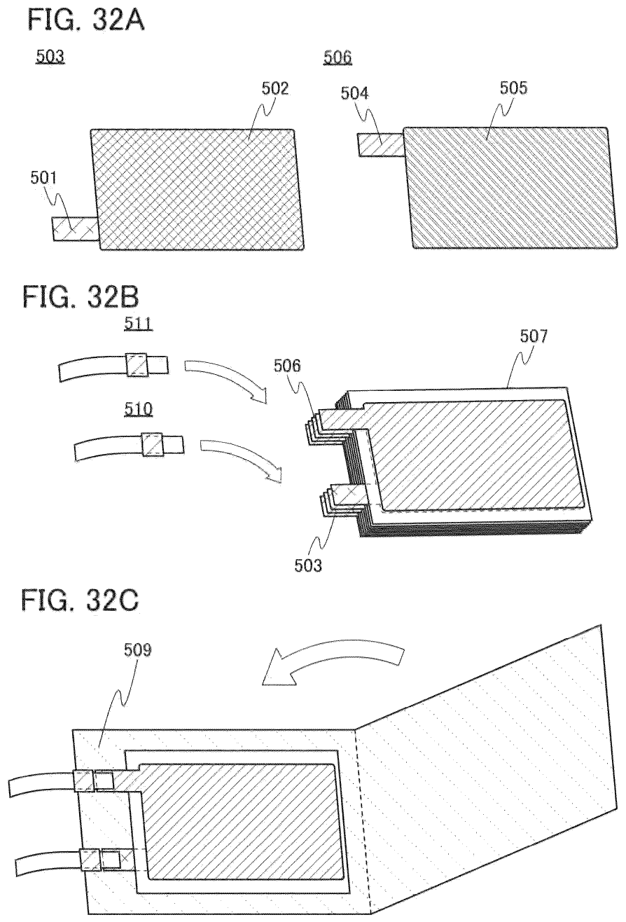

Here, an example of a method for fabricating the laminated secondary battery whose external view is illustrated in FIG. 30 is described with reference to FIG. 32A to FIG. 32C.

First, as illustrated in FIG. 32A, the negative electrode 506 and the positive electrode 503 are prepared. FIG. 32B illustrates a stack including the negative electrode 506, the separator 507, and the positive electrode 503. Here, an example in which 5 negative electrodes and 4 positive electrodes are used is shown. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a portion shown by a dashed line as illustrated in FIG. 32C. Then, the outer edges of the exterior body 509 are bonded to each other. The bonding can be performed by thermocompression bonding, for example. At this time, an unbonded region (hereinafter referred to as an inlet) is provided for part (or one side) of the exterior body 509 so that the electrolyte solution 508 can be put later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is bonded. In the above manner, the laminated secondary battery 500 can be fabricated.

When the positive electrode active material described in the above embodiment is used in the positive electrode 503, the secondary battery 500 with high charge and discharge capacity and excellent cycle performance can be obtained.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charging and discharging of the all-solid-state battery can be suppressed, and the reliability of the all-solid-state battery can be improved.

This embodiment can be implemented in appropriate combination with any of the other embodiments.

### Embodiment 9

In this embodiment, examples of electronic devices each including the secondary battery of one embodiment of the present invention are described.

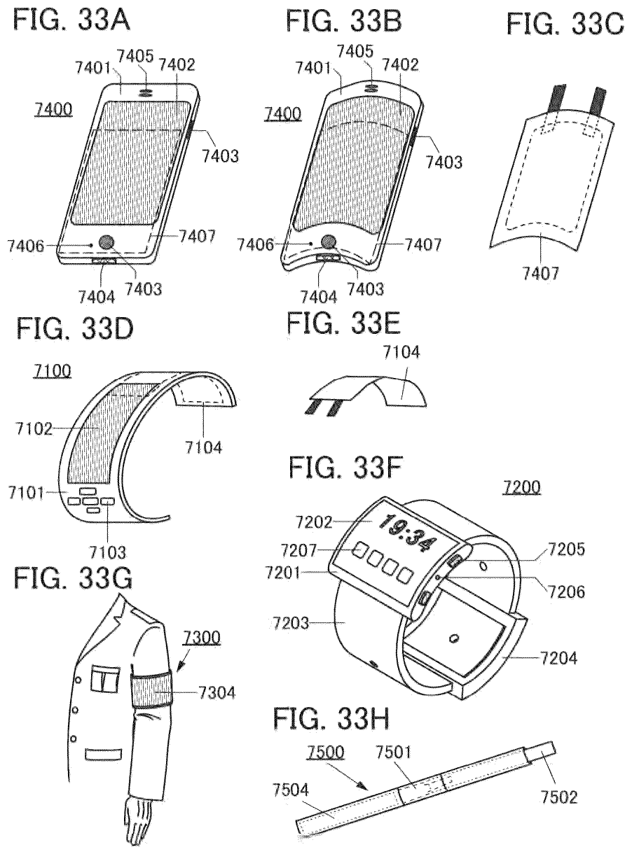

First, FIG. 33A to FIG. 33G illustrate examples of electronic devices including the bendable secondary battery described in the above embodiment. Examples of electronic devices each including a bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside/outside wall surface of a house or a building or a curved interior/exterior surface of an automobile.

FIG. 33A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 33B illustrates the mobile phone 7400 that is curved. When the whole mobile phone 7400 is curved by external force, the secondary battery 7407 provided therein is also curved. FIG. 33C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 33D illustrates an example of a bangle display device. A portable display device 7100 includes a housing 7101, a display portion 7102, operation buttons 7103, and a secondary battery 7104. FIG. 33E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the inverse of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 33F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charging via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 33E that is in the state of being curved can be provided in the housing 7201. Alternatively, the secondary battery 7104 illustrated in FIG. 33E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 33G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charging via the input/output terminal is possible. Note that the charging operation may be performed by wireless power feeding without using the input/output terminal.

The secondary battery of one embodiment of the present invention can be used as the secondary battery included in the display device 7300.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high charge and discharge capacity are desired in consideration of handling ease for users.

FIG. 33H is a perspective view of a device called a cigarette smoking device (electronic cigarette). In FIG. 33H, an electronic cigarette 7500 includes an atomizer 7501 including a heating element, a secondary battery 7504 that supplies power to the atomizer, and a cartridge 7502 including a liquid supply bottle, a sensor, or the like. To improve safety, a protection circuit that prevents overcharging and overdischarging of the secondary battery 7504 may be electrically connected to the secondary battery 7504. The secondary battery 7504 illustrated in FIG. 33H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high charge and discharge capacity and excellent cycle performance, the small and lightweight electronic cigarette 7500 that can be used for a long time over a long period can be provided.

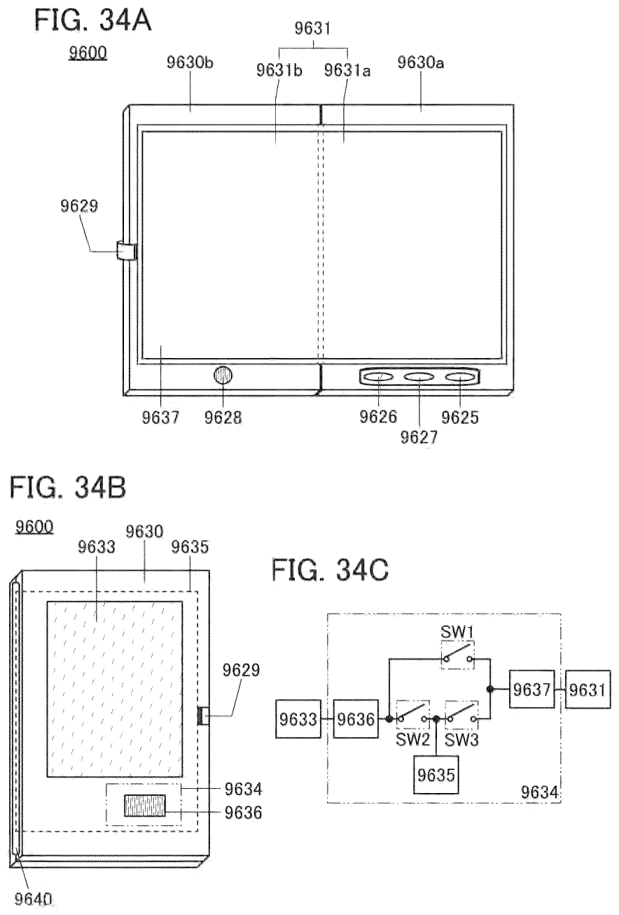

Next, FIG. 34A and FIG. 34B illustrate an example of a tablet terminal that can be folded in half. A tablet terminal 9600 illustrated in FIG. 34A and FIG. 34B includes a housing 9630a, a housing 9630b, a movable portion 9640 connecting the housing 9630a and the housing 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 34A illustrates the tablet terminal 9600 that is opened, and FIG. 34B illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

It is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display a keyboard on the display portion 9631.

Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may function as a switch for switching power on/off of the tablet terminal 9600. For another example, at least one of the switch 9625 to the switch 9627 may have a function of switching the display orientation between a portrait mode and a landscape mode and a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 34A illustrates an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different sizes or different display quality. For example, one may be a display panel that can display higher-resolution images than the other.

FIG. 34B illustrates the tablet terminal 9600 folded in half, and the tablet terminal 9600 includes a housing 9630, a solar cell 9633, and a charge and discharge control circuit 9634 including a DCDC converter 9636. The power storage unit of one embodiment of the present invention is used as the power storage unit 9635.

Note that as described above, the tablet terminal 9600 can be folded in half, and thus can be folded when not in use such that the housing 9630a and the housing 9630b overlap with each other. By the folding, the display portion 9631 can be protected, which increases the durability of the tablet terminal 9600. With the power storage unit 9635 including the secondary battery of one embodiment of the present invention, which has high charge and discharge capacity and excellent cycle performance, the tablet terminal 9600 that can be used for a long time over a long period can be provided.

The tablet terminal 9600 illustrated in FIG. 34A and FIG. 34B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, can supply electric power to a touch panel, a display portion, a video signal processing portion, and the like. Note that the solar cell 9633 can be provided on one surface or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 34B are described with reference to a block diagram in FIG. 34C. The solar cell 9633, the power storage unit 9635, the DCDC converter 9636, a converter 9637, switches SW1 to SW3, and the display portion 9631 are illustrated in FIG. 34C, and the power storage unit 9635, the DCDC converter 9636, the converter 9637, and the switches SW1 to SW3 correspond to the charge and discharge control circuit 9634 illustrated in FIG. 34B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage is raised or lowered by the converter 9637 to a voltage needed for the display portion 9631. When display on the display portion 9631 is not performed, the switch SW1 is turned off and the switch SW2 is turned on, so that the power storage unit 9635 is charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the charging may be performed with a non-contact power transmission module that performs charging by transmitting and receiving power wirelessly (without contact), or with a combination of other charge units.

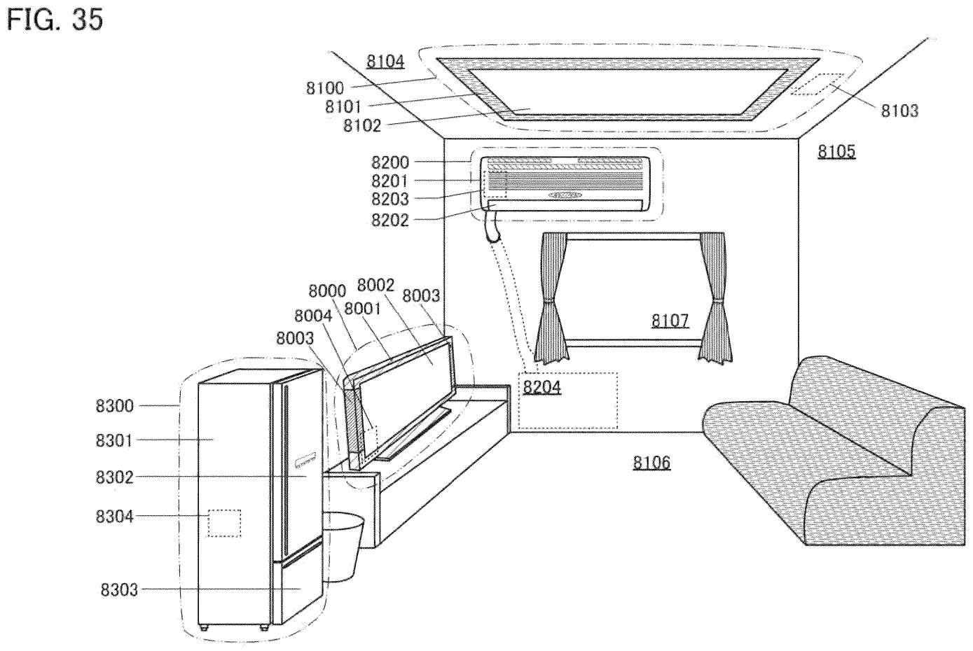

FIG. 35 illustrates other examples of electronic devices. In FIG. 35, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 35, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 35 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 35 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 35, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 35 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 35 as an example, the secondary battery of one embodiment of the present invention can be used in an air conditioner in which the function of an indoor unit and the function of an outdoor unit are integrated in one housing.

In FIG. 35, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 35. The electric refrigerator-freezer 8300 can be supplied with electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Therefore, the tripping of a breaker of a commercial power supply in use of the electronic device can be prevented by using the secondary battery of one embodiment of the present invention as an auxiliary power supply for supplying electric power which cannot be supplied enough by a commercial power supply.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high charge and discharge capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with the other embodiments.

### Embodiment 10

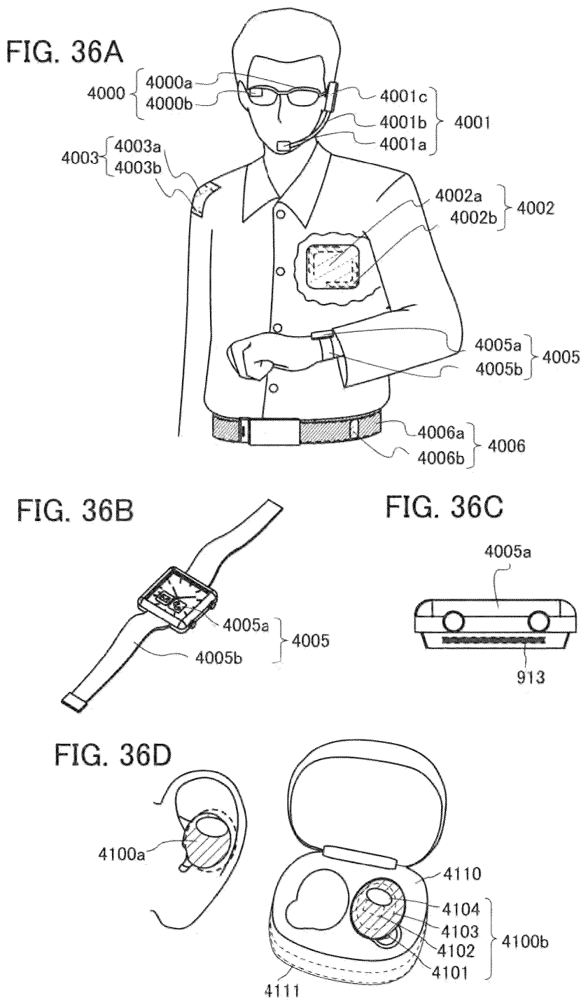

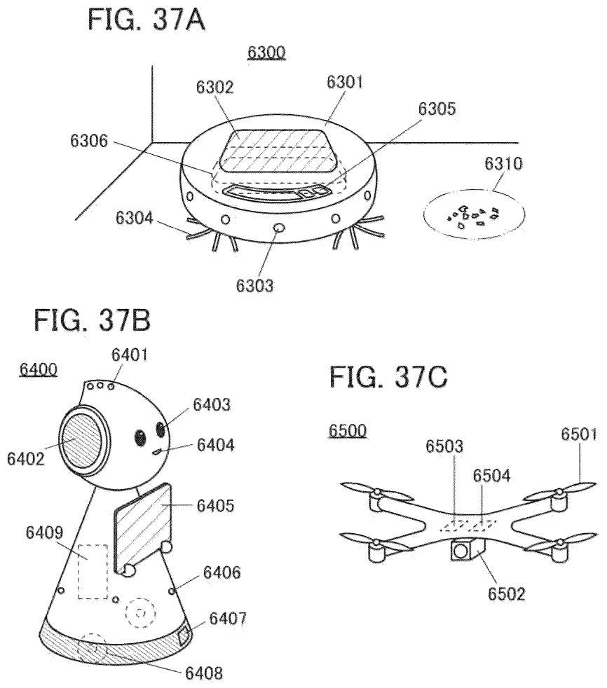

In this embodiment, examples of electronic devices each including the secondary battery described in the above embodiment are described with reference to FIG. 36A to FIG. 37C.

FIG. 36A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 36A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 36B is a perspective view of the watch-type device 4005 that is detached from an arm.

FIG. 36C is a side view. FIG. 36C illustrates a state where the secondary battery 913 is incorporated inside. The secondary battery 913 is the secondary battery described in Embodiment 4. The secondary battery 913, which is small and lightweight, is provided at a position overlapping with the display portion 4005a.

FIG. 36D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the above embodiment, for example, can be used. A secondary battery including a positive electrode using the positive electrode active material 100 obtained in Embodiment 1 has a high energy density; thus, with the use of the secondary battery as the secondary battery 4103 and the secondary battery 4111, a structure that accommodates space saving due to a reduction in size of the wireless earphones can be achieved.

FIG. 37A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 37B illustrates an example of a robot. A robot 6400 illustrated in FIG. 37B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 37C illustrates an example of a flying object. A flying object 6500 illustrated in FIG. 37C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 11

In this embodiment, examples of vehicles each including the secondary battery of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

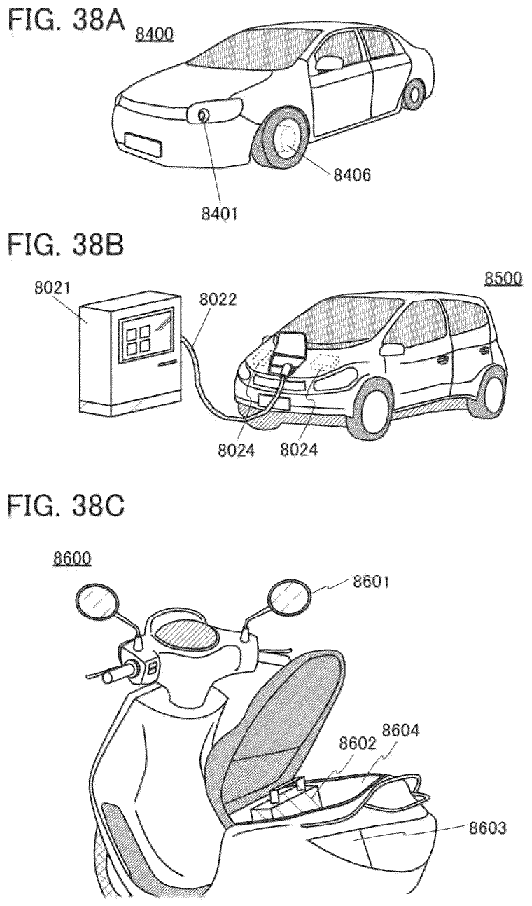

FIG. 38 illustrates examples of a vehicle including the secondary battery of one embodiment of the present invention. An automobile 8400 illustrated in FIG. 38A is an electric vehicle that runs on the power of an electric motor. Alternatively, the automobile 8400 is a hybrid electric vehicle capable of driving using either an electric motor or an engine as appropriate. The use of one embodiment of the present invention achieves a high-mileage vehicle. The automobile 8400 includes the secondary battery. As the secondary battery, the modules of the secondary batteries illustrated in FIG. 23C and FIG. 23D may be arranged to be used in a floor portion in the automobile. Alternatively, a battery pack in which a plurality of secondary batteries illustrated in FIG. 23 are combined may be placed in the floor portion in the automobile. The secondary battery can be used not only for driving an electric motor 8406, but also for supplying electric power to a light-emitting device such as a headlight 8401 or a room light (not shown).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 38B can be charged when the secondary battery included in the automobile 8500 is supplied with electric power through external charge equipment by a plug-in system, a contactless power feeding system, or the like. FIG. 38B illustrates a state where a secondary battery 8024 included in the automobile 8500 is charged with the use of a ground-based charging apparatus 8021 through a cable 8022. Charging can be performed as appropriate by a given method such as CHAdeMO (registered trademark) or Combined Charging System as a charging method, the standard of a connector, or the like. The charging apparatus 8021 may be a charge station provided in a commerce facility or a power supply in a house. For example, with the use of a plug-in technique, the secondary battery 8024 included in the automobile 8500 can be charged by being supplied with electric power from outside. The charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 38C illustrates an example of a motorcycle including the secondary battery of one embodiment of the present invention. A motor scooter 8600 illustrated in FIG. 38C includes a secondary battery 8602, side mirrors 8601, and direction indicators 8603. The secondary battery 8602 can supply electric power to the direction indicators 8603.

In the motor scooter 8600 illustrated in FIG. 38C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the charge and discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### Example 1

In this example, a positive electrode active material was fabricated with reference to FIG. or the like described in the above embodiment, and coin cells (sometimes also referred to as cells) each using the fabricated positive electrode active material were fabricated and evaluated.

### <Fabrication of Positive Electrode Active Material>

### <Step S14>

As LiMO₂ in Step S14 in FIG. 10, with the use of cobalt as the transition metal M, commercially available lithium cobalt oxide (Cellseed C-10N produced by NIPPON CHEMICAL INDUSTRIAL CO., LTD.) not containing any additive element was prepared.

### <Step S20a>

According to Step S20a in FIG. 10, lithium fluoride and magnesium fluoride were prepared as the first additive element source (referred to as the X1 source), and the lithium fluoride and the magnesium fluoride were mixed by a solid phase method. The lithium fluoride and the magnesium fluoride were weighed such that the number of molecules of the lithium fluoride was and the number of molecules of the magnesium fluoride was 1 with the number of cobalt atoms assumed to be 100. The lithium fluoride and the magnesium fluoride were mixed in dehydrated acetone at a rotating speed of 400 rpm for 12 hours, so that the X1 source was obtained.

### <Step S31 and Step S32>

According to Step S31 in FIG. 10, 1 mol % of the X1 source and lithium cobalt oxide were mixed. Specifically, the mixing was performed using a planetary ball mill at a rotating speed of 150 rpm for one hour, so that the mixture 903 shown in Step 32 was obtained.

### <Step S33 to Step S34a>

Heating was performed according to Step S33 in FIG. 10. In a square-shaped alumina container, the mixture 903 was placed, a lid was put on the container, and heating was performed in a muffle furnace. The atmosphere in the furnace was purged and an oxygen gas was introduced; the flow was not performed during the heating. The heating temperature was 900° C. and the heating time was 20 hours. In this manner, the composite oxide shown in Step S34a was obtained. The composite oxide is lithium cobalt oxide containing the X1 source.

### <Step S40>

According to Step S40 in FIG. 10, the second additive element source (referred to as the X2 source) was prepared. A nickel source and an aluminum source were used as the X2 source. Nickel hydroxide was prepared as the nickel source, and aluminum hydroxide was prepared as the aluminum source.

### <Step S51 and Step S52>

According to Step S51 in FIG. 10, the composite oxide obtained in Step S34a was mixed with a mixture of 0.5 mol % of the aluminum hydroxide and 0.5 mol % of the nickel hydroxide using a planetary ball mill at a rotating speed of 150 rpm for one hour, so that the mixture 904 in Step S52 was obtained.

### <Step S53>

Heating was performed according to Step S53 in FIG. 10. In a square-shaped alumina container, the mixture 903 was placed, a lid was put on the container, and heating was performed in a muffle furnace. The atmosphere in the furnace was purged and an oxygen gas was introduced; the flow was performed during the heating. The heating temperature was 850° C. and the heating time was 10 hours.

### <Step S54>

In such a manner, the positive electrode active material 100 of Step S54 in FIG. 10 was obtained. The positive electrode active material 100 is lithium cobalt oxide containing the X1 source and the X2 source. Specifically, the positive electrode active material 100 is lithium cobalt oxide containing at least magnesium, aluminum, fluorine, and nickel.

### <Fabrication of Positive Electrode>

Next, positive electrodes were fabricated using the positive electrode active material 100 fabricated in the above manner.

The positive electrode active material fabricated in the above manner, acetylene black (AB), and polyvinylidene fluoride (PVDF) were mixed at the positive electrode active material:AB:PVDF=95:3:2 (weight ratio) using NMP as a solvent, whereby slurry was fabricated. The fabricated slurry was applied to only one surface of the current collector, and then the solvent was vaporized. Aluminum foil having a thickness of 20 μm was used as the current collector.

### <Pressing Conditions>

After that, positive electrodes were fabricated under two conditions: a condition where pressing was performed (denoted as “with pressing”) and a condition where pressing was not performed (denoted as “without pressing”). Under the condition where pressing was performed, a pressure of 210 kN/m was applied at 120° C., and then a pressure of 1467 kN/m was applied at 120° C. The loading amount and the density of the positive electrode active material layer were approximately 6.8 mg/cm 2 and 3.7 g/cc under the condition with pressing, and approximately 7.1 mg/cm 2 and 2.1 g/cc under the condition without pressing.

Through the above steps, the positive electrodes were fabricated.

### <Coin Cell>

Next, using the fabricated positive electrodes, CR2032 type coin cells (with a diameter of 20 mm and a height of 3.2 mm) were fabricated.

A lithium metal was used for a counter electrode of the coin cell. This electrode is referred to as a lithium electrode.

As a lithium salt contained in an electrolyte solution of the coin cell, 1 mol/L of lithium hexafluorophosphate (LiPF₆) was used. As a solvent contained in the electrolyte solution, a solution in which ethylene carbonate (EC) and diethyl carbonate (DEC) at EC:DEC=3:7 (volume ratio) and vinylene carbonate (VC) at 2 wt % are mixed was used.

A polypropylene separator was used for the coin cell.

### <Cycle Test>

A cycle test (half-cell test) was performed on the coin cells to evaluate the samples.

### <Test Conditions>

First, a discharge rate and a charge rate as the cycle conditions are described. The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Specific conditions are described. The charge conditions are as follows: constant current charging (referred to as CC charging) was performed at 0.5 C until the voltage reached 4.6 V or 4.7 V, and then constant voltage charging (referred to as CV charging) was performed until the current value reached 0.05 C. The voltage of 4.6 V or 4.7 V is referred to as an upper limit voltage. As the discharge condition, constant current discharging was performed at 0.5 C until the voltage reached 2.5 V. The voltage of 2.5 V is referred to as a lower limit voltage. In this cycle test, 1 C was set to 200 mA/g. The coin cells were placed at a temperature of 25° C. or 45° C. A break period longer than or equal to 5 minutes and shorter than or equal to 15 minutes may be provided between charging and discharging, and a break period of 10 minutes was provided in this cycle test. In the above manner, charging and discharging were repeated 50 times.

In a laminated cell (also referred to as full cell), graphite was used instead of lithium for the electrode. The upper limit voltage of the coin cell (also referred to as half cell) is lower than that of the full cell by approximately 0.1 V. The conditions in this cycle test correspond to charging to 4.5 V or 4.6 V in the full cell.

### <Test Results>

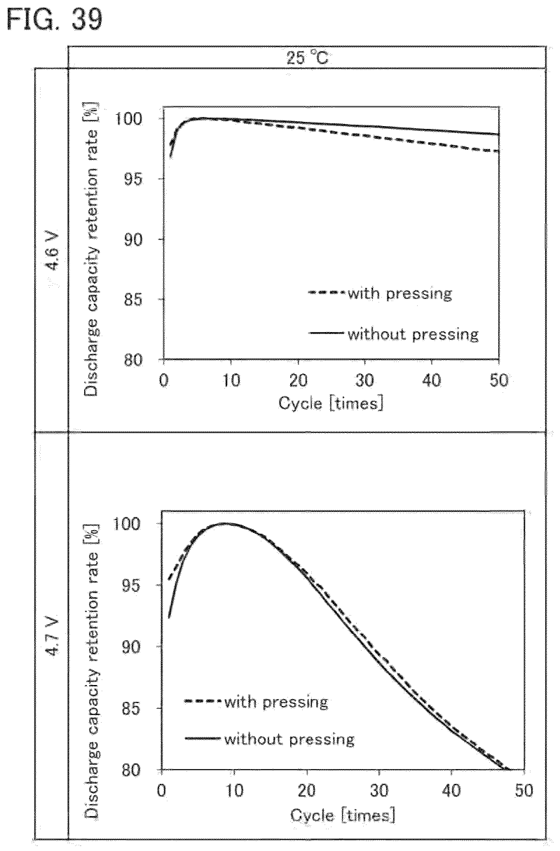

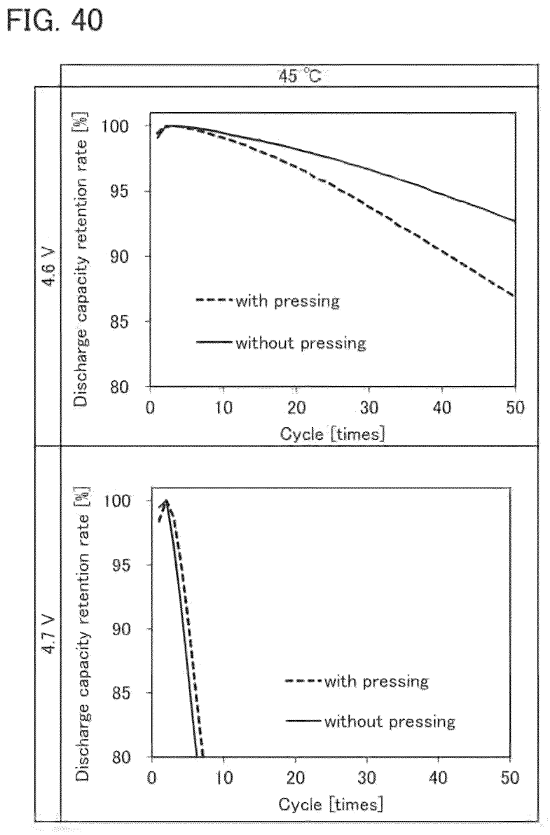

FIG. 39 and FIG. 40 show the discharge capacity retention rates, which are a kind of the cycle test results. Note that the discharge capacity retention rate (%) was obtained by performing 50 cycles of the above charging and discharging and calculating (capacity after 50 cycles/capacity after 1 cycle)×100. That is, the discharge capacity retention rate shows a change in discharge capacity in accordance with the number of cycles. In each graph, the horizontal axis represents the number of cycles and the vertical axis represents the discharge capacity retention rate (%: with the maximum discharge capacity in 50 cycles assumed to be 100%). A higher discharge capacity retention rate inhibits a reduction in battery capacity after repeated charging and discharging, which is desirable for battery performance.

The upper graph of FIG. 39 shows the results of the cycle test at 25° C. and 4.6 V, the lower graph of FIG. 39 shows the results of the cycle test at 25° C. and 4.7 V, the upper graph of FIG. 40 shows the results of the cycle test at 45° C. and 4.6 V, and the lower graph of FIG. 40 shows the results of the cycle test at 45° C. and 4.7 V. In each graph, the condition without pressing is indicated by a solid line and the condition with pressing is indicated by a dashed line.

As the cycle test results, the maximum discharge capacity values are shown in the following table.

TABLE 1
Maximum discharge capacity value (mAh/g)

| | |
|---|---|
| 25° C. | 45° C. |

| | 4.6 V | 4.7 V | 4.6 V | 4.7 V |
|---|---|---|---|---|
| With pressing | 217.7 | 237.3 | 224.9 | 242.9 |
| Without pressing | 218.0 | 234.4 | 224.7 | 241.5 |

As the cycle test results, the discharge capacity retention rates after 50 cycles are shown in the following table.

TABLE 2
Discharge capacity retention rate (%) after 50 cycles

| | |
|---|---|
| 25° C. | 45° C. |

| | 4.6 V | 4.7 V | 4.6 V | 4.7 V |
|---|---|---|---|---|
| With pressing | 98.7 | 78.9 | 92.7 | 37.3 |
| Without pressing | 97.3 | 79.0 | 86.8 | 36.8 |

FIG. 39, FIG. 40, and Table 2 show that, at 4.6 V, a decrease in discharge capacity retention rate is suppressed more in the condition without pressing than in the condition with pressing, and suppressed significantly at 45° C. in particular. At 4.7 V, there is no big difference in decrease in discharge capacity retention rate between the condition without pressing and the condition with pressing.

Table 1 does not show a big difference in the maximum discharge capacity value between the condition without pressing and the condition with pressing.

### <SEM (Scanning Electron Microscopy) Observation>

Next, the coin cells after the cycle test in which charging and discharging were repeated 50 cycles were disassembled, and observation images were obtained by SEM observation. In the case of cross-sectional observation, cross-sections were exposed by processing with FIB for observation. The FIB processing and the SEM observation were performed using XVision manufactured by Hitachi High-Tech Corporation, and an accelerating voltage in the SEM observation was 2.0 kV.

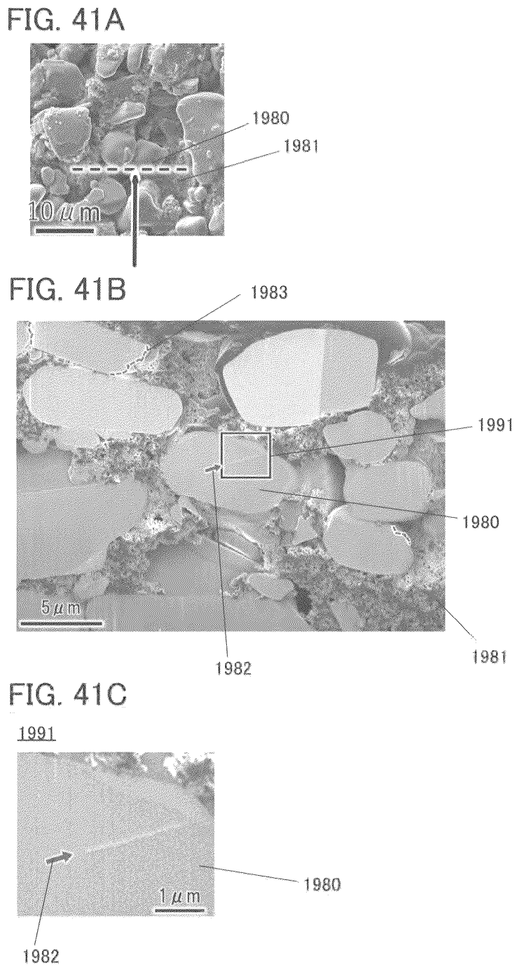

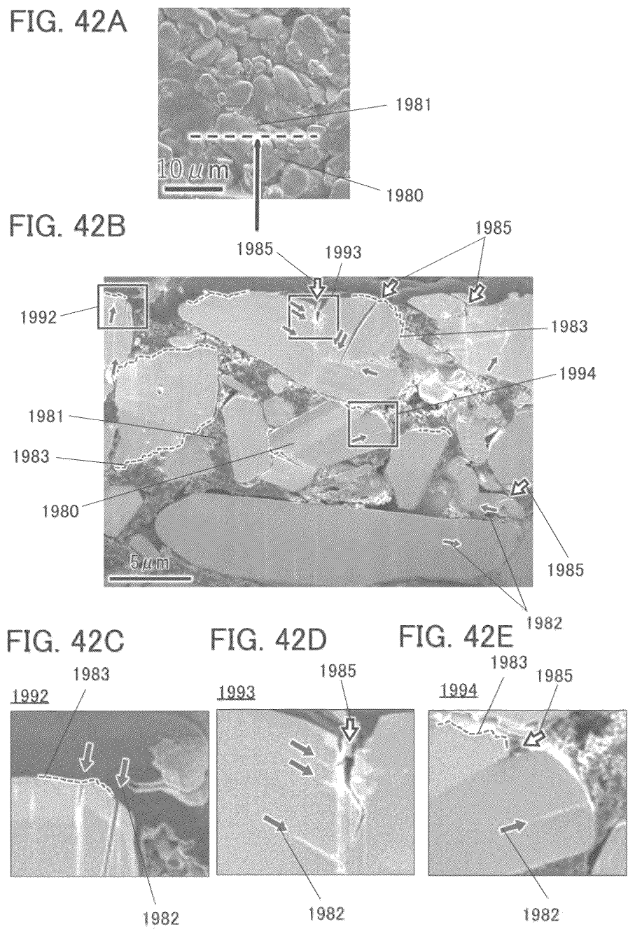

FIG. 41 and FIG. 42 are observation images of the positive electrodes subjected to the cycle test at 45° C. and 4.6 V; FIG. 41 shows the positive electrode without pressing and FIG. 42 shows the positive electrode with pressing.

In the SEM image of the top surface of the positive electrode shown in FIG. 41A, a positive electrode active material 1980 and acetylene black (denoted as AB) 1981 can be observed.

FIG. 41B is an observation image obtained by observing a portion indicated by a dashed line shown in FIG. 41A in the arrow direction, and the positive electrode active material 1980 and the AB 1981 can be observed. FIG. 41C is an enlarged image of a region 1991 denoted by a square in FIG. 41B. A dashed line 1983 shown in FIG. 41B indicates a portion of a slip. An arrow 1982 shown in each of FIG. 41B and FIG. 41C indicates a portion of a pit that is a defect.

In the SEM image of the top surface of the positive electrode shown in FIG. 42A, the positive electrode active material 1980 and the AB 1981 can be observed.

FIG. 42B is an observation image obtained by observing a portion indicated by a dashed line shown in FIG. 42A in the arrow direction, and the positive electrode active material 1980 and the AB 1981 can be observed. FIG. 42C to FIG. 42E are enlarged images respectively of a region 1992, a region 1993, and a region 1994 indicated by squares in FIG. 42B. The dashed line 1983 shown in each of FIG. 42B, FIG. 42C, and FIG. 42E indicates a portion of a slip. The arrow 1982 shown in each of FIG. 42B to FIG. 42E indicates a portion of a pit. Since FIG. 42B to FIG. 42E show many pits, only some of the arrows are denoted by reference numerals. A solid white arrow 1985 shown in each of FIG. 42B, FIG. 42D, and FIG. 42E indicates a portion of a crack that is a defect.

It is suggested that the frequency of generation of a pit and a crack is high under the conditions at 4.6 V with pressing. The frequency of generation of a pit and a crack is low under the condition at 4.6 V without pressing, which indicates the possibility that a decrease in discharge capacity retention rate is suppressed.

### Example 2

In this example, a positive electrode active material was fabricated with reference to FIG. 11 described in the above embodiment, and coin cells using the fabricated positive electrode active material were fabricated and evaluated.

### <Fabrication of Positive Electrode Active Material>

### <Step S14>

As LiMO₂ in Step S14 in FIG. 11, with the use of cobalt as the transition metal M, commercially available lithium cobalt oxide (Cellseed C-10N manufactured by NIPPON CHEMICAL INDUSTRIAL CO., LTD.) not containing any additive element was prepared.

### <Step S20a>

According to Step S20a in FIG. 11, lithium fluoride and magnesium fluoride were prepared as the X1 source, and the lithium fluoride and the magnesium fluoride were mixed by a wet process. The lithium fluoride and the magnesium fluoride were weighed such that the number of molecules of the lithium fluoride was 0.33 and the number of molecules of the magnesium fluoride was 1 with the number of cobalt atoms assumed to be 100. The lithium fluoride and the magnesium fluoride were mixed in dehydrated acetone at a rotating speed of 400 rpm for 12 hours, so that the X1 source was obtained.

### <Step S31 and Step S32>

According to Step S31 in FIG. 11, 1 mol % of the X1 source and lithium cobalt oxide were mixed. Specifically, the mixing was performed by a dry process at a rotating speed of 150 rpm for one hour, so that the mixture 903 shown in Step 32 was obtained.

### <Step S33 to Step S34a>

Heating was performed according to Step S33 in FIG. 11. In a square-shaped alumina container, the mixture 903 was placed, a lid was put on the container, and heating was performed in a muffle furnace. The atmosphere in the furnace was purged and an oxygen gas was introduced; the flow was performed during the heating. The heating temperature was 850° C. and the heating time was 60 hours. In such a manner, the composite oxide shown in Step S34a was obtained. The composite oxide is lithium cobalt oxide containing the X1 source.

### <Step S40a>

According to Step S40a in FIG. 11, the X2a source was prepared. As a nickel source of the X2a source, 0.5 mol % of nickel hydroxide was prepared.

### <Step S41 and Step S42>

According to Step S41 in FIG. 11, the composite oxide obtained in Step S34a and the mol % of nickel hydroxide were mixed, so that a mixture 991 of Step S42 was obtained.

### <Step S40b to Step S52>

According to Step S40b in FIG. 11, the X2b source was prepared, and mixing according to Step S51 in FIG. 11 was performed by a sol-gel method. Thus, 2-propanol was also prepared as a solvent in Step S40b. Furthermore, in Step S40b, aluminum isopropoxide and zirconium isopropoxide were prepared as metal alkoxide of the X2b source. The aluminum alkoxide and the zirconium isopropoxide were weighed to have concentrations of 0.5 mol % and 0.25 mol %, respectively, so that the X2b source was obtained.

### <Step S51 and Step S52>

According to Step S51, the X2b source and the mixture 991 were mixed at a heating temperature of 95° C. for a heating time of 3 hours to remove the solvent. In such a manner, the mixture 904 of Step S52 was obtained.

### <Step S53>

Heating was performed according to Step S53 in FIG. 11. The atmosphere in the furnace was purged and an oxygen gas was introduced; the flow was performed during the heating. The heating temperature was 850° C. and the heating time was 2 hours.

### <Step S54>

In such a manner, the positive electrode active material 100 of Step S54 in FIG. 11 was obtained. The positive electrode active material 100 was lithium cobalt oxide containing the X1 source, the X2a source, and the X2b source. Specifically, the positive electrode active material 100 is lithium cobalt oxide containing at least magnesium, aluminum, fluorine, nickel, and zirconium.

### <Fabrication of Positive Electrode>

Next, a positive electrode was fabricated using the positive electrode active material 100 fabricated in the above manner.

The positive electrode active material fabricated in the above manner, acetylene black (AB), and polyvinylidene fluoride (PVDF) were mixed at the positive electrode active material:AB:PVDF=95:3:2 (weight ratio) using NMP as a solvent, whereby slurry was fabricated. The fabricated slurry was applied to only one surface of the current collector, and then the solvent was vaporized. Aluminum foil having a thickness of 20 μm was used as the current collector.

### <Pressing Conditions>

Next, a pressure of 210 kN/m was applied at 120° C., and then a pressure of 1467 kN/m was applied at 120° C. The loading amount and the density of the positive electrode active material layer were approximately 7.3 mg/cm 2 and 3.8 g/cc, respectively.

Through the above steps, the positive electrode was fabricated.

### <Coin Cell>

Next, using the fabricated positive electrode, a CR2032 type coin cell (with a diameter of 20 mm and a height of 3.2 mm) was fabricated.

A lithium metal was used for a counter electrode of the coin cell. This is referred to as a lithium electrode.

As a lithium salt contained in an electrolyte solution of the coin cell, 1 mol/L of lithium hexafluorophosphate (LiPF₆) was used. As a solvent contained in the electrolyte solution, a solution in which ethylene carbonate (EC) and diethyl carbonate (DEC) at EC:DEC=3:7 (volume ratio) and vinylene carbonate (VC) at 2 wt % are mixed was used.

A polypropylene separator was used for the coin cell.

### <Cycle Test>

A cycle test (half-cell test) was performed on the coin cell to evaluate the sample.

### <Test Conditions>

The charge conditions are as follows: constant current charging was performed at 0.5 C until the voltage reached 4.65 V or 4.7 V, and then constant voltage charging was performed until the current value reached 0.05 C. The voltage of 4.65 V or 4.7 V is referred to as an upper limit voltage. As the discharge condition, constant current discharging was performed at 0.5 C until the voltage reached 2.5 V. The voltage of 4.6 V or 4.7 V is referred to as an upper limit voltage. In this cycle test, 1 C was set to 200 mA/g. The coin cell was placed at a temperature of 25° C. or 45° C. An interval longer than or equal to 5 minutes and shorter than or equal to 15 minutes may be provided between charging and discharging, and an interval of 10 minutes was provided in this cycle test. In the above manner, charging and discharging were repeated 50 times.

In a laminated cell (also referred to as full cell), graphite was used instead of lithium for the electrode. The upper limit voltage of the coin cell (also referred to as half cell) is smaller than that of the full cell by approximately 0.1 V. The conditions in this cycle test correspond to charging to 4.5 V or 4.6 V in the full cell.

### <Test Results>

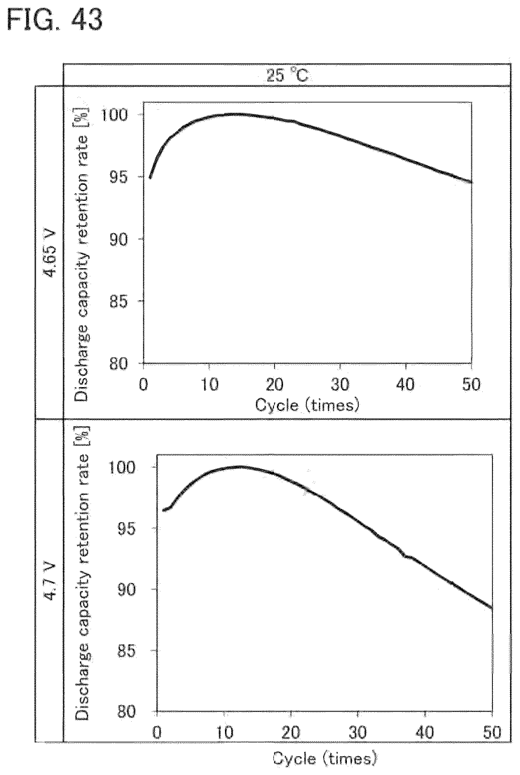

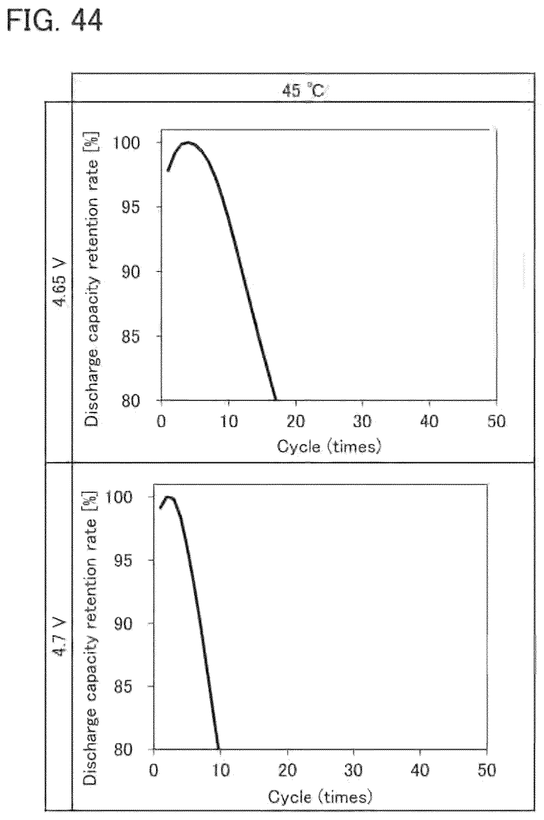

FIG. 43 and FIG. 44 show the discharge capacity retention rates, which are a kind of the cycle test results. The upper graph of FIG. 43 shows the results of the cycle test at 25° C. and 4.65 V, the lower graph of FIG. 43 shows the results of the cycle test at 25° C. and 4.7 V, the upper graph of FIG. 44 shows the results of the cycle test at 45° C. and 4.65 V, and the lower graph of FIG. 44 shows the results of the cycle test at 45° C. and 4.7 V.

As the cycle test results, the maximum discharge capacity values are shown in the following table.

TABLE 3
Maximum discharge capacity value (mAh/g)

| | |
|---|---|
| 25° C. | 45° C. |

| 4.65 V | 4.7 V | 4.65 V | 4.7 V |
|---|---|---|---|
| 224.0 | 223.3 | 232.1 | 232.1 |

As the cycle test results, the discharge capacity retention rates after 50 cycles are shown in the following table.

TABLE 4
Discharge capacity retention rate (%) after 50 cycles

| | |
|---|---|
| 25° C. | 45° C. |

| 4.65 V | 4.7 V | 4.65 V | 4.7 V |
|---|---|---|---|
| 94.5 | 88.4 | 48.9 | 37.3 |

FIG. 43, FIG. 44, and Table 4 show that a decrease in discharge capacity retention rate is suppressed at 25° C., and suppressed significantly at 4.65 V in particular.

Table 3 does not show a big difference in the maximum discharge capacity value.

### <STEM Observation>

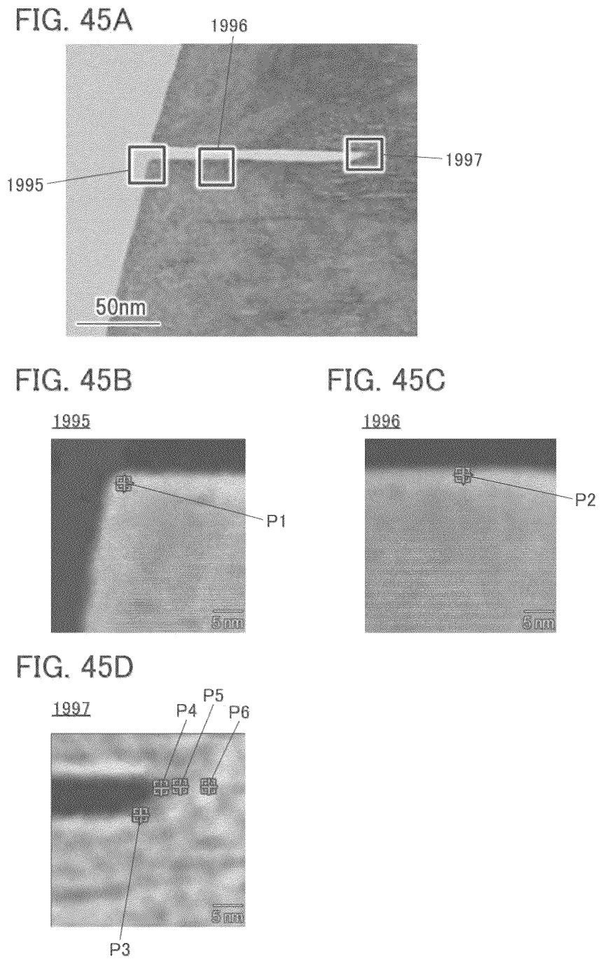

The coin cell after the cycle test in which charging and discharging were repeated 50 cycles under the conditions of 25° C. and 4.7 V was disassembled, and STEM observation was performed. The cross section was processed by FIB. As the STEM apparatus, JEM-ARM200F manufactured by JEOL Ltd. was used. The accelerating voltage was 200 kV. FIG. 45A is a cross-sectional image of a pit that is a defect observed in the positive electrode active material. FIG. 45B, FIG. 45C, and FIG. 45D are enlarged images respectively of a region 1995, a region 1996, and a region 1997 indicated by squares in FIG. 45A.

EDX analysis was performed on measurement points P1 to P6 shown in FIG. 45B, FIG. 45C, and FIG. 45D. The concentrations of detected magnesium (Mg) and aluminum (Al) are shown in the following table. Note that “-” in the following table indicates a concentration of 1 atom % or lower and no detection of clear peaks.

TABLE 5
[atom %]

| | Mg | Al |
|---|---|---|
| P1 | 2.3 | 3.1 |
| P2 | 0.6 | 5.1 |
| P3 | — | — |
| P4 | — | — |
| P5 | — | — |
| P6 | 0.7 | — |

The region 1997 is a STEM image of a region including the tip of the pit; at the measurement points P3 and P4 that are in the surface portion at the tip and the measurement point P5 positioned deeper than the measurement points P3 and P4 by several nanometers, the concentrations of magnesium and aluminum were lower than or equal to 1 atom % and no clear peak was detected. Meanwhile, at the measurement point P6 positioned deeper than the measurement point P5, a magnesium peak was observed although the concentration was lower than or equal to 1 atom %. At the measurement point P1 around the entrance of the pit, both magnesium and aluminum were detected. At the measurement point P2 at a depth of approximately 50 nm from the measurement point P1, aluminum was detected. In addition, a magnesium peak was observed at the measurement point P2 although the concentration was lower than or equal to 1 atom %.

Magnesium and aluminum are the elements that are the same as those added to the lithium cobalt oxide as the additive element sources (the X1 source, the X2 source, or the like).

In the surface portion of the lithium cobalt oxide where a defect such as a pit is formed, an additive element such as magnesium or aluminum is detected. This indicates that the additive element moves due to charging and discharging in a cycle test and is unevenly distributed also in the surface portion that appears only after formation of the defect such as the pit.

In consideration of the pit progress, the region 1997 is formed after the region 1996 and the region 1995. Since magnesium was detected at P6 in the region 1997, magnesium is presumably detected also in P3 to P5 when the cycle test is kept performed. A region at the tip of a pit where magnesium or the like can be distributed unevenly, such as the region 1997, is referred to as a pit tip region or simply referred to as a defect tip region. The thickness of the pit tip region in a cross-sectional image is 15 nm, preferably 10 nm, further preferably 5 nm.

A region in the vicinity of a pit where magnesium or the like is distributed unevenly, such as the region 1995 or the region 1996, is referred to as a region in the vicinity of a pit or simply referred to as a region in the vicinity of a defect. The thickness of the region in the vicinity of a pit in a cross-sectional image is 15 nm, preferably 10 nm, further preferably 5 nm.

### Example 3

This example examines lithium diffusibilities of LiCoO₂ (the O3 structure, the layered rock-salt structure, hexagonal: R-3m), LiCo₂O₄ (the spinel structure, cubic: Fd-3m), Co₃O₄ (the spinel structure, cubic: Fd-3m), and CoOx (the rock-salt structure in the case of CoO, cubic: Fm-3m), which are structures that lithium cobalt oxide can have.

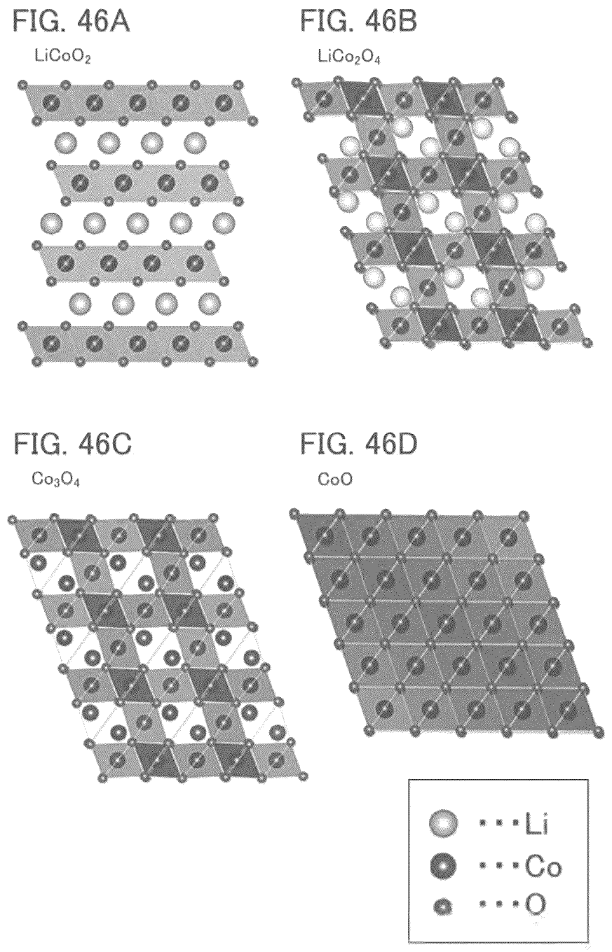

FIG. 46A to FIG. 46D illustrate the crystal structures of LiCoO₂, LiCo₂O₄, Co₃O₄, and CoO. As already described above, LiCoO₂ has the O3 structure, LiCo₂O₄ and Co₃O₄ have the spinel structure, and CoOx has the rock-salt structure when being CoO.

Among these, lithium exists in the structure of LiCoO₂ as illustrated in FIG. 46A, and lithium exists in the structure of LiCo₂O₄ as illustrated in FIG. 46B. In consideration of such structures, the energy barrier was calculated to obtain the lithium diffusibility in LiCoO₂ and LiCo₂O₄, on the assumption that lithium moves to an adjacent lithium site.

As illustrated in FIG. 46C, lithium does not exist in the structure of Co₃O₄. In view of this, on the assumption that lithium moves from an octahedral site to an adjacent octahedral site in the structure, the energy barrier related to the movement was calculated to obtain the lithium diffusibility in Co₃O₄. Specifically, a Nudged Elastic Band (NEB) method was used for the calculation to obtain the energy barrier between sites where lithium was assumed to move.

As illustrated in FIG. 46D, the structure of CoO does not have a space to which lithium enters, and thus is assumed not to allow lithium movement.

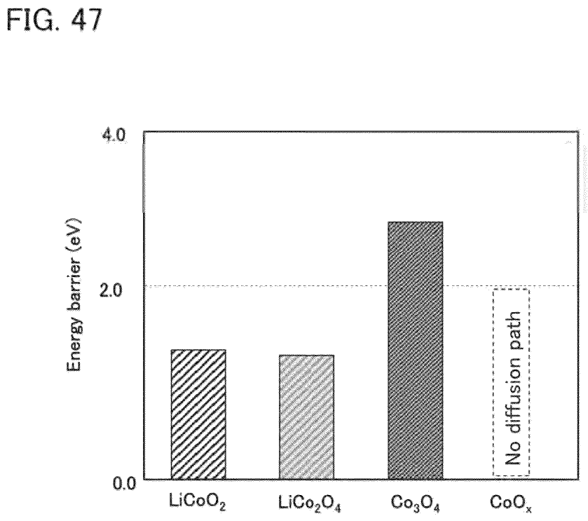

FIG. 47 shows the calculation results and the like obtained under the above conditions.

The y-axis in FIG. 47 represents the energy barrier (eV), and lithium is less likely to move, that is, the lithium diffusibility becomes lower as the energy barrier is larger. The diffusibility includes diffusion speed. FIG. 47 shows that LiCoO₂ and LiCo₂O₄ have substantially the same energy barrier. It is found that Co₃O₄ has a larger energy barrier than LiCoO₂ and LiCo₂O₄. This reveals that Co₃O₄ has lower lithium diffusibility than LiCoO₂ and LiCo₂O₄. The lithium diffusibility is different between LiCo₂O₄ and Co₃O₄, both of which have the spinel structure. Furthermore, CoO cannot ensure a diffusion path of lithium (denoted by “no diffusion path”), and thus is considered to have the lowest lithium diffusibility.

In addition, the lithium diffusion coefficient in each structure was calculated and the movement distance of lithium per hour was calculated. The obtained results are shown in the following table.

TABLE 6

| | | LiCo₂O₄ | Co₃O₄ | |
|---|---|---|---|---|
| | | (Spinel | (Spinel | |
| Crystal structure | LiCoO₂ | structure) | structure) | CoO |
| Li diffusion | 3.9 × 10⁻¹⁶ | 3.30 × 10⁻¹⁶ | 1.41 × 10⁻²⁴ | — |
| coefficient [m²/sec] | | | | |
| Movement distance | 1.98 | 1.82 | 1.19 × 10⁻⁴ | — |
| per hour [nm] | | | | |

It is found from Table 6 that LiCoO₂ and LiCo₂O₄ have substantially the same lithium diffusibility even when examined in view of the lithium diffusion coefficient. It is found that lithium hardly diffuses in Co₃O₄ as compared with that in LiCoO₂ and LiCo₂O₄. When lithium moves the same distance in each of Co₃O₄, LiCoO₂, and LiCo₂O₄, the time taken in Co₃O₄ is 10⁴ times longer than that taken in LiCoO₂. A difference in the lithium diffusion coefficient or the like between LiCo₂O₄ and Co₃O₄, both of which have the spinel structure, was observed. Note that since there is no diffusion path of lithium in CoO, Li diffusion is not considered to occur therein and hyphens are used in Table 6. Thus, it is considered that existence of CoO or Co₃O₄, an increase in the thickness of a region where CoO or Co₃O₄ exists, and the like makes lithium diffusion difficult and causes a degradation in the battery characteristics such as a discharge capacity retention rate.

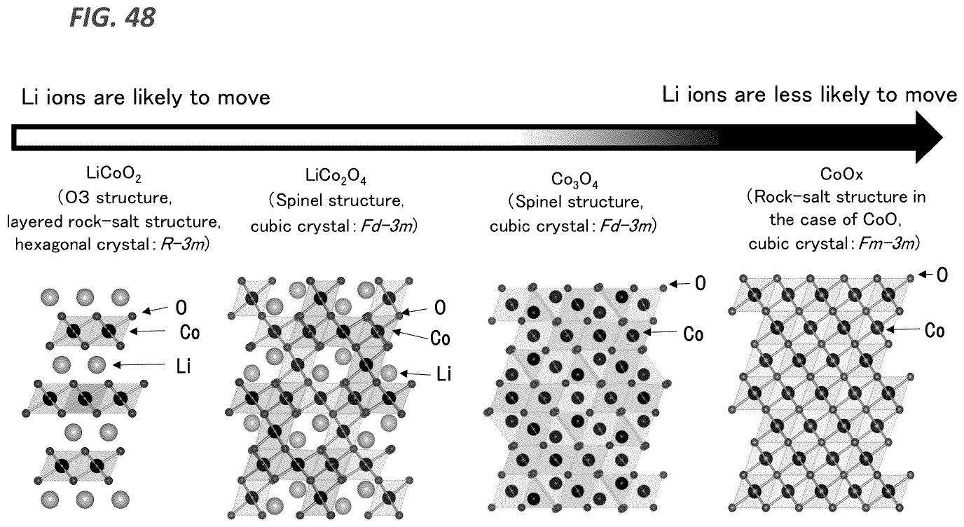

FIG. 48 shows the crystal structures illustrated in FIG. 46 in the order of ease of lithium ion movement, on the basis of the results in FIG. 47, the results in Table 6, and the like. The crystal structure where lithium ions move most easily is the O3 structure. In the O3 structure, lithium can be observed as a layer and lithium ions can move on a two-dimensional plane. The crystal structure where lithium ions move the second most easily is the spinel structure. Among the spinel structures, lithium ions move most easily in LiCo₂O₄, and the second most easily in Co₃O₄. In LiCo₂O₄, the movement path of lithium ions is more restricted than in the O3 structure. It is also found that the volume occupied by one lithium ion is smaller than that in the O3 structure. Furthermore, cobalt exists also in the tetrahedral site in Co₃O₄; thus, a region between the tetrahedral sites serves as a lithium ion path, but the path seems to be extremely small. The crystal structure that is the most difficult for lithium ions to move is CoO, and the crystal structure is the rock-salt structure. It is found that the rock-salt structure has no site for storing lithium ions and thus has no movement path of lithium ions.

As illustrated in FIG. 48, it is considered that the crystal structure of the lithium cobalt oxide changes after a cycle test and the change makes lithium ion movement in the crystal structure more difficult. Accordingly, the lithium ion path becomes narrow, which might cause deterioration of the lithium cobalt oxide after a cycle test.

Next, the electron resistivities in the structures are shown in the following Table.

TABLE 7

| | | LiCo₂O₄ | Co₃O₄ | |
|---|---|---|---|---|
| | | (Spinel | (Spinel | |
| Crystal structure | LiCoO₂ | structure) | structure) | CoO |
| Electron resistivity | 0.24 | — | 4.1 to 10.9 | up to |
| [Ω · cm] | | | | approximately |
| | | | | 1.0 × 10¹¹ |

Table 7 shows that the electron resistivities become higher in the order of the crystal structures illustrated in FIG. 48.

As described above, the crystal structure of lithium cobalt oxide changes after a cycle test into a crystal structure with a state where no lithium exists. Accordingly, the electron resistivity of the lithium cobalt oxide increases. These can be regarded as factors of deterioration of the lithium cobalt oxide after a cycle test.

### Example 4

In this example, a positive electrode active material was fabricated according to FIG. 9, FIG. 10, and the like described in the above embodiment, and coin cells each using the fabricated positive electrode active material were fabricated and evaluated.

### <Fabrication of Positive Electrode>

### <Step S14>

As LiMO₂ in Step S14 in FIG. 10, with the use of cobalt as the transition metal M, commercially available lithium cobalt oxide (Cellseed C-10N produced by NIPPON CHEMICAL INDUSTRIAL CO., LTD.) not containing any additive element was prepared.

### <Step S15>

After Step S14, heating was performed according to Step S15 shown in FIG. 9 or the like. The heating conditions were 850° C. and 2 hours, and oxygen in the furnace was purged.

### <Step S20a>

According to Step S20a in FIG. 10, lithium fluoride and magnesium fluoride were prepared as the X1 source, and the lithium fluoride and the magnesium fluoride were mixed by a wet process. The lithium fluoride and the magnesium fluoride were weighed such that the molar ratio of the lithium fluoride to the magnesium fluoride was M_{LiF}:M_{MgF}=1:3. MgF₂ and LiF were mixed in dehydrated acetone at a rotating speed of 400 rpm for 12 hours, so that the X1 source was obtained.

### <Step S31 and Step S32>

According to Step S31 in FIG. 10, 1 mol % of the X1 source and lithium cobalt oxide were mixed. Specifically, the mixing was performed by a dry process at a rotating speed of 150 rpm for one hour, so that the mixture 903 shown in Step 32 was obtained.

### <Step S33 to Step S34a>

Heating was performed according to Step S33 in FIG. 10. In a square-shaped alumina container, the mixture 903 was placed, a lid was put on the container, and heating was performed in a muffle furnace. The atmosphere in the furnace was purged and an oxygen gas was introduced; the flow was not performed during the heating. The heating temperature was 900° C. and the heating time was 20 hours. In this manner, the composite oxide shown in Step S34a was obtained. The composite oxide is lithium cobalt oxide containing the X1 source.

### <Step S40>

According to Step S40 in FIG. 10, the second additive element source (referred to as the X2 source) was prepared. Nickel hydroxide was prepared as the nickel source of the X2 source, and aluminum hydroxide was prepared as the aluminum source of the X2 source.

### <Step S51 and Step S52>

According to Step SM in FIG. 10, the composite oxide shown in Step S34a was mixed with a mixture of the aluminum hydroxide and the nickel hydroxide by a dry process at a rotating speed of 150 rpm for one hour, so that the mixture 904 in Step S52 was obtained. Note that the aluminum hydroxide and the nickel hydroxide were each added at 0.5 mol % in Step SM.

### <Step S53>

Heating was performed according to Step S53 in FIG. 10. In a square-shaped alumina container, the mixture 903 was placed, a lid was put on the container, and heating was performed in a muffle furnace. The atmosphere in the furnace was purged and an oxygen gas was introduced; the flow was not performed during the heating. The heating temperature was 850° C. and the heating time was 10 hours.

### <Step S54>

In such a manner, the positive electrode active material 100 of Step S54 in FIG. 10 was obtained. The positive electrode active material 100 is lithium cobalt oxide containing the X1 source and the X2 source. Specifically, the positive electrode active material 100 is lithium cobalt oxide containing at least magnesium, aluminum, fluorine, and nickel.

### <Fabrication of Positive Electrode>

Next, a positive electrode was fabricated using the positive electrode active material 100 fabricated in the above manner.

The positive electrode active material fabricated in the above manner, acetylene black (AB) as a conductive material, and PVDF as a binder were mixed at a weight ratio of 95:3:2 using NMP as a solvent, whereby slurry was fabricated. After the fabricated slurry was applied to only one surface of the current collector, the solvent was vaporized. Aluminum foil having a thickness of 20 μm was used as the current collector.

### <Pressing Conditions>

Next, pressing was performed at 210 kN/m and 120° C., and then pressing was performed at 1467 kN/m and 120° C. The loading amount and the density of the positive electrode active material layer were approximately 7.0 mg/cm 2 and 3.7 g/cc, respectively.

Through the above steps, the positive electrode was fabricated.

### <Coin Cell>

Next, using the fabricated positive electrode, CR2032 type coin cells (with a diameter of 20 mm and a height of 3.2 mm) were fabricated.

A lithium metal was used for a counter electrode of the coin cell (referred to as lithium electrode). The electrode is referred to as a lithium electrode.

As a lithium salt contained in an electrolyte solution of the coin cell, 1 mol/L of lithium hexafluorophosphate (LiPF₆) was used. As a solvent contained in the electrolyte solution, a solution in which ethylene carbonate (EC) and diethyl carbonate (DEC) at EC:DEC=3:7 (volume ratio) and vinylene carbonate (VC) at 2 wt % are mixed was used.

A polypropylene separator was used for the coin cell.

Two coin cells were prepared as Samples A and B.

### <Cycle Test>

A cycle test (half-cell test) was performed on Samples A and B to perform evaluation.

### <Test Conditions>

Sample A was placed at a temperature of 25° C. As charging, constant current charging was performed at 0.5 C until the voltage reached 4.6 V or 4.7 V, and then constant voltage charging was performed until the current value reached 0.05 C. The voltage of 4.6 V or 4.7 V is referred to as an upper limit voltage. As discharging, constant current discharging was performed at 0.5 C until the voltage reached 2.5 V. The voltage of 2.5 V is referred to as a lower limit voltage. In this cycle test, 1 C was set to 200 mA/g. A break period longer than or equal to 5 minutes and shorter than or equal to 15 minutes may be provided between charging and discharging, and a break period of 10 minutes was provided in this cycle test. In the above manner, charging and discharging were repeated 50 times.

In a laminated cell (also referred to as full cell), graphite was used instead of lithium for the electrode. The upper limit voltage of the coin cell (also referred to as half cell) is smaller than that of the full cell by approximately 0.1 V. The conditions in this cycle test correspond to charging to 4.5 V or 4.6 V in the full cell.

The only difference from the conditions for Sample A is that Sample B was placed at a temperature of 45° C.

### <Test Results>

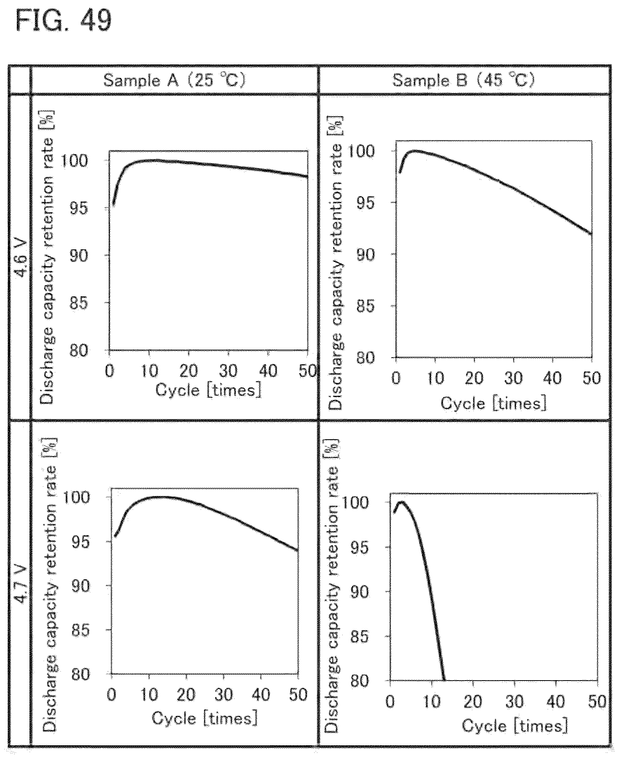

FIG. 49 shows the discharge capacity retention rates, which are a kind of the cycle test results. The upper left graph of FIG. 49 shows the cycle test results of Sample A (25° C.) at 4.6 V, the upper right graph of FIG. 49 shows the cycle test results of Sample B (45° C.) at 4.6 V, the lower left graph of FIG. 49 shows the cycle test results of Sample A (25° C.) at 4.7 V, and the lower right graph of FIG. 49 shows the cycle test results of Sample B (45° C.) at 4.7 V.

As the cycle test results, the maximum discharge capacity values are shown in the following table.

TABLE 8
Maximum discharge capacity value (mAh/g)

| | |
|---|---|
| Sample A (25° C.) | Sample B (45° C.) |

| 4.6 V | 4.7 V | 4.6 V | 4.7 V |
|---|---|---|---|
| 215.0 | 223.0 | 224.4 | 229.9 |

As the cycle test results, the discharge capacity retention rates after 50 cycles are shown in the following table.

TABLE 9
Discharge capacity retention rate after 50 cycles (%)

| | |
|---|---|
| Sample A (25° C.) | Sample B (45° C.) |

| 4.6 V | 4.7 V | 4.6 V | 4.7 V |
|---|---|---|---|
| 98.2 | 93.9 | 91.9 | 43.0 |

FIG. 49 and Table 9 show that Sample B has a lower discharge capacity retention rate than Sample A. It is also found that Sample A has a discharge capacity retention rate higher than or equal to 93% and lower than or equal to 99%.

Table 8 does not show a big difference in the maximum discharge capacity value.

### <SEM Observation>

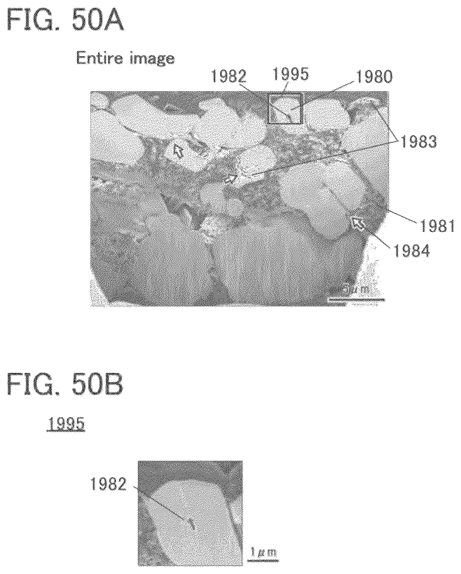

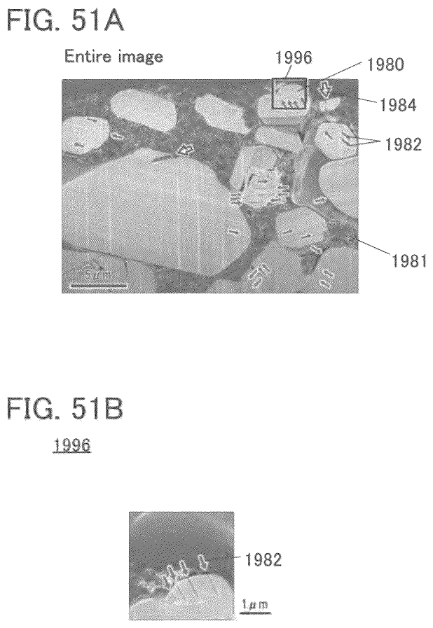

Samples A and B after the cycle test in which charging and discharging were repeated 50 cycles at a voltage of 4.7 V were disassembled, and observation images were obtained by SEM observation. FIG. 50 shows the cross-sectional SEM images of Sample A after the cycle test, and FIG. 51 shows the cross-sectional images of Sample B after the cycle test. In the case of cross-sectional observation, cross-sections were exposed by processing with FIB for observation. The FIB processing and the SEM observation were performed using XVision manufactured by Hitachi High-Tech Corporation, and an accelerating voltage in the SEM observation was 2.0 kV. Specifically, each image is one of a plurality of images obtained by a Slice and View method, in which cross-sectional processing by FIB and SEM observation are repeated.

FIG. 50A is the entire image and FIG. 50B is an enlarged image of the region 1995 denoted by a square. FIG. 51A is the entire image and FIG. 51B is an enlarged image of the region 1996 denoted by a square. In the entire images in FIG. 50A and FIG. 51A, the positive electrode active material 1980 and the acetylene black (AB) 1981 can be observed.

The dashed line 1983 shown in FIG. 50A indicates a portion of a slip. The arrow 1982 shown in each of FIG. 50A, FIG. 50B, FIG. 51A, and FIG. 51B indicates a portion of a pit. Although only some arrows are denoted by reference numerals in the figures, the same kind of arrows indicate portions of pits. A white solid arrow 1984 shown in each of FIG. 50A, FIG. 50B, FIG. 51A, and FIG. 51B indicates a portion of a crack. Although only some arrows are denoted by reference numerals in the figures, the same kind of arrows indicate portions of cracks.

Comparison between the SEM images in FIG. 50 and FIG. 51 reveals that more pits are formed in Sample B than in Sample A. Since the number of generated pits differs depending on a difference in the cycle conditions, such as whether the temperature is low (25° C.) or high (45° C.), the pits are probably generated depending on the measurement temperature.

### <EDX Analysis>

Next, EDX mapping analysis and EDX line analysis were performed on Samples A and B. In each analysis, cobalt as a main component of the surface portion and magnesium and aluminum as additive elements were focused.

First, Samples A and B were observed with a HAADF (High-Angle Annular Dark Field)-STEM (Scanning Transmission Electron Microscope). Hereinafter, an image obtained with a HAADF-STEM is also referred to as a STEM image.

In this example, the STEM images were obtained using an atomic resolution analytical electron microscope JEM-ARM200F manufactured by JEOL Ltd. under the following conditions: the acceleration voltage was 200 kV; and irradiation with an electron beam with a diameter of approximately 0.1 nmϕ was performed.

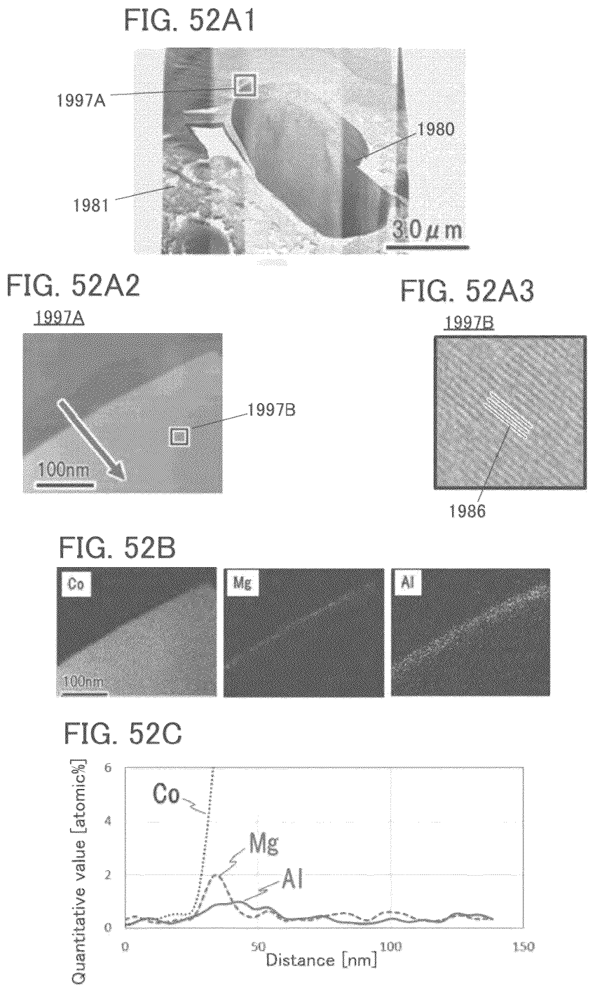

FIG. 52A1 is a cross-sectional STEM image. In FIG. 52A1, the positive electrode active material 1980 and the AB 1981 can be observed. FIG. 52A2 is an enlarged image of a region 1997A denoted by a square in FIG. 52A1. The EDX line analysis was performed in the arrow direction shown in FIG. 52A2. FIG. 52A3 is an enlarged image of a region 1997B denoted by a square in FIG. 52A2. In FIG. 52A3, lattice fringes 1986 can be observed.

FIG. 52B shows the EDX mapping analysis results corresponding to the image in FIG. 52A2. In Sample A, existence of magnesium and aluminum can be observed in the surface portion of the positive electrode active material, i.e., the lithium cobalt oxide, and it can be found that the magnesium and the aluminum are unevenly distributed in the surface portion.

FIG. 52C shows the results of the EDX line analysis in the arrow direction shown in FIG. 52A2. The quantitative values of magnesium and aluminum can be seen from FIG. 52C. In FIG. 52C, a magnesium peak is observed in the surface portion of the lithium cobalt oxide, and the magnesium peak top is observed within the range of higher than or equal to 1.9 atom % and lower than or equal to 2.1 atom %. The aluminum peak is observed in the surface portion of the lithium cobalt oxide, and the aluminum peak top is observed within the range of higher than or equal to 0.9 atom % and lower than or equal to 1.1 atom %. It can be seen from FIG. 52C that the magnesium peak top is positioned closer to the surface of the lithium cobalt oxide than the aluminum peak top.

The barrier layer containing magnesium and aluminum probably exists in Sample A even after a cycle test. Thus, as shown in FIG. 49 or the like, the discharge capacity retention rate is probably higher than that in Sample B.

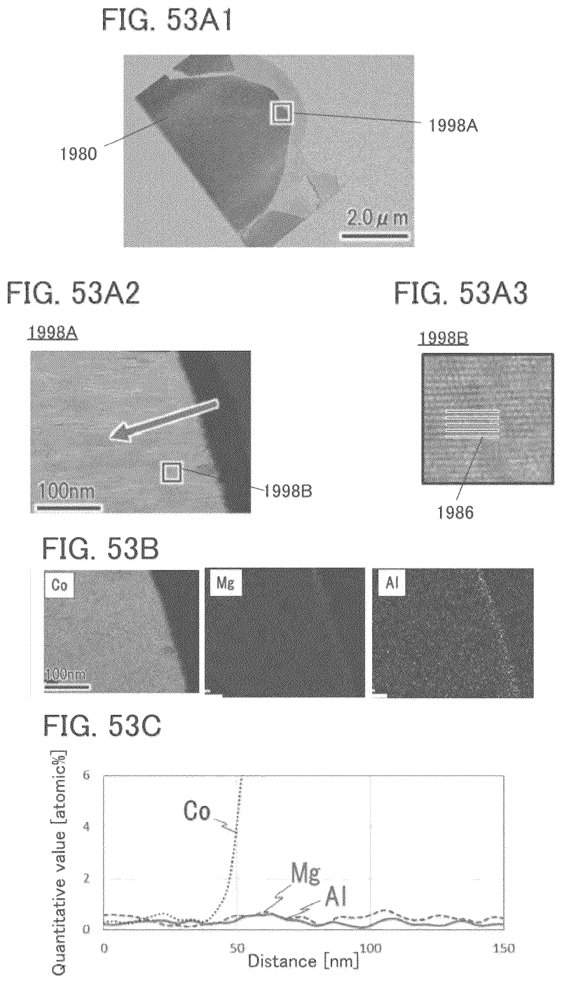

FIG. 53A1 to FIG. 53C show the results of Sample B. FIG. 53A1 is a cross-sectional STEM image. In FIG. 53A1, the positive electrode active material 1980 can be observed. FIG. 53A2 is an enlarged image of a region 1998A denoted by a square in FIG. 53A1. The EDX line analysis was performed in the arrow direction shown in FIG. 53A2. FIG. 53A3 is an enlarged image of a region 1998B denoted by a square in FIG. 53A2. The lattice fringes 1986 can be observed in FIG. 53A3.

FIG. 53B shows the EDX mapping analysis results corresponding to the image in FIG. 53A2. It was found that Sample B contains a small amount of magnesium and aluminum in the surface portion of the positive electrode active material, i.e., the lithium cobalt oxide, and magnesium and aluminum hardly exist in Sample B as compared with those in Sample A. It can also be found that magnesium and aluminum are not distributed unevenly in Sample B.

FIG. 53C shows the results of the EDX line analysis in the arrow direction shown in FIG. 53A2. The quantitative values of magnesium and aluminum can be seen from FIG. 53C. FIG. 53C shows that the peaks of magnesium and aluminum are small and almost no magnesium and aluminum exist in the surface portion of the lithium cobalt oxide.

It is considered that there is no barrier layer in Sample B after a cycle test. Thus, as shown in FIG. 49 or the like, the discharge capacity retention rate is probably lower than that in Sample A.

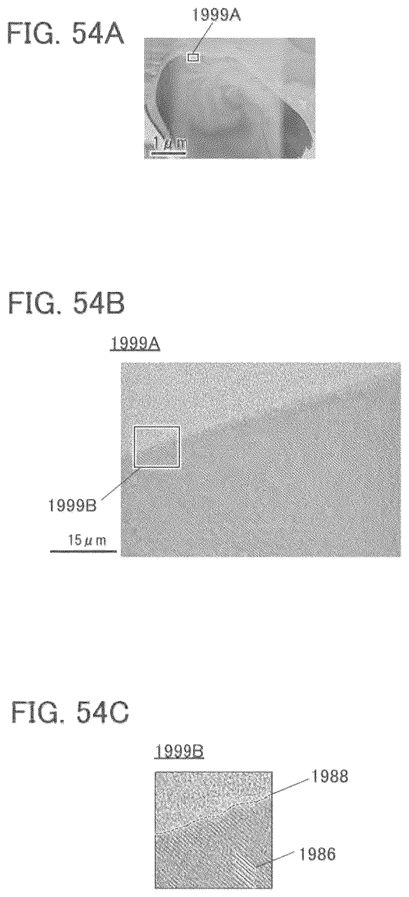

Next, the structures of the surface portions of Samples A and B were examined. The cross-sectional STEM image of Sample A is shown again in FIG. 54A. FIG. 54B is an enlarged image of a region 1999A denoted by a square in FIG. 54A. FIG. 54C is an enlarged image of a region 1999B denoted by a square in FIG. 54B. In FIG. 54C, an auxiliary line 1988 is added to the surface of the lithium cobalt oxide. In Sample A, the lattice fringes 1986 can be clearly observed even in the surface portion.

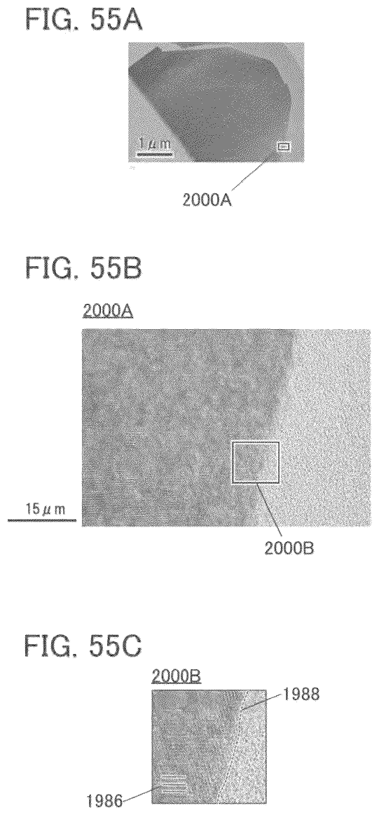

The cross-sectional STEM image of Sample B is shown in FIG. 55A again. FIG. 55B is an enlarged image of a region 2000A denoted by a square in FIG. 55A. FIG. 55C is an enlarged image of a region 2000B denoted by a square in FIG. 55B. In FIG. 55C, the auxiliary line 1988 is added to the surface of the lithium cobalt oxide. In Sample B, the lattice fringes 1986 can be observed in the inner portion, but the lattice fringes in the surface portion were unclear. In particular, the lattice fringes were unclear in the vicinity of the auxiliary line 1988 corresponding to the outermost surface.

The present inventors considered that the difference in how the lattice fringes in a crystal were seen was due to the difference in the crystal structure. In view of this, the crystal structure of the surface portion after a cycle test was examined.

### <Nanobeam Electron Diffraction>

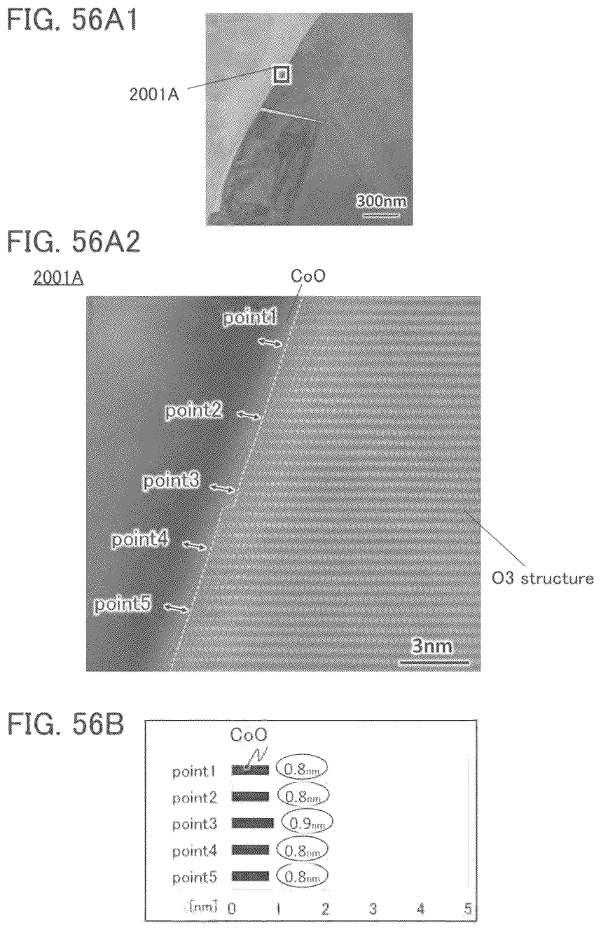

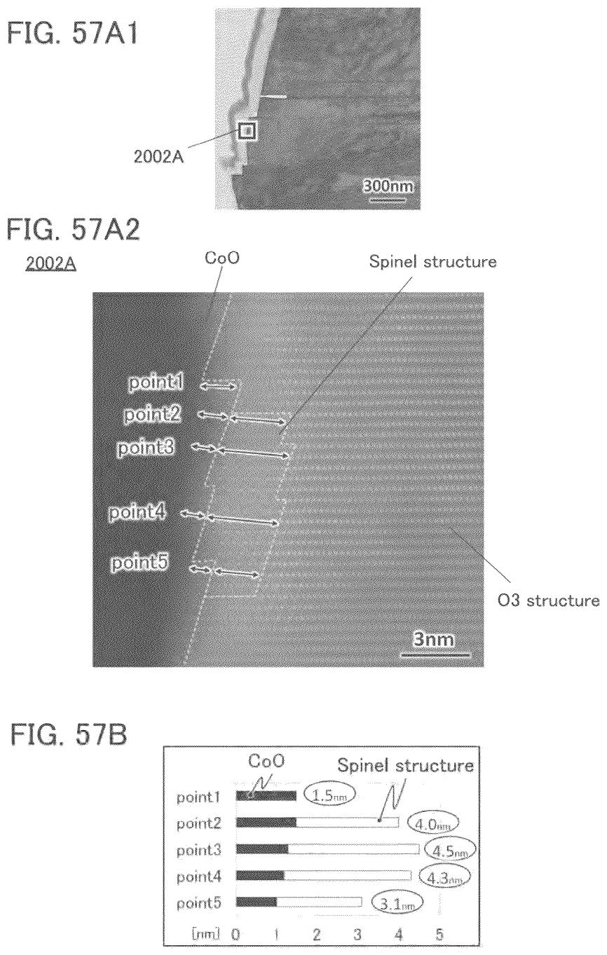

STEM images of Samples A and B were obtained again. FIG. 56A1 and FIG. 56A2 are the STEM images of Sample A, and FIG. 57A1 and FIG. 57B are the STEM images of Sample B. Furthermore, nanobeam electron diffraction (NBED) was performed on each of Samples A and B to determine the crystal structures, and the length of a region where the crystal structure exist was measured and quantified.

FIG. 56A1 is a cross-sectional STEM image of Sample A. FIG. 56A2 is an enlarged image of a region 2001A denoted by a square in FIG. 56A1. FIG. 56B shows the results of measuring the range of regions in points 1 to 5 shown in FIG. 56A2, where CoO exists. FIG. 56A1 to FIG. 56B show that the inner portion of Sample A has the O3 structure and CoO exists in the surface portion within a range from the surface to a depth of greater than or equal to 0.8 nm and less than or equal to 0.9 nm. Note that CoO has a rock-salt structure. In addition, the spinel structure was not observed in Sample A. Since a barrier layer containing magnesium or aluminum exists even after a cycle test, it is considered that formation of CoO, that is, formation of a block layer is inhibited, and Sample A has favorable discharge capacity retention rate shown in FIG. 49 or the like.

FIG. 57A1 is a cross-sectional STEM image of Sample B. FIG. 57A2 is an enlarged image of a region 2002A denoted by a square in FIG. 57A1. FIG. 57B shows the results of measuring the range of regions in the points 1 to 5 shown in FIG. 57A2, where CoO or the spinel structure exists. FIG. 57A1 to FIG. 57B show that the inner portion of Sample B has the O3 structure, and CoO and the spinel structure (LiCo₂O₄ and Co₃O₄) exist in the surface portion within a range from the surface to a depth of greater than or equal to 1.5 nm and less than or equal to 4.5 nm. CoO was positioned closer to the surface than the spinel structure. At the points 2 to 5, CoO existed within a narrower range than the spinel structure. Note that CoO has a rock-salt structure and thus is considered to have no diffusion path of lithium.

When CoO is compared between Samples A and B, CoO exists in a wider range in Sample B in the depth direction. The depth direction is the depth direction in a cross section of the sample.

It is found from the above that, after a cycle test at a high temperature such as 45° C., the crystal structure of the surface portion changes and at least the spinel structure begins to appear. It is also found that the region where CoO exists becomes wider after the cycle test at high temperature. As described in the above example, the spinel structure and CoO have low lithium diffusibility. Since the crystal structure with low lithium diffusibility is widely formed in the surface portion, the discharge capacity retention rate after a cycle test, especially at high temperature, is considered to become low.

### Example 5

Next, a change in the crystal structure of the surface portion before and after a cycle test was examined. For another sample, a positive electrode active material was fabricated under the same conditions as Example 2 described above.

### <Coin Cell>

A coin cell was fabricated using the positive electrode active material under the same conditions as Sample A or the like to obtain Sample C.

### <Cycle Test>

Sample C was subjected to a cycle test (half-cell test) and evaluated.

### <Test Conditions>

The test conditions for Sample C were the same as those for Sample A. That is, the measurement temperature is 25° C.

### <STEM Observation>

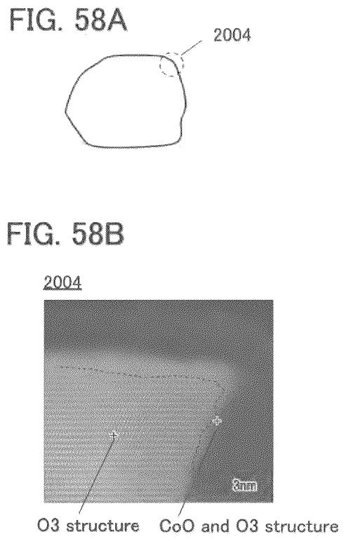

HAADF-STEM observation was performed before and after the cycle test. FIG. 58A is a schematic view of the positive electrode active material before the cycle test, in which a region 2004 including the surface portion is indicated. FIG. 58B is a STEM image that can correspond to the region 2004 including the surface portion before the cycle test.

The region 2004 including the surface portion before the cycle test shown in FIG. 58B is found to include the O3 structure inside and include CoO and the O3 structure in the surface portion. CoO has no diffusion path of lithium ions and sometimes has a blocking function that inhibits passage of lithium ions.

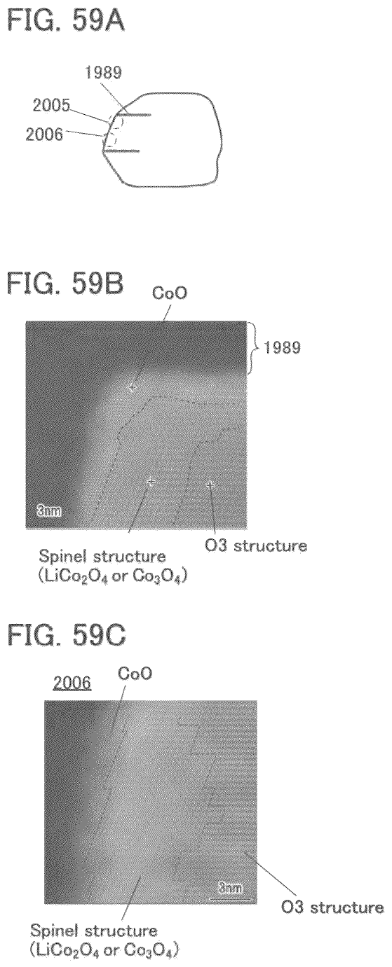

FIG. 59A is a schematic view of the positive electrode active material after the cycle test, in which a pit 1989, a region 2005 in the vicinity of a bit, and a region 2006 including a surface portion between pits are indicated. FIG. 59B is a STEM image that can correspond to the region 2005 in the vicinity of a pit after the cycle test, and FIG. 59C is a STEM image that can correspond to the region 2006 including a surface portion between pits.

The pit 1989 was formed after the cycle test, and CoO, the spinel structure, and the O3 structure were found to exist in both the region 2005 in the vicinity of a pit shown in FIG. 59B and the region 2006 including a surface portion between pits shown in FIG. 59B after the cycle test. In addition, CoO was positioned in the outermost surface, the O3 structure was positioned in the inner portion, and the spinel structure was positioned between CoO and the O3 structure.

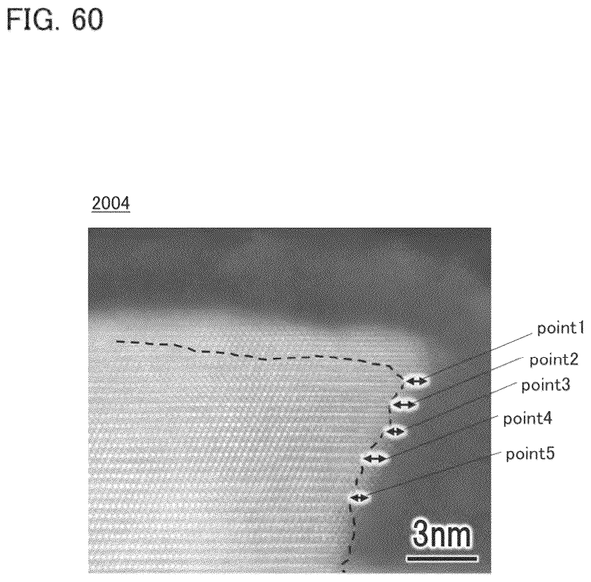

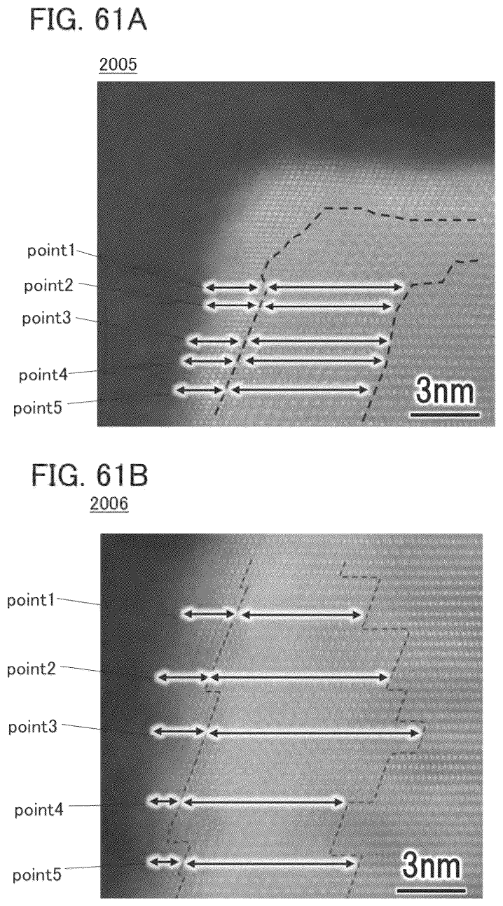

The length of each region was measured and quantified. In FIG. 60, the measured portions of the region 2004 shown in FIG. 58B are denoted by the points 1 to 5. In FIG. 61A, the measured portions of the region 2005 shown in FIG. 59B are denoted by the points 1 to 5. In FIG. 61B, the measured portions of the region 2006 shown in FIG. 59C are denoted by the points 1 to 5.

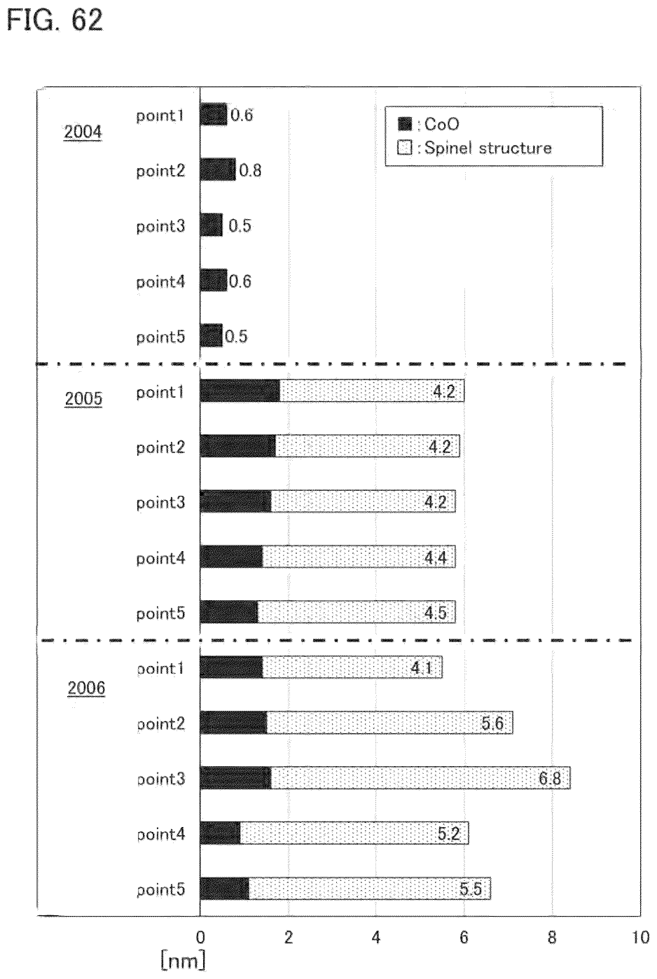

FIG. 62 shows the length measurement results of the region 2004 to the region 2006. The numeral values of the length measurement results are also shown with a unit of nm.

It is found from comparison between before and after the cycle test of Sample C that a region where CoO exists is narrower in the region 2004 before the cycle test shown in FIG. 58A than in the region 2005 and the region 2006 after the cycle test shown in FIG. 59B and FIG. 59C. It is found from comparison between the results after the cycle test that a region where CoO exists is wider in the region 2005 that is the surface portion in the vicinity of a pit after the cycle test shown in FIG. 59B than in the region 2006 that is the surface portion between pits shown in FIG. 59C. It is found that the spinel structure exists in a wider range in the region 2005 that is the surface portion between pits after the cycle test shown in FIG. 59C than in the region 2006 that is the surface portion at the tip of the pit after the cycle test shown in FIG. 59B.

### Example 6

In this example, the pit size and the like of Samples A and B after a cycle test in which charging and discharging at a voltage of 4.7 V were repeated 50 cycles were examined.

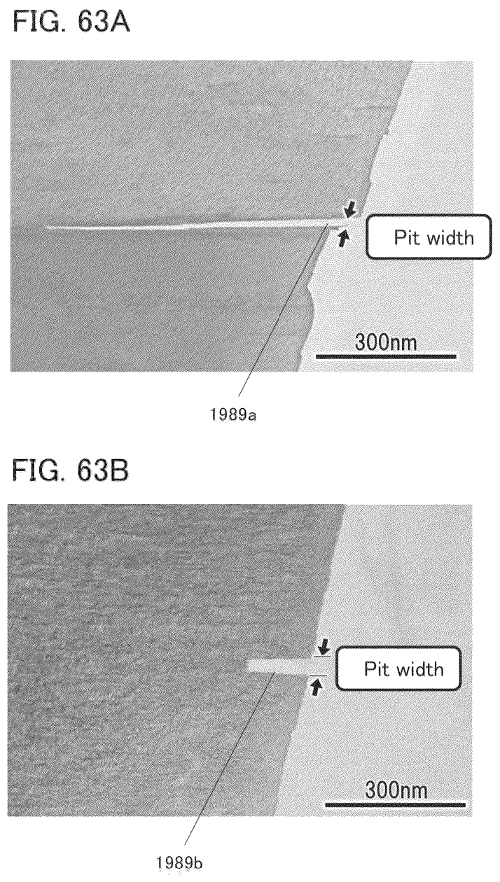

FIG. 63A is an enlarged image of a pit 1989a in Sample A after the cycle test. FIG. 63B is an enlarged image of a pit 1989b in Sample B after the cycle test. It is found that the pits 1989a and 1989b progress into the inner portions in Samples A and B.

Furthermore, when the pit width of Sample A is assumed to be a width between arrows shown in FIG. 63A, the width is approximately 15 nm, and when the pit width of Sample B is assumed to be a width between arrows shown in FIG. 63B, the width is approximately 35 nm. It is confirmed that the pit width of Sample B is larger than the pit width of Sample A. That is, Sample B subjected to the cycle test at high temperature is found to have a large pit width. The pit depth of Sample A is approximately 700 nm, and the pit depth of Sample B is approximately 150 nm. The tip of a pit that determines the pit depth can be regarded as the surface of the positive electrode active material. The end of the pit that determines the pit depth can be found by contrast in the images shown in FIG. 63A and FIG. 63B. The lithium cobalt oxide is indicated by darkness and the pit is indicated by brightness; thus, the end of a bright image corresponds to the end of the bit.

The present inventors have considered that a pit begins to be formed in lithium cobalt oxide from the surface portion of the lithium cobalt oxide and progresses due to repetition of oxygen release (also referred to as oxygen desorption) and cobalt diffusion. The present inventors have considered that oxygen is probably desorbed from the lithium cobalt oxide due to a reaction with an electrolyte solution, for example, and cobalt cut from the Co—O bond might diffuse. The reaction with the electrolyte solution is deemed to progress faster at higher temperature, which probably contributes to making the pit width of Sample B larger than the pit width of Sample A.

The crystal structure of the surface portion when oxygen desorption and cobalt diffusion further progress is considered to change from the O3 structure to CoO.

### Example 7

This example examined what is happened in an atomic level at the initial stage of pit generation.

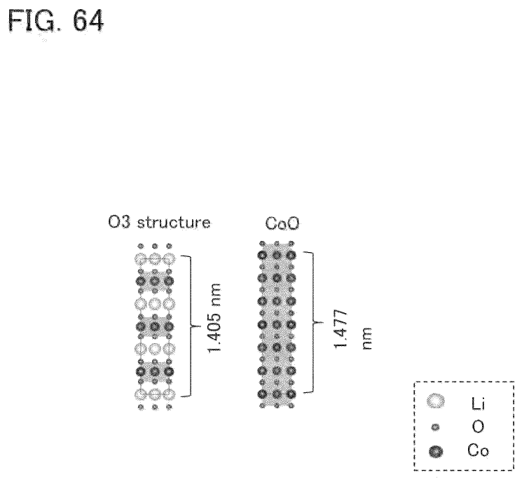

Sample C before a cycle test, which is examined in the above example, has the O3 structure in its inner portion and includes CoO in its surface portion, and thus includes a region where the O3 structure and the CoO are in contact with each other. CoO corresponds to CoOx where x=1. The crystal orientation in the (110) plane of LCO and that in the (110) plane of CoO are aligned with each other. When a set plane having equivalent symmetry is represented by { }, crystal orientations in {110} of LCO and {110} of CoO can be regarded as being aligned with each other. As shown in FIG. 64, the interplanar spacing of {001} perpendicular to {110} of the O3 structure is 1.405 nm, and a value six times the interplanar spacing {1-11} that is a plane perpendicular to {110} of CoO is 1.477 nm; thus, there is 5.1% of deviation between the interplanar spacings. Due to the deviation, stress is probably applied on the surface portion of LCO since before the cycle test.

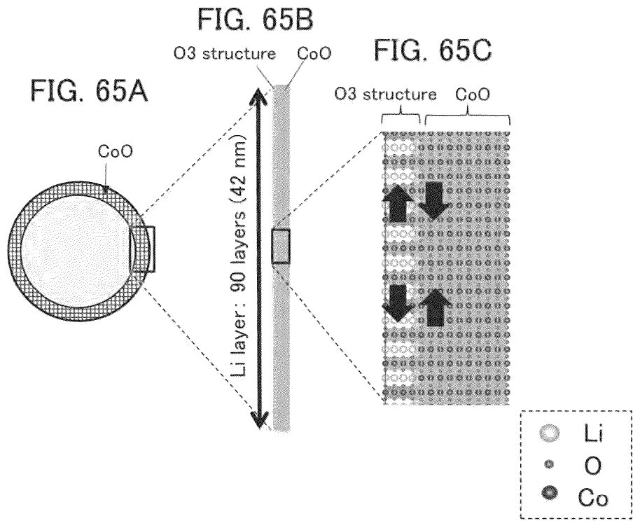

Thus, calculation was performed to examine whether the deviation can cause structure distortion in the O3 structure and CoO. As shown in FIG. 65A, lithium cobalt oxide in which CoO is positioned in the surface portion and the O3 structure is included in the inner portion is considered. FIG. 65B is an enlarged view of a region denoted by a square in FIG. 65A, and FIG. 65C is a diagram in which a region denoted by a square in FIG. 65B is enlarged to an atomic level. As shown in FIG. 65B, classical molecular dynamic simulation was performed using a model in which 90 lithium layers (a distance denoted by an arrow is 42 nm) are included and CoO is in contact with the (110) plane of the O3 structure.

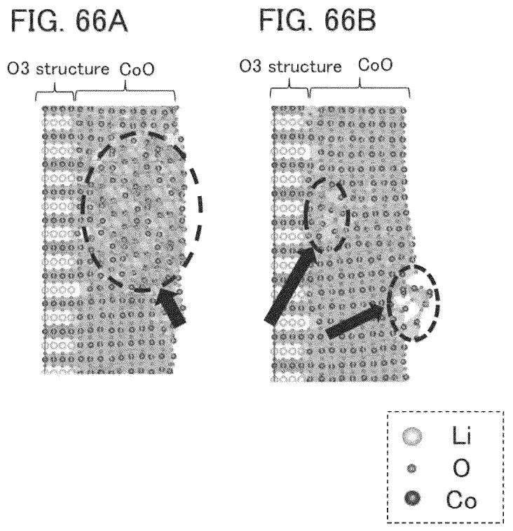

FIG. 66A and FIG. 66B show the simulation results. The results show that a shift in atomic arrangement is caused in regions denoted by arrows, i.e., part of CoO in FIG. 66A and FIG. 66B, because the structure cannot withstand the distortion. The shift in atomic arrangement is caused not only in the vicinity of the interface between the O3 structure and CoO but also in a surface of CoO as shown in FIG. 66B. The shift in atomic arrangement corresponds to the crystal distortion. Since an unstable cobalt atom or oxygen atom exists in the surface, the atom is likely to be desorbed. The present inventors have considered that the shift in atomic arrangement, i.e., crystal distortion caused in the surface of CoO shown in FIG. 66B becomes a starting point of a pit.

It is also considered that a pit is generated in the following manner: a stress difference generated between CoO and the O3 structure tears the surface, the teared portion becomes a starting point of a pit, and then CoO and the O3 structure are eroded from the starting point.

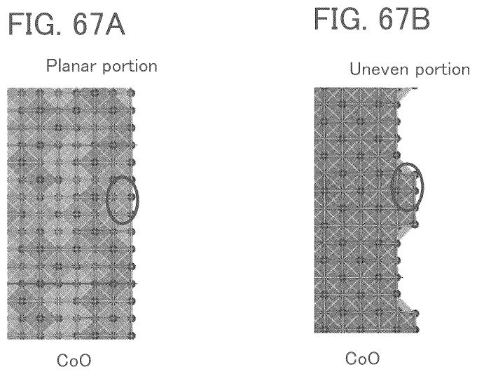

Next, focusing on CoO, a model of CoO whose surface includes a planar portion without distortion, which is illustrated in FIG. 67A, and a model of CoO whose surface is provided with an uneven portion that can reflect distortion, which is illustrated in FIG. 67B, were examined. The CoO provided with the uneven portion can be regarded as CoO including a projecting portion in FIG. 67B. Ease of desorption of cobalt atoms in the CoO including the planar portion in FIG. 67A and the CoO including the projecting portion in FIG. 67B was calculated. The region denoted by a circle and an arrow indicates a position of a desorbed cobalt atom.

The calculation results show that the cobalt atom is more likely to be desorbed when unevenness is included as illustrated in FIG. 67B. Specifically, the desorption energy of the cobalt atom is lower in the cobalt atom in the uneven portion in FIG. 67B than in the cobalt atom in the planar portion of FIG. 67A by 0.45 eV. Thus, it is considered that a cobalt atom or an oxygen atom is likely to be desorbed from CoO including the uneven portion that corresponds to the shift in atomic arrangement, which might result in pit formation.

Furthermore, exposing lithium cobalt oxide to a high temperature such as 45° C. seems to make going over the energy barrier needed for cutting Co—O (a bond between oxygen and cobalt) easy, so that the cobalt atom or the oxygen atom is likely to be desorbed.

### Example 8

In this example, a growth process of a pit, that is, how the pit grows was examined.

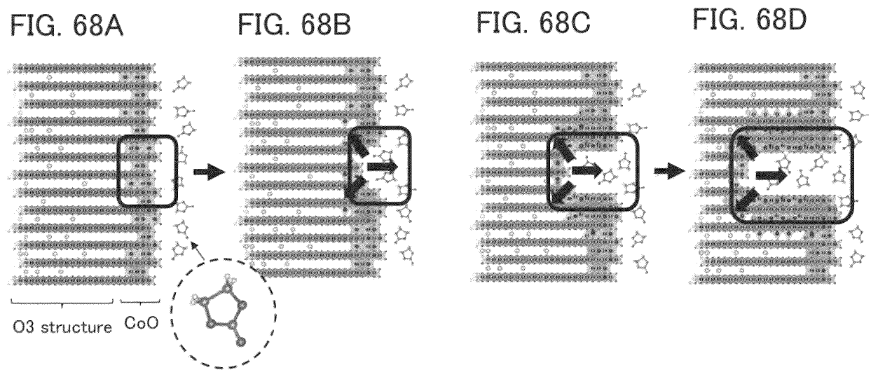

FIG. 68A illustrates lithium cobalt oxide that includes CoO provided with a distorted portion in the starting point of a pit, i.e., a surface portion, and has the O3 structure in the inner portion. Solvent molecules as organic electrolytes included in an electrolyte solution are illustrated in the vicinity of the lithium cobalt oxide. As illustrated in FIG. 68B, the solvent molecule exists in the vicinity of the CoO, and thus the CoO reacts with the solvent molecule first in the lithium cobalt oxide. This probably makes cobalt or oxygen in the CoO be released. The released cobalt or oxygen is released to the electrolyte solution, and sometimes diffuses into the lithium cobalt oxide. The release is promoted by the reaction between the CoO and the solvent molecule. Accordingly, a pit grows as illustrated in FIG. 68C. Next, as illustrated in FIG. 68D, the O3 structure positioned along the side surface of the pit changes to CoO or the spinel structure due to the diffused cobalt or the like. This probably increases the thickness of a region where the CoO or the spinel structure exists. The pit is considered to progress since cobalt moves along the side surface of the pit as illustrated in FIG. 68D. In addition, as described in the above example, the CoO and the spinel structure have lower lithium diffusibility than the O3 structure. It is thus deemed that the pit width is not increased and the width is constant. It is also considered that, as illustrated in FIG. 68D, the CoO or the spinel structure is formed along the side surface of the pit and the O3 structure changes to CoO or the spinel structure in accordance with the pit progress, which might make the pit width constant.

Therefore, formation of a Li block layer such as CoO or the spinel structure in the surface of the O3 structure, which inhibits Li diffusion, is considered to be the factor of a decrease in discharge capacity retention rate after a cycle test.

The Li block layer is extremely thin in the case where a barrier layer exists in the lithium cobalt oxide. However, the barrier layer seems to disappear after a cycle test, which probably results in a large thickness of the Li block layer and a decrease in discharge capacity retention rate.

The present inventors have considered that inhibition of Li diffusion into the inner portion due to the formation of the Li block layer in the surface portion of the positive electrode active material is one of factors of battery deterioration, which is different from a conventional main factor of battery deterioration. In addition, the present inventors have considered that the pit itself is not the main factor of deterioration.

### Example 9

In this example, check for splits was conducted on Samples A and B after a cycle test in which charging and discharging at a voltage of 4.7 V were repeated 50 cycles.

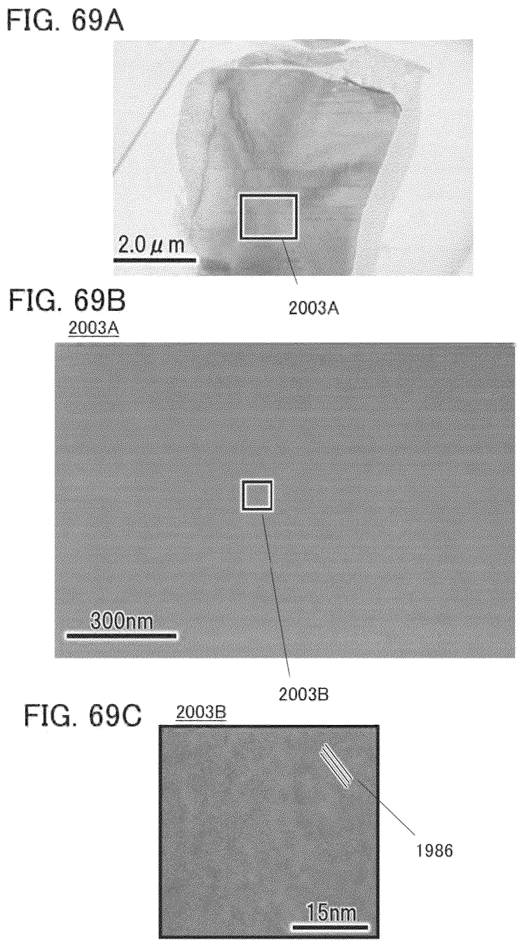

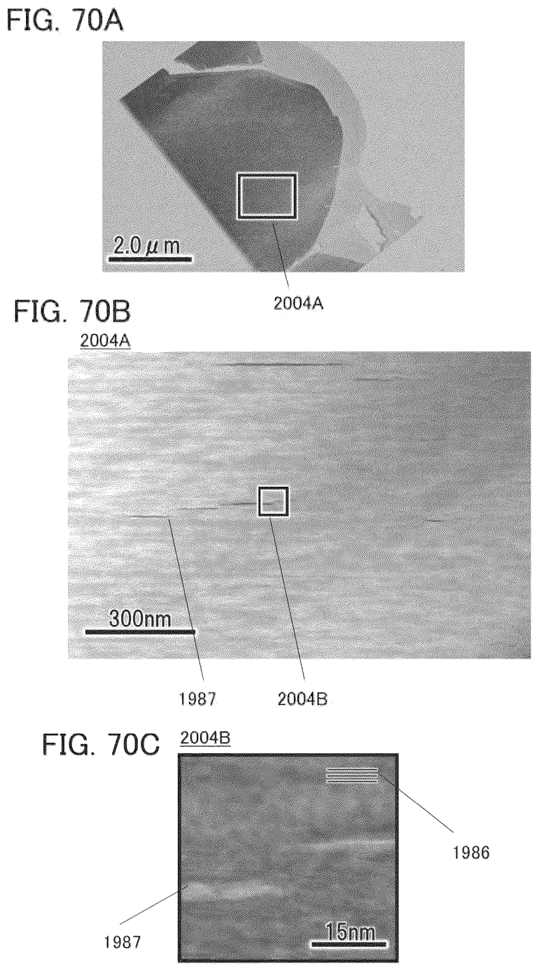

FIG. 69A to FIG. 69C are cross-sectional STEM images of Sample A, and FIG. 70A to FIG. 70C are cross-sectional STEM images of Sample B. Note that for obtaining the cross-sectional STEM images in this example, XVision210DB manufactured by Hitachi High-Tech Corporation was used and the accelerating voltage was 2.0 kV.

FIG. 69B is an enlarged image of a region 2003A denoted by a square in FIG. 69A. FIG. 69C is an enlarged image of a region 2003B denoted by a square in FIG. 69B. The lattice fringes 1986 can be observed in FIG. 69C. No obvious split was observed in Sample A. In Sample A, a barrier layer containing magnesium or aluminum exists even after the cycle test.

FIG. 70B is an enlarged image of a region 2004A denoted by a square in FIG. 70A. A split 1987 can be observed in FIG. 70B. FIG. 70C is an enlarged image of a region 2004B denoted by a square in FIG. 70B. The lattice fringes 1986 and the split 1987 can be observed in FIG. 70C. In Sample B, no barrier layer exists after the cycle test, and thus a split seems to be formed easily.

The crystal structure of Sample B where the split was observed was checked.

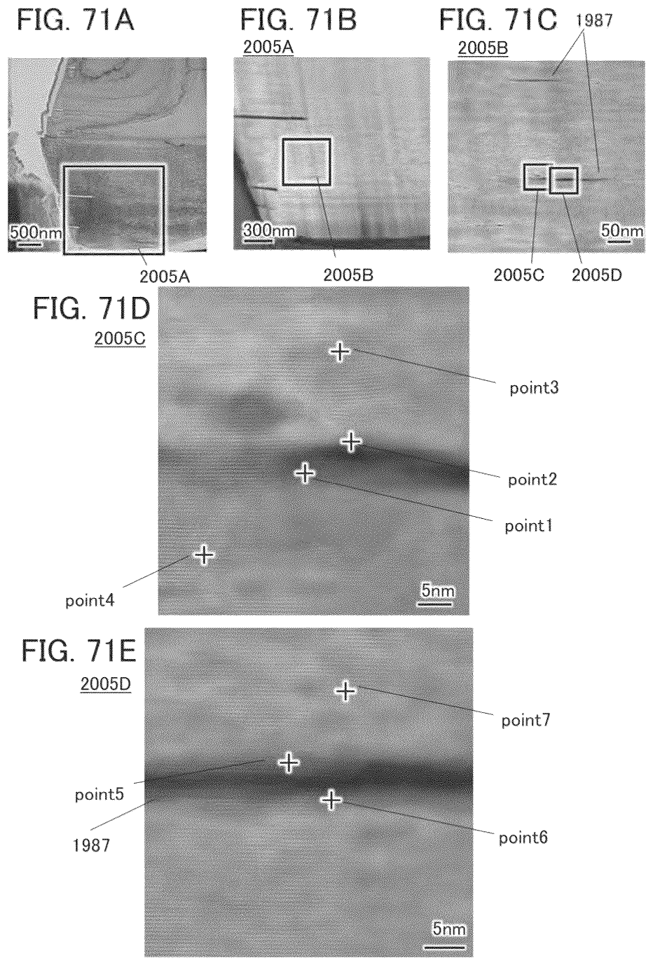

FIG. 71A is a cross-sectional STEM image of Sample B. FIG. 71B is an enlarged image of a region 2005A denoted by a square in FIG. 71A. FIG. 71C is an enlarged image of a region 2005B denoted by a square in FIG. 71B. The split 1987 can be observed in FIG. 71C. FIG. 71D and FIG. 71E are enlarged images respectively of a region 2005C and a region 2005D denoted by squares in FIG. 71C. The split 1987 can be observed in FIG. 71E.

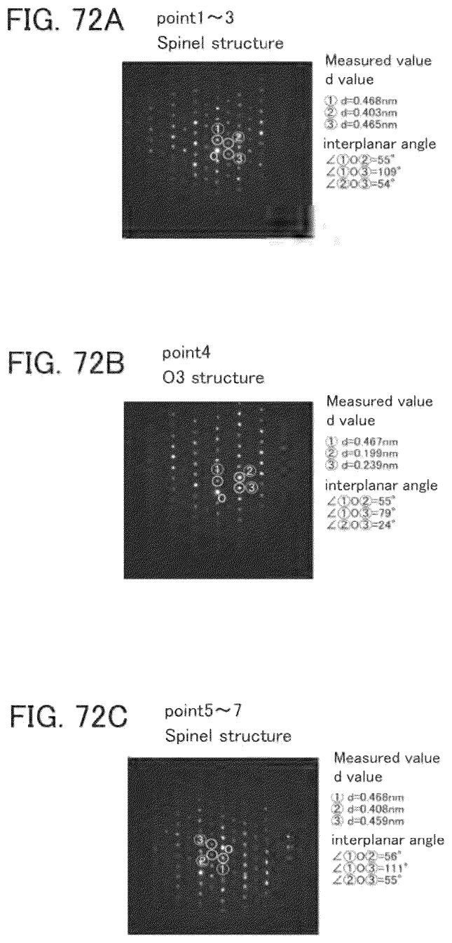

As shown in FIG. 72A and FIG. 72B, the crystal structures were determined using diffraction patterns obtained by nanobeam electron diffraction performed on the points 1 to 4 shown in FIG. 71D. The nanobeam electron diffraction was carried out with a transmission electron microscope (“HF-2000” manufactured by Hitachi High-Tech Corporation) at an acceleration voltage of 200 kV and a camera length of 0.8 m. The points 1 to 3 in FIG. 72A were found to have the spinel structure (LiCo₂O₄ or Co₃O₄). The point 4 in FIG. 72A was found to have the O3 structure (LiCoO₂).

As shown in FIG. 72C, the crystal structure was determined using diffraction patterns obtained by nanobeam electron diffraction performed on the points 5 to 7 shown in FIG. 71E. The nanobeam electron diffraction was performed under the conditions similar to those for the points 1 to 4. The points 5 to 7 in FIG. 72C were found to have the spinel structure (LiCo₂O₄ or Co₃O₄).

As described above, the inner portion of the lithium cobalt oxide where a split was generated was found to have the O3 structure. As shown in FIG. 72A to FIG. 72C, a region in the vicinity of the split 1987 was found to have the spinel structure (LiCo₂O₄ or Co₃O₄). It is considered that the spinel structure is less likely to allow entering and leaving of lithium ions than the O3 structure and has a function of blocking lithium ions; thus, the spinel structure in the region in the vicinity of the split 1987 is also considered to be a factor of deterioration.

### REFERENCE NUMERALS

50: inner portion, 50a: inner portion, 50b: inner portion, 52: crystal plane, 53a: barrier layer, 53c: barrier layer, 57: crack, 58a: pit, 58b: pit, 59a: vicinity, 59b: vicinity, 60: grain boundary, 61: split, 100: positive electrode active material

1. A positive electrode active material used for a secondary battery, the positive electrode active material comprising lithium cobalt oxide comprising an additive element,
wherein after a cycle test is performed on a cell using the positive electrode active material for a positive electrode and a lithium electrode as a counter electrode, the positive electrode active material comprises a defect, and comprises at least the additive element in a region in a vicinity of the defect.

2. The positive electrode active material according to claim 1,
wherein the region in the vicinity of the defect is a side surface of the defect.

3. The positive electrode active material according to claim 1,
wherein the region in the vicinity of the defect is a tip of the defect.

4. The positive electrode active material according to claim 1,
wherein the defect has a constant width.

5. The positive electrode active material according to claim 1,
wherein the defect is a pit.

6. The positive electrode active material according to claim 1,
wherein an upper limit voltage of the cycle test is 4.65 V or 4.7 V.

7. The positive electrode active material according to claim 1,
wherein the additive element contained in the lithium cobalt oxide is positioned in a surface portion of the lithium cobalt oxide.

8. The positive electrode active material according to claim 1,
wherein the additive element contained in the lithium cobalt oxide comprises one or both of magnesium or aluminum.

9. A positive electrode active material used for a secondary battery, the positive electrode active material comprising lithium cobalt oxide comprising an additive element,
wherein after a cycle test is performed at an upper limit voltage of 4.7 V and at 25° C. on a cell using the positive electrode active material for a positive electrode and a lithium electrode as a counter electrode, a surface portion of the positive electrode active material comprises a region where a rock-salt structure exists.

10. The positive electrode active material according to claim 9,
wherein the additive element contained in the lithium cobalt oxide is positioned in the surface portion of the lithium cobalt oxide.

11. The positive electrode active material according to claim 9,
wherein the surface portion of the positive electrode active material further comprises a region where a spinel structure exists.

12. The positive electrode active material according to claim 9,
wherein the surface portion of the positive electrode active material further comprises a region where a spinel structure exists, and
wherein the additive element is not detected in the surface portion of the positive electrode active material in EDX line analysis.

13. The positive electrode active material according to claim 9,
wherein the rock-salt structure exists in a region from a surface of the lithium cobalt oxide to a depth of greater than or equal to 0.8 nm and less than or equal to 0.9 nm.

14. The positive electrode active material according to claim 11,
wherein the spinel structure exists in a region from a surface of the lithium cobalt oxide to a depth of greater than or equal to 1.5 nm and less than or equal to 4.5 nm.

15. The positive electrode active material according to claim 9,
wherein the lithium cobalt oxide comprises a defect having a constant width in a cross section.

16. The positive electrode active material according to claim 9,
wherein the lithium cobalt oxide comprises a pit.

17. The positive electrode active material according to claim 9,
wherein the additive element comprises one or both of magnesium or aluminum.

18. A lithium-ion secondary battery comprising:
a positive electrode comprising the positive electrode active material according to claim 1; and
a negative electrode comprising graphite.

19. A vehicle comprising the lithium-ion secondary battery according to claim 18.

20. A lithium-ion secondary battery comprising:
a positive electrode comprising the positive electrode active material according to claim 9; and
a negative electrode comprising graphite.

21. A vehicle comprising the lithium-ion secondary battery according to claim 20.
